(19) United States
(12) Patent Application Publication
(10) Pub. No.: US 2015/0154147 A1
(43) Pub. Date: Jun. 4, 2015

(54) Entanglement in a pair of subjects whose contextualization of a proposition is tracked in a quantum representation

(71) Applicant: Invent.ly LLC, Woodside, CA (US)

(72) Inventors: Marek Alboszta, Montara, CA (US); Stephen J. Brown, Woodside, CA (US)

(21) Appl. No.: 14/619,009

(22) Filed: Feb. 10, 2015

(51) Int. Cl. G06F 17/18

(52) U.S. Cl. CPC G06F 17/18

(57) ABSTRACT

The present invention concerns methods and apparatus for determining the effects of a mutual interdependence or entanglement in pairs of subjects that jointly contextualize a proposition and are considered in a quantum representation. The subject pairs are selected based on contextualizations and measurable indications they exhibit modulo the proposition. Once selected, they are jointly exposed or confronted by the proposition such that both are aware that they are facing the proposition together and in accordance with certain additional rules that lead to the formation of joint subject states that are entangled. Quantum representation of entanglement between both F-D anti-consensus subjects and B-E consensus type subjects is achieved in accordance with the four canonical equations and consequent violation of the Bell inequality is encoded in subject interdependence thus established.

### RELATED APPLICATIONS

This application is related to U.S. patent application Ser. No. 14/182,281 entitled “Method and Apparatus for Predicting Subject Responses to a Proposition based on a Quantum Representation of the Subject's Internal State and of the Proposition”, filed on Feb. 17, 2014, and to U.S. patent application Ser. No. 14/224,041 entitled “Method and Apparatus for Predicting Joint Quantum States of Subjects modulo an Underlying Proposition based on a Quantum Representation”, filed on Mar. 24, 2014, and to U.S. patent application Ser. No. 14/324,127 entitled “Quantum State Dynamics in a Community of Subjects assigned Quantum States modulo a Proposition perceived in a Social Value Context”, filed on Jul. 4, 2014, and to U.S. patent application Ser. No. 14/504,435 entitled “Renormalization-Related Deployment of Quantum Representations for Tracking Measurable Indications Generated by Test Subjects while Contextualizing Propositions”, filed on Oct. 2, 2014, and to U.S. patent application Ser. No. 14/555,478 entitled “Marketing to a Community of Subjects assigned Quantum States modulo a Proposition perceived in a Social Value Context”, filed on Nov. 26, 2014, and to U.S. patent application Ser. No. 14/582,056 entitled “Biasing effects on the contextualization of a proposition by like-minded subjects considered in a quantum representation”, filed on Dec. 23, 2014, and to U.S. patent application Ser. No. 14/583,712 entitled “Perturbing a subject's contextualization of a proposition about an item considered in a quantum representation by altering the item”, filed on Dec. 28, 2014, and to U.S. patent application Ser. No. 14/588,296 entitled “Freezing a subject's contextualization of a proposition considered in a quantum representation by using a Quantum Zeno effect”, filed on Dec. 31, 2014, and to U.S. patent application Ser. No. 14/601,227 entitled “Perturbing the contextualization of a proposition by a group of subjects considered in a quantum representation by injecting a subjects exhibiting an anti-consensus statistic modulo the proposition”, filed on Jan. 20, 2015. All nine enumerated related applications are incorporated herein by reference in their entirety.

### FIELD OF THE INVENTION

The present invention relates to a method and an apparatus for determining a mutual interdependence or entanglement between a pair of subjects that are jointly exposed to a proposition and, while being under conditions that make both of them aware of their joint confrontation with the proposition, each subject adopts their own value according to which they apprehend or contextualize that proposition. The contextualization of the proposition is tracked in a quantum representation that captures the effects of entanglement between the two subjects belonging to the pair while the values chosen are expressed by subject value matrices corresponding to quantum mechanical operators.

### BACKGROUND OF THE INVENTION

### 1. Preliminary Overview

Fundamental and new insights into the workings of nature at micro-scale were captured by quantum mechanics over a century ago. The realizations derived from these insights have forced several drastic revisions to our picture of reality at that scale. A particularly difficult to accept adjustment in thinking had to do with quantum's inherently statistical rather than predictive description of events.

Many centuries of progress in the western world were rooted in logical and positivist extensions of the ideas of materialism. This paradigm suggested that the underpinnings of reality involve elements that are separable and interact in deterministic ways. Short of such classical triumph, one might have at least presumed that reality is explainable in terms of distinguishable elements that are stable, coherent and consistent. These expectations biased the human mind against theories of nature that did not offer simple, certain and perpetually applicable rules for categorizing and quantifying things.

Quantum mechanics flagrantly violated these expectations. Moreover, reality sided with quantum mechanics by supporting all of its predictions with experimentally verifiable facts. This unceremonious breaking of western premises and of the classical worldview presented scientists and modern thinkers with a conundrum of epic proportions.

As often happens in such situations, western culture at large chose the coping mechanism of avoidance and/or denial. In other words, for the most part it kept marching on without worrying about the implications of quantum theory on human lives and endeavors. The few that paid attention to the sound of death knells for cherished notions such as the western concepts of ontology and epistemology, determinism, realism and causality found some solace in three principles. The application of these principles helped to convince them to sequester any conceivable effects of the novel and “weird” ideas in the domain of the very small.

First was the correspondence principle, which requires that quantum mechanics reduce to classical physics at macro-scale. Second was decoherence, the accepted mechanism for explaining the emergence of classical order at macro-scale. Third were the tools officially devised by the Copenhagen Interpretation, and more specifically the classical measurement apparatus deemed fundamental to performing any legitimate quantum measurements and explaining the experiment. (It should be remarked, however, that even the biggest proponent of using the classical-sized measurement apparatus, Niels Bohr, did not preclude the possibility of treating large-scale systems quantum mechanically, provided a suitable “classical apparatus” could be found for making the required measurements.) The above concepts along with several additional arguments permitted even those perturbed by the new science to safely disregard its most radical aspects in most practical settings.

In most people's minds “weird” revolutionary ideas became a curiosity confined to the atomic and sub-atomic realms as well as esoteric fields presumed devoid of any practical importance. Despite many attempts to export the new teachings to wider circles, including many academic disciplines, the actual and unadulterated discoveries did not percolate into general western consciousness. Rather than achieving the stature it deserved, the new fundamental theory of nature became a silent explosion in a niche domain with a recognized ability to amuse and perplex. Of course, the inherent difficulty of the subject and the high level of skill required of its practitioners were never helpful in efforts at wider dissemination.

In fields more closely affected by the quantum, many responded by adopting strong notions about the existence of as-yet-undiscovered and more fundamental predictive description(s) of microscopic phenomena that would explain the same facts more fully. In following such classical intuitions, some have spent considerable efforts in unsuccessful attempts to attribute the statistical nature of quantum mechanics to its incompleteness. Others tried to interpret or reconcile it with entrenched classical intuitions rooted in Newtonian physics. However, the deep desire to contextualize quantum mechanics within a larger and more “intuitive” or even quasi-classical framework has resulted in few works of practical significance. On the other hand, it has bred many philosophical discussions that are ongoing.

Meanwhile, as human tools enable us to probe nature at incredible resolutions, quantum mechanics continues to exhibit exceptional levels of agreement with all measurable aspects of reality. Its explanatory power within legitimately applicable realms remains unchallenged as it continues to defy all struggles at classical reinterpretations. Today, quantum mechanics and the consequent quantum theory of fields (its extension and partial integration with relativity theory) have proven to be humanity's best fundamental theories of nature. Sub-atomic, atomic as well as many molecular and even higher-level phenomena are now studied with quantum or at least quasi-quantum models.

In a radical departure from the classical assumption of perpetually existing and measurable quantities, the quantum representation of reality posits new entities called wavefunctions or state vectors. These unobservable components of the new model of reality are prior to the emergence of measured quantities (a.k.a. observables) or facts. More precisely, state vectors are related to distributions of probabilities for observing any one of a range of possible experimental results. A telltale sign of the “non-physical” status of a state vector is captured in the language of mathematics, where typical state vectors are expressed as imaginary-valued objects. Further, the space spanned by such state vectors is not classical (i.e., it is not our familiar Euclidean space or even any classical configuration space such as phase space). Instead, state vectors inhabit a Hilbert space of square-integrable functions.

Given that state vectors actually represent complex probability amplitudes, it is uncanny that their behavior is rather easily reconciled with previously developed physics formalisms. Indeed, after some revisions the tools of Lagrangian and Hamiltonian mechanics as well as many long-standing physical principles, such as the Principle of Least Action, are found to apply directly to state vectors and their evolution. The stark difference, of course, is that state vectors themselves represent relative propensities for observing certain measurable values associated with the objects of study, rather than these measurable quantities themselves. In other words, whereas the classical formulations, including Hamiltonian or Lagrangian mechanics, were originally devised to describe the evolution of “real” entities, their quantum mechanical equivalents apply to the evolution of probability amplitudes in a “pre-emerged reality”. Apart from that jarring fact, when left unobserved the state vectors prove to be rather well behaved. Their continuous and unitary evolution in Hilbert space is not entirely unlike propagation of real waves in plain Euclidean space. Hence, some of our intuitions about classical wave mechanics are useful in grasping the behavior of quantum waves.

Of course, our intuitive notions about wave mechanics ultimately falter because quantum waves are not physical waves. This becomes abundantly clear when considering superpositions of two or more such complex-valued objects. Indeed, such superpositions help to bring out several unexpected aspects of quantum mechanics.

For example, quantum wave interference predicts the emergence of probability interference patterns that lead to unexpected distributions of measureable entities in real space. This is true, albeit not noticeable at macro-scales, even when dealing with familiar particles and their trajectories. The interference effect is probably best illustrated by the famous Young's double slit experiment. Here, the complex phase differences between quantum mechanical waves propagating from different space points, namely the two slits where the particle wave was forced to “bifurcate”, manifest in a measurable effect on the path followed by the physical particle. Specifically, the particle is predicted to exhibit a type of self-interference that prevents it from reaching certain places that lie manifestly along classically computed particle trajectories. These startling quantum effects are confirmed by fact.

Although surprising, wave superpositions and interference patterns in probability distributions are ultimately not the novel aspects that challenged human intuition most. Far more mysterious is the nature of measurement during which a real value of an observable attribute or of an element of reality is actually observed. While the underlying model of pre-emerged reality constructed of quantum waves governed by differential wave equations (e.g., by the Schroedinger equation) and boundary conditions may be at least partly intuitive, measurement defies all attempts at non-probabilistic description.

According to quantum theory, the act of measurement forces the full state vector or wave packet of all possibilities to “collapse” or choose just one of the possibilities. In other words, measurement forces the normally compound wave function (i.e., a superposition of possible wave solutions to the governing differential equation) to transition discontinuously and manifest as just one of its constituents. Still differently put, measurement reduces the wave packet and selects only one component wave from the full packet that represents the superposition of all component waves contained in the state vector.

In order to properly evaluate the state of the prior art and to contextualize the contributions of the present invention, it will be necessary to review a number of important concepts from quantum mechanics, quantum information theory (e.g., the quantum version of bits also called “qubits” by skilled artisans) and several related fields. For the sake of brevity, only the most pertinent issues will be presented herein. A more thorough review of quantum information theory is found in course materials by John P. Preskill, “Quantum Information and Computation”, Lecture Notes Ph219/CS219, Chapters 2&3, California Institute of Technology, 2013 and references cited therein and in lecture notes of Jeffrey Yepez, “Topics in Particles & Fields”, Lectures 1&2 Phys711, Department of Physics and Astronomy of the University of Hawaii, Spring 2013 and the references cited therein as well. Excellent reviews of the fundamentals of quantum mechanics are found in standard textbooks starting with P. A. M. Dirac, “The Principles of Quantum Mechanics”, Oxford University Press, 4^{th} Edition, 1958; L. D. Landau and E. M. Lifshitz, “Quantum Mechanics (Non-relativistic Theory)”, Institute of Physical Problems, USSR Academy of Sciences, Butterworth Heinemann, 3^{rd} Edition, 1962; Cohen-Tannoudji et al., “Quantum Mechanics”, John Wiley & Sons, 1977, and many others including the more modern and experiment-based treatments such as J. J. Sakurai, “Modern Quantum Mechanics”, Addison-Wesley, 2011.

### 2. A Brief Review of Quantum Mechanics Fundamentals

In most practical applications of quantum models, the process of measurement is succinctly and elegantly described in the language of linear algebra or matrix mechanics (frequently referred to as the Heisenberg picture). Since all those skilled in the art are familiar with linear algebra, many of its fundamental theorems and corollaries will not be reviewed herein. In the language of linear algebra, a quantum wave ψ is represented in a suitable eigenvector basis by a state vector |ψ [symbol] . To provide a more rigorous definition, we will take advantage of the formal bra-ket notation introduced by Dirac and routinely used in the art.

In the bra-ket convention a column vector ψ is written as |ψ [symbol] and its corresponding row vector (dual vector) is written as [symbol] ψ|. Additionally, because of the complex-valuedness of quantum state vectors, flipping any bra vector to its dual ket vector and vice versa implicitly includes the step of complex conjugation. After initial introduction, most textbooks do not expressly call out this step (i.e., [symbol] ψ| is really [symbol] ψ*| where the asterisk denotes complex conjugation). The reader is cautioned that many simple errors can be avoided by recalling this fundamental rule of complex conjugation.

We now recall that a measure of norm or the dot product (which is related to a measure of length and is a scalar quantity) for a standard vector [symbol] is normally represented as a multiplication of its row vector form by its column vector form as follows: d= [symbol] ^{T} [symbol] . This way of determining norm carries over to the bra-ket formulation. In fact, the norm of any state vector carries a special significance in quantum mechanics.

Expressed by the bra-ket [symbol] ψ|ψ [symbol] , we note that this formulation of the norm is always positive definite and real-valued for any non-zero state vector. That condition is assured by the step of complex conjugation when switching between bra and ket vectors. State vectors describe probability amplitudes while their norms correspond to probabilities. The latter are real-valued and by convention mapped to a range between 0 and 1 (with 1 representing a probability of 1 or 100% certainty). Correspondingly, all state vectors are typically normalized such that their inner product (a generalization of the dot product) is equal to one, or simply put: [symbol] ψ|ψ [symbol] = [symbol] χ|χ [symbol] = • • • =1. This normalization enforces conservation of probability on objects composed of quantum mechanical state vectors.

Using the above notation, we can represent any state vector |ψ [symbol] in its ket form as a sum of basis ket vectors |εⱼ [symbol] that span the Hilbert space [symbol] of state vector |ψ [symbol] . In this expansion, the basis ket vectors |εⱼ [symbol] are multiplied by their correspondent complex coefficients cⱼ. In other words, state vector |ψ [symbol] decomposes into a linear combination as follows:

|ψ [symbol] =Σⱼ₌₁ⁿcⱼ|εⱼ) Eq. 1

where n is the number of vectors in the chosen basis. This type of decomposition of state vector |ψ [symbol] is sometimes referred to as its spectral decomposition by those skilled in the art.

Of course, any given state vector |ψ [symbol] can be composed from a linear combination of vectors in different bases thus yielding different spectra. However, the normalization of state vector |ψ [symbol] is equal to one irrespective of its spectral decomposition. In other words, bra-ket [symbol] ψ|ψ [symbol] =1 in any basis. From this condition we learn that the complex coefficients cⱼ of any expansion have to satisfy:

pₜₒₜ=1=Σⱼ₌₁ⁿcⱼ*cⱼ Eq. 2

where pₜₒₜ is the total probability. This ensures the conservation of probability, as already mentioned above. Furthermore, it indicates that the probability pⱼ associated with any given eigenvector |εⱼ [symbol] in the decomposition of |ψ [symbol] is the norm of the complex coefficient cⱼ, or simply put:

pⱼ=cⱼ*cⱼ Eq. 3

In view of the above, it is not accidental that undisturbed evolution of any state vector |ψ [symbol] in time is found to be unitary or norm preserving. In other words, the evolution is such that the norms cⱼ*cⱼ do not change with time.

To better understand the last point, we use the polar representation of complex numbers by their modulus r and phase angle θ. Thus, we rewrite complex coefficient cⱼ as:

cⱼ=rⱼe^{iθj}, Eq. 4a

where i=\sqrt{−1} (we will use i rather than j for the imaginary number). In this form, complex conjugate of complex coefficient cⱼ* is just:

cⱼ*rⱼe^{-iθj}, Eq. 4b

and the norm becomes:

cⱼ*cⱼ=rⱼe^{-iθj}rⱼe^{iθj}=rⱼ². Eq. 4c

The step of complex conjugation thus makes the complex phase angle drop out of the product (since e^{-iθ}e^{iθ}=e^{i(θ-θ)}=e⁰=1). This means that the complex phase of coefficient cⱼ does not have any measurable effect on the real-valued probability pⱼ associated with the corresponding eigenvector |εj [symbol] . Note, however, that relative phases between different components of the decomposition will introduce measurable effects (e.g., when measuring in a different basis).

Given the above insight about complex phases, it should not be a surprise that temporal evolution of state vector |ψ [symbol] corresponds to the evolution of phase angles of complex coefficients cⱼ in its spectral decomposition (see Eq. 1). In other words, evolution of state vector |ψ [symbol] in time is associated with a time-dependence of angles θⱼ of each complex coefficient cⱼ. The complex phase thus exhibits a time dependence e^{iθj}=e^{iωjt}, where the j-th angular frequency ωⱼ is associated with the j-th eigenvector |εⱼ [symbol] and t stands for time. For completeness, it should be pointed out that ωⱼ is related to the energy level of the correspondent eigenvector |εⱼ [symbol] by the famous Planck relation:

Eⱼ=ωⱼ, Eq. 5

where stands for the reduced Planck's constant h, namely:

$$ℏ = \frac{h}{2 π} .$$

Correspondingly, evolution of state vector |ψ [symbol] is encoded in a unitary matrix U that acts on state vector |ψ [symbol] in such a way that it only affects the complex phases of the eigenvectors in its spectral decomposition. The unitary nature of evolution of state vectors ensures the fundamental conservation of probability. Of course, this rule applies when there are no disturbances to the overall system and states exhibiting this type of evolution are often called stationary states.

In contrast to the unitary evolution of state vectors that affects the complex phases of all eigenvectors of the state vector's spectral decomposition, the act of measurement picks out just one of the eigenvectors. Differently put, the act of measurement is related to a projection of the full state vector |ψ [symbol] onto the subspace defined by just one of eigenvectors |εⱼ [symbol] in the vector's spectral decomposition (see Eq. 1). Based on the laws of quantum mechanics, the projection obeys the laws of probability. More precisely, each eigenvector |εⱼ [symbol] has the probability pⱼ dictated by the norm cⱼ*cⱼ (see Eq. 3) of being picked for the projection induced by the act of measurement. Besides the rules of probability, there are no hidden variables or any other constructs involved in predicting the projection. This situation is reminiscent of a probabilistic game such as a toss of a coin or the throw of a die. It is also the reason why Einstein felt uncomfortable with quantum mechanics and proclaimed that he did not believe that God would “play dice with the universe”.

No experiments to date have been able to validate Einstein's position by discovering hidden variables or other deterministic mechanisms behind the choice. In fact, experiments based on the famous Bell inequality and many other investigations have confirmed that the above understanding encapsulated in the projection postulate of quantum mechanics is complete. Furthermore, once the projection occurs due to the act of measurement, the emergent element of reality that is observed, i.e., the measurable quantity, is the eigenvalue λⱼ associated with eigenvector |εⱼ [symbol] selected by the projection.

Projection is a linear operation represented by a projection matrix P that can be derived from knowledge of the basis vectors. The simplest state vectors decompose into just two distinct eigenvectors in any given basis. These vectors describe the spin states of spin ½ particles such as electrons and other spinors. The quantum states of twistors, such as photons, also decompose into just two eigenvectors. In the present case, we will refer to spinors for reasons of convenience.

It is customary to define the state space of a spinor by eigenvectors of spin along the z-axis. The first, |ε_{z+} [symbol] is aligned along the positive z-axis and the second, |ε_{z-} [symbol] is aligned along the negative z-axis. Thus, from standard rules of linear algebra, the projection along the positive z-axis (z+) can be obtained from constructing the projection matrix or, in the language of quantum mechanics the projection operator P_{z+} from the z+ eigenvector |ε_{z+} [symbol] as follows:

$${P}_{z +} = \vert {ɛ}_{z +} 〉 〈 {ɛ}_{z +} \vert = {[ \begin{matrix}1 \\ 0\end{matrix} ] [ \begin{matrix}1 & 0\end{matrix} ]}^{*} = [ \begin{matrix}1 & 0 \\ 0 & 0\end{matrix} ] , \qquad Eq . 6$$

where the asterisk denotes complex conjugation, as above (no change here because vector components of |ε_{z+} [symbol] are not complex in this example). Note that in Dirac notation obtaining the projection operator is analogous to performing an outer product in standard linear algebra. There, for a vector [symbol] we get the projection matrix onto it through the outer product, namely: Pₓ= [symbol] ^{T}.

### 3. A Brief Introduction to Qubits

We have just seen that the simplest quantum state vector |ψ [symbol] corresponds to a pre-emerged quantum entity that can yield one of two distinct observables under measurement. These measures are the two eigenvalues λ₁, λ₂ of the correspondent two eigenvectors |ε₁ [symbol] , |ε₂ [symbol] in the chosen spectral decomposition. The relative occurrence of the eigenvalues will obey the probabilistic rule laid down by the projection postulate. In particular, eigenvalue λ₁ will be observed with probability p₁ (see Eq. 3) equal to the probability of projection onto eigenvector |ε₁ [symbol] . Eigenvalue λ₂ will be seen with probability p₂ equal to the probability of projection onto eigenvector |ε₂ [symbol] .

Because of the simplicity of the two-state quantum system represented by such two-state vector |ψ [symbol] , it has been selected in the field of quantum information theory and quantum computation as the fundamental unit of information. In analogy to the choice made in computer science, this system is commonly referred to as a qubit and so the two-state vector becomes the qubit: |qb [symbol] =|ψ [symbol] . Operations on one or more qubits are of great interest in the field of quantum information theory and its practical applications. Since the detailed description will rely extensively on qubits and their behavior, we will now introduce them with a certain amount of rigor.

From the above preliminary introduction it is perhaps not surprising to find that the simplest two-state qubit, just like a simple spinor or twistor on which it is based, can be conveniently described in 2-dimensional complex space called [symbol] ². The description finds a more intuitive translation to our 3-dimensional space, [symbol] ³, with the aid of the Bloch or Poincare Sphere. This concept is introduced by FIG. 1A, in which the Bloch Sphere 10 is shown centered on the origin of orthogonal coordinates indicated by axes X, Y, Z.

Before allowing oneself to formulate an intuitive view of qubits by looking at Bloch sphere 10, the reader is cautioned that the representation of qubits inhabiting [symbol] ² by mapping them to a ball in [symbol] ³ is a useful tool. The actual mapping is not one-to-one. Formally, the representation of spinors by the group of transformations defined by SO(3) (Special Orthogonal matrices in [symbol] ³) is double-covered by the group of transformations defined by SU(2) (Special Unitary matrices in [symbol] ²).

In the Bloch representation, a qubit 12 represented by a ray in [symbol] ² is spectrally decomposed into the two z-basis eigenvectors. These eigenvectors include the z-up or |+ [symbol] _{z} eigenvector, and the z-down or |− [symbol] _{z} eigenvector. The spectral decomposition theorem assures us that any state of qubit 12 can be decomposed in the z-basis as long as we use the appropriate complex coefficients. In other words, any state of qubit 12 can be described in the z-basis by:

|ψ [symbol] _{z}=|qb [symbol] _{z}=α|+ [symbol] _{z}+β|− [symbol] _{z}, Eq. 7

where α and β are the corresponding complex coefficients. In quantum information theory, basis state |+ [symbol] _{z} is frequently mapped to logical “yes” or to the value “1”, while basis state |− [symbol] _{z} is frequently mapped to logical “no” or to the value “0”.

In FIG. 1A basis states |+ [symbol] _{z} and |− [symbol] _{z} are shown as vectors and are written out in full form for clarity of explanation. (It is worth remarking that although basis states |+ [symbol] _{z} and |− [symbol] _{z} are indeed orthogonal in [symbol] ², they fall on the same axis (Z axis) in the Bloch sphere representation in [symbol] ³. That is because the mapping is not one-to-one but rather homomorphic, as already mentioned above.) Further, in our chosen representation of qubit 12 in the z-basis, the X axis corresponds to the real axis and is thus also labeled by Re. Meanwhile, the Y axis corresponds to the imaginary axis and is additionally labeled by Im.

To appreciate why complex coefficients α and β contain sufficient information to encode qubit 12 pointed anywhere within Bloch sphere 10 we now refer to FIG. 1B. Here the complex plane 14 spanned by real and imaginary axes Re, Im that are orthogonal to the Z axis and thus orthogonal to eigenvectors |+ [symbol] _{z} and |− [symbol] _{z} of our chosen z-basis is hatched for better visualization. Note that eigenvectors for the x-basis |+ [symbol] ₓ, |− [symbol] ₓ as well as eigenvectors for the y-basis |+ [symbol] _{y}, |− [symbol] _{y} are in complex plane 14. Most importantly, note that each one of the alternative basis vectors in the two alternative basis choices we could have made finds a representation using the eigenvectors in the chosen z-basis. As shown in FIG. 1B, the following linear combinations of eigenvectors |+ [symbol] _{z} and |− [symbol] _{z} describe vectors |+ [symbol] ₓ, |− [symbol] ₓ and |+ [symbol] _{y}, |− [symbol] _{y}:

$$\begin{matrix}{{{\vert + 〉}_{x} = \frac{1}{\sqrt{2}} \vert + 〉}_{z} + \frac{1}{\sqrt{2}} \vert - 〉}_{z} , & Eq . 8 a \\ {{{\vert - 〉}_{x} = \frac{1}{\sqrt{2}} \vert + 〉}_{z} - \frac{1}{\sqrt{2}} \vert - 〉}_{z} , & Eq . 8 b \\ {{{\vert + 〉}_{y} = \frac{1}{\sqrt{2}} \vert + 〉}_{z} + \frac{i}{\sqrt{2}} \vert - 〉}_{z} , & Eq . 8 c \\ {{{\vert - 〉}_{y} = \frac{1}{\sqrt{2}} \vert + 〉}_{z} - \frac{i}{\sqrt{2}} \vert - 〉}_{z} . & Eq . 8 d\end{matrix}$$

Clearly, admission of complex coefficients α and β permits a complete description of qubit 12 anywhere within Bloch sphere 10 thus furnishing the desired map from [symbol] ² to [symbol] ³ for this representation. The representation is compact and leads directly to the introduction of Pauli matrices.

FIG. 1C shows the three Pauli matrices σ₁, σ₂, σ₃ (sometimes also referred to as σₓ, σ_{y}, σ_{z}) that represent the matrices corresponding to three different measurements that can be performed on spinors. Specifically, Pauli matrix σ₁ corresponds to measurement of spin along the X axis (or the real axis Re). Pauli matrix σ₂ corresponds to measurement of spin along the Y axis (or the imaginary axis Im). Finally, Pauli matrix σ₃ corresponds to measurement of spin along the Z axis (which coincides with measurements in the z-basis that we have selected). The measurement of spin along any of these three orthogonal axes will force projection of qubit 12 to one of the eigenvectors of the corresponding Pauli matrix. The measurable value will be the eigenvalue that is associated with the eigenvector.

To appreciate the possible outcomes of measurement we notice that all Pauli matrices σ₁, σ₂, σ₃ share the same two orthogonal eigenvectors, namely |ε₁ [symbol] =[1, 0] and |ε₂ [symbol] =[0, 1]. Further, Pauli matrices are Hermitian (an analogue of real-valued symmetric matrices) such that:

σₖ=σₖ^{†}, Eq. 9

for k=1, 2, 3 (for all Pauli matrices). These properties ensure that the eigenvalues λ₁, λ₂, λ₃ of Pauli matrices σ₁, σ₂, σ₃ are real and the same for each matrix. In particular, for spin ½ particles such as electrons, the Pauli matrices are multiplied by a factor of Ø/2 to obtain the corresponding spin angular momentum matrices Sₖ. Hence, the eigenvalues are shifted to

$${λ}_{1} = \frac{h}{2} and {λ}_{2} = - \frac{h}{2}$$

(wnere is the reduced Planck's constant already defined above). Here we also notice that Pauli matrices σ₁, σ₂, σ₃ are constructed to apply to spinors, which change their sign under a 2π rotation and require a rotation by 4π to return to initial state (formally, an operator S is a spinor if S(θ+2π)=−S(θ)).

As previously pointed out, in quantum information theory and its applications the physical aspect of spinors becomes unimportant and thus the multiplying factor of /2 is dropped. Pauli matrices σ₁, σ₂, σ₃ are used in unmodified form with corresponded eigenvalues λ₁=1 and λ₂=−1 mapped to two opposite logical values, such as “yes” and “no”. For the sake of rigor and completeness, one should state that the Pauli matrices are traceless, each of them squares to the Identity matrix I, their determinants are −1 and they are involutory. A more thorough introduction to their importance and properties can be found in the many foundational texts on Quantum Mechanics, including the above mentioned textbook by P. A. M. Dirac, “The Principles of Quantum Mechanics”, Oxford University Press, 4^{th} Edition, 1958 in the section on the spin of the electron.

Based on these preliminaries, the probabilistic aspect of quantum mechanics encoded in qubit 12 can be re-stated more precisely. In particular, we have already remarked that the probability of projecting onto an eigenvector of a measurement operator is proportional to the norm of the complex coefficient multiplying that eigenvector in the spectral decomposition of the full state vector. This rather abstract statement can now be recast as a complex linear algebra prescription for computing an expectation value [symbol] O [symbol] of an operator matrix O for a given quantum state |ψ [symbol] as follows:

[symbol]

O [symbol] _{ψ}= [symbol] ψ|O|ψ [symbol] , Eq. 10a

where the reader is reminded of the implicit complex conjugation between the bra vector [symbol] ψ| and the dual ket vector |ψ [symbol] . The expectation value [symbol] O [symbol] _{ψ} is a number that corresponds to the average result of the measurement obtained by operating with matrix O on a system described by state vector |ψ [symbol] . For better understanding, FIG. 1C visualizes the expectation value [symbol] σ₃ [symbol] for qubit 12 whose ket in the z-basis is written as |qb [symbol] _{z} for a measurement along the Z axis represented by Pauli matrix σ₃ (note that the subscript on the expectation value is left out, since we know what state vector is being measured).

Although the drawing may suggests that expectation value [symbol] σ₃ [symbol] is a projection of qubit 12 onto the Z axis, the value of this projection is not the observable. Instead, the value [symbol] σ₃ [symbol] is the expectation value of collapse of qubit 12 represented by ket vector |qb [symbol] _{z}, in other words, a value that can range anywhere between 1 and −1 (“yes” and “no”) and will be found upon collecting the results of a large number of actual measurements.

In the present case, since operator σ₃ has a complete set of eigenvectors (namely |+ [symbol] _{z} and |− [symbol] _{z}) and since the qubit |qb [symbol] _{z} we are interested in is described in the same z-basis, the probabilities are easy to compute. The expression follows directly from Eq. 10a:

[symbol]

σ₃ [symbol] _{ψ}=Σⱼλⱼ| [symbol] ψ|εⱼ [symbol] |², Eq. 10b

where λⱼ are the eigenvalues (or the “yes” and “no” outcomes of the experiment) and the norms | [symbol] ψ|εⱼ [symbol] |² are the probabilities that these outcomes will occur. Eq. 10b is thus more useful for elucidating how the expectation value of an operator brings out the probabilities of collapse to respective eigenvectors |εⱼ [symbol] that will obtain when a large number of measurements are performed in practice.

For the specific case in FIG. 1C, we show the probabilities from Eq. 10b can be found explicitly in terms of the complex coefficients α and β. Their values are computed from the definition of quantum mechanical probabilities already introduced above (see Eqs. 2 and 3):

p₁=p_{“yes”}=| [symbol] qb|ε₁ [symbol] |²=|(α*( [symbol] +|+β* [symbol] −|)|+ [symbol] _{z}|²=α*α

p₂=p_{“no”}=| [symbol] qb|ε₂ [symbol] |²=|(α*( [symbol] +|+β* [symbol] −|)|+ [symbol] _{z}|²=β*β

p₁+p₂=p_{“yes”}+p_{“no”}=α*α+β*β=1

These two probabilities are indicated by visual aids at the antipodes of Bloch sphere 10 for clarification. The sizes of the circles that indicate them denote their relative values. In the present case p_{“yes”}>p_{“no”} given the exemplary orientation of qubit 12.

Representation of qubit 12 in Bloch sphere 10 brings out an additional and very useful aspect to the study, namely a more intuitive polar representation. This representation will also make it easier to point out several important aspects of quantum mechanical states that will be pertinent to the present invention.

FIG. 1D illustrates qubit 12 by deploying polar angle θ and azimuthal angle φ routinely used to parameterize the surface of a sphere in [symbol] ³. Qubit 12 described by state vector |qb [symbol] _{z} has the property that its vector representation in Bloch sphere 10 intersects the sphere's surface at point 16. That is apparent from the fact that the norm of state vector |ab [symbol] _{z} is equal to one and the radius of Bloch sphere 10 is also one. Still differently put, qubit 12 is represented by quantum state |qb [symbol] _{z} that is pure; i.e., it is considered in isolation from the environment and from any other qubits for the time being. Pure state |qb [symbol] _{z} is represented with polar and azimuth angles θ, φ of the Bloch representation as follows:

$${{{\vert qb 〉}_{z} = cos \frac{θ}{2} \vert + 〉}_{z} + {e}^{iφ} sin \frac{θ}{2} \vert - 〉}_{z} , \qquad Eq . 11$$

where the half-angles are due to the state being a spinor (see definition above). The advantage of this description becomes even more clear in comparing the form of Eq. 11 with Eq. 7. State |qb [symbol] _{z} is insensitive to any overall phase or overall sign thus permitting several alternative formulations.

Additionally, we note that the Bloch representation of qubit 12 provides for an easy parameterization of point 16 in terms of {x,y,z} coordinates directly from polar and azimuth angles θ, φ. In particular, the coordinates of point 16 are just:

{x,y,z}={sin θ cos φ, sin θ sin φ, cos θ}, Eq. 12

in agreement with standard transformation between polar and Cartesian coordinates.

We now return to the question of measurement equipped with some basic tools and a useful representation of qubit 12 as a unit vector terminating at the surface of Bloch sphere 10 at point 16 (whose coordinates {x,y,z} are found from Eq. 12) and pointing in some direction characterized by angles θ, φ. The three Pauli matrices σ₁, σ₂, σ₃ can be seen as associating with measurements along the three orthogonal axes X, Y, Z in real 3-dimensional space [symbol] ³.

A measurement represented by a direction in [symbol] ³ can be constructed from the Pauli matrices. This is done with the aid of a unit vector û pointing along a proposed measurement direction, as shown in FIG. 1D. Using the dot-product rule, we now compose the desired operator σᵤ using unit vector û and the Pauli matrices as follows:

σᵤ=û· σ̅=uₓσ₁+u_{y}σ₂+u_{z}σ₃. Eq. 13

Having thus built up a representation of quantum mechanical state vectors, we are in a position to understand a few facts about the pure state of qubit 12. Namely, an ideal or pure state of qubit 12 is represented by a Bloch vector of unit norm pointing along a well-defined direction. It can also be expressed by Cartesian coordinates {x,y,z} of point 16. Unit vector û defining any desired direction of measurement can also be defined in Cartesian coordinates {x,y,z} of its point of intersection 18 with Bloch sphere 10.

When the direction of measurement coincides with the direction of the state vector of qubit 12, or rather when the Bloch vector is aligned with unit vector û, the result of the quantum measurement will not be probabilistic. In other words, the measurement will yield the result |+ [symbol] ᵤ with certainty (probability equal to 1 as may be confirmed by applying Eq. 10b), where the subscript u here indicates the basis vector along unit vector û. Progressive misalignment between the direction of measurement and qubit 12 will result in an increasing probability of measuring the opposite state, |− [symbol] ᵤ.

The realization that it is possible to predict the value of qubit 12 with certainty under above-mentioned circumstances suggests we ask the opposite question. When do we encounter the least certainty about the outcome of measuring qubit 12? With the aid of FIG. 1E, we see that in the Bloch representation this occurs when we pick a direction of measurement along a unit vector \hat{v} that is in a plane 20 perpendicular to unit vector û after establishing the state |+ [symbol] ᵤ (or the state |− [symbol] ᵤ) by measuring qubit 12 eigenvalue “yes” along û (or “no” opposite to û). Note that establishing a certain state in this manner is frequently called “preparing the state” by those skilled in the art. After preparation in state |+ [symbol] ᵤ or in state |− [symbol] ᵤ, measurement of qubit 12 along vector \hat{v} will produce outcomes |+ [symbol] ᵥ and |− [symbol] ᵥ with equal probabilities (50/50).

Indeed, we see that this same condition holds among all three orthogonal measurements encoded in the Pauli matrices. To wit, preparing a certain measurement along Z by application of matrix σ₃ to qubit 12 makes its subsequent measurement along X or Y axes maximally uncertain (see also plane 14 in FIG. 1B). This suggests some underlying relationship between Pauli matrices σ₁, σ₂, σ₃ that encodes for this indeterminacy. Even based on standard linear algebra we expect that since the order of application of matrix operations usually matters (since any two matrices A and B typically do not commute) the lack of commutation between Pauli matrices could be signaling a fundamental limit to the simultaneous observation of multiple orthogonal components of spin or, by extension, of qubit 12.

In fact, we find that the commutation relations for the Pauli matrices, here explicitly rewritten with the x,y,z indices rather than 1, 2, 3, are as follows:

[σₓ,σ_{y}]=iσ_{z}; [σ_{y},σ_{z}]=iσₓ; [σ_{z},σₓ]=iσ_{y}. Eq. 14

The square brackets denote the traditional commutator defined between any two matrices A, B as [A,B]=AB−BA. When actual quantities rather than qubits are the subject of investigation, this relationship leads directly to the famous Heisenberg Uncertainty Principle. This fundamental limitation on the emergence of elements of reality prevents the simultaneous measurement of incompatible observables and places a bound related to Planck's constant h (and more precisely to the reduced Planck's constant ) on the commutator. This happens because matrices encoding real observables bring in a factor of Planck's constant and the commutator thus acquires this familiar bound.

The above finding is general and extends beyond the commutation relations between Pauli matrices. According to quantum mechanics, the measurement of two or more incompatible observables is always associated with matrices that do not commute. Another way to understand this new limitation on our ability to simultaneously discern separate elements of reality, is to note that the matrices for incompatible elements of reality cannot be simultaneously diagonalized. Differently still, matrices for incompatible elements of reality do not share the same eigenvectors. Given this fact of nature, it is clear why modern day applications strive to classify quantum systems with as many commuting observables as possible up to the famous Complete Set of Commuting Observables (CSCO).

Whenever the matrices used in the quantum description of a system do commute, then they correspond to physical quantities of the system that are simultaneously measurable. A particularly important example is the matrix that corresponds to the total energy of the system known as the Hamiltonian H. When an observable is described by a matrix M that commutes with Hamiltonian H, and the system is not subject to varying external conditions, (i.e., there is no explicit time dependence) then that physical quantity that corresponds to operator M is a constant of motion.

### 4. A Basic Measurement Arrangement

In practice, pure states are rare due to interactions between individual qubits as well as their coupling to the environment. All such interactions lead to a loss of quantum state coherency, also referred to as decoherence, and the consequent emergence of “classical” statistics. Thus, many additional tools have been devised for practical applications of quantum models under typical conditions. However, under conditions where the experimenter has access to entities exhibiting relatively pure quantum states many aspects of the quantum mechanical description can be recovered from appropriately devised measurements.

To recover the desired quantum state information it is important to start with collections of states that are large. This situation is illustrated by FIG. 1F, where an experimental apparatus 22 is set up to perform a measurement of spin along the Z axis. Apparatus 22 has two magnets 24A, 24B for separating a stream of quantum systems 26 (e.g., electrons) according to spin. The spin states of systems 26 are treated as qubits 12a, 12b, . . . , 12n for the purposes of the experiment. The eigenvectors and eigenvalues are as before, but the subscript “z” that was there to remind us of the z-basis decomposition, which is now implicitly assumed, has been dropped.

Apparatus 22 has detectors 28A, 28B that intercept systems 26 after separation to measure and amplify the readings. It is important to realize that the act of measurement is performed during the interaction between the field created between magnets 24A, 24B and systems 26. Therefore, detectors 28A, 28B are merely providing the ability to amplify and record the measurements for human use. These operations remain consistent with the original result of quantum measurements. Hence, their operation can be treated classically. (The careful reader will discover a more in-depth explanation of how measurement can be understood as entanglement that preserves consistency between measured events given an already completed micro-level measurement. By contrast, the naïve interpretation allowing amplification to lead to macro-level superpositions and quantum interference, to with the Schroedinger's Cat paradox, is incompatible with the consistency requirement. A detailed analysis of these fine points is found in any of the previously mentioned foundational texts on quantum mechanics.)

For systems 26 prepared in various pure states that are unknown to the experimenter, the measurements along Z will not be sufficient to deduce these original states. Consider that each system 26 is described by Eq. 7. Thus, each system 26 passing through apparatus 22 will be deflected according to its own distinct probabilities p_{|+} [symbol] =α*α (or p_{“yes”}) and p_{|-} [symbol] =β*β (or p_{“no”}). Hence, other than knowing the state of each system 26 with certainty after its measurement, general information about the preparation of systems 26 prior to measurement will be very difficult to deduce.

FIG. 1G shows the more common situation, where systems 26 are all prepared in the same, albeit unknown pure state (for “state preparation” see section 3 above). Under these circumstances, apparatus 22 can be used to deduce more about the original pure state that is unknown to the experimenter. In particular, a large number of measurements of |+ [symbol] (“yes”) and |− [symbol] (“no”) outcomes, for example N such measurements assuming all qubits 12a through 12n are properly measured, can be analyzed probabilistically. Thus, the number n_{|+} [symbol] of |+ [symbol] measurements divided by the total number of qubits 12 that were measured, namely N, has to equal α*α. Similarly, the number n_{|-} [symbol] of |− [symbol] measurements divided by N has to equal β*β. From this information the experimenter can recover the projection of the unknown pure state onto the Z axis. In FIG. 1G this projection 26′ is shown as an orbit on which the state vector can be surmised to lie. Without any additional measurements, this is all the information that can be easily gleaned from a pure Z axis measurement with apparatus 22.

### 5. Overview of Practical Cases

By now it will have become apparent to the reader that the quantum mechanical underpinnings of qubits are considerably more complicated than the physics of regular bits. Regular bits can be treated in a manner that is completely divorced from their physicality. A computer scientist dealing with a bit does not need to know what the physical system embodying the bit happens to be, as long as it satisfies the typical criteria of performance (e.g., low probability of bit errors and containment of other failure modes). Unfortunately, as already remarked and further based on the reviews found in the patent applications enumerated in the section on related applications, the same is not true for qubits.

To deal with quantum systems exhibiting interactions between themselves and with the environment that has degrees of freedom inaccessible to an observer a more practical representation had to be adopted. That is because in such open systems states or typically not rays in Hilbert space and measurements are not obtained by applying simple projections operators. Moreover, the evolution of the states is usually not unitary. A suitable representation in view of these real-life limitations is embodied by the density matrix, which was devised in the first half of the 20^{th} century and is usually attributed to John von Neumann (also sometimes to Lev Landau and Felix Bloch). We have previously discussed this matrix in U.S. patent application Ser. No. 14/182,281. Here we want to focus more on how this matrix accommodates mixed states and pure states that include coherent superpositions.

Let us start by looking at coherent superpositions. From Eq. 8a we know a pure state of up along X axis, or |+ [symbol] ₓ, can be expressed in terms of the up- and down-states along Z axis, i.e., by using the z-basis eigenvectors |+ [symbol] _{z} and |− [symbol] _{z}. Recall that the required superposition is actually:

$${\vert + 〉}_{x} = \frac{1}{\sqrt{2}} {\vert + 〉}_{z} + \frac{1}{\sqrt{2}} {\vert - 〉}_{z} .$$

This means that if we were to measure the z-component of spin (using the σ₃ operator or equivalently experimental apparatus 22 introduced in FIG. 1F) over a statistical sample of quantum systems 26 prepared as |+ [symbol] ₓ then we would find states |+ [symbol] _{z} and |− [symbol] _{z} to be equally likely (50/50). After all, the superposition has c₁=α=1/\sqrt{2} and thus probability p₁=(1/\sqrt{2})²=½ for state |+ [symbol] _{z} and c₂=β=1/\sqrt{2} leading to probability p₂=(1/\sqrt{2})²=½ for state |− [symbol] _{z}. If we were to measure the x-component of spin for this superposition via the σ₁ operator, however, we would find |+ [symbol] ₓ with certainty every time (100% chance). (Of course, we would not actually observe the states, but rather their eigenvalues.)

Now consider a case in which we have a statistical sample or, what those skilled in the art refer to as an ensemble, of quantum systems 26 in which half of the states are |+ [symbol] _{z} and the other half of the states are |− [symbol] _{z}. Once again, by applying the σ₃ operator instantiated by experimental apparatus 22 we would find these states to be equally likely (50/50). Yet, a measurement along X axis represented by the σ₁ operator (we would obviously have to rotate apparatus 22 to perform this measurement) on the same ensemble would now discover state |+ [symbol] ₓ only half of the time. The other half of the time the state along X axis would be down or |− [symbol] ₓ. In other words, the ensemble exhibits an equiprobable distribution (50/50 chance) of states |+ [symbol] ₓ and |− [symbol] ₓ!

We have just uncovered a fundamental inability of measurements along just one single axis to determine the difference between a coherent superposition and a statistical ensemble. Needless to say, a proper description of the superposition and the statistical ensemble (sometimes referred to as “Gemisch” (German for “mixture” or “mixed state”) by those skilled in the art) should take account of this. The density matrix is the right description and can be used in either case.

Let us examine its representation of the pure state expressed by the coherent superposition of Eq. 8a first. We construct the density matrix for this pure state by forming a projection onto it and then multiplying it by the probability of occurrence of this pure state. In our case the probability of occurrence of state |+ [symbol] _{z} is 100% or 1. It must clearly be so, since we are not dealing with a mixture of different states but a coherent superposition. The density operator thus has only one component (i=1) and is computed using the outer product (introduced in conjunction with projection operators) as follows:

\hat{ρ}=Σᵢpᵢ|ψᵢ [symbol] ψᵢ|, Eq. 15

yielding in our case:

$$\hat{ρ} = ( \frac{1}{\sqrt{2}} {\vert + 〉}_{z} + \frac{1}{\sqrt{2}} {\vert - 〉}_{z} ) ( \frac{1}{\sqrt{2}} {}_{z} 〈 + \vert + \frac{1}{\sqrt{2}} {}_{z} 〈 - \vert ) = [ \begin{matrix}\frac{1}{2} & \frac{1}{2} \\ \frac{1}{2} & \frac{1}{2}\end{matrix} ] .$$

The trace class density operator \hat{ρ} thus obtained encodes pure state |+ [symbol] ₓ computed from its traditional z-basis decomposition. (We note here that the basis in which the computation is done turns out to be unimportant.)

Matrix \hat{ρ} for pure state |+ [symbol] _{z} looks a bit unwieldy and it may not be immediately apparent that it encodes a coherent superposition. Of course, it is idempotent and thus a good candidate density operator for representing a pure state (a state whose point 16 in the Bloch representation is on the surface of the Bloch ball—also see here the background section of U.S. patent application Ser. No. 14/182,281 and FIG. 1J in particular for an additional refresher on the properties of density matrices). However, we can compute the average value of observable σ₁ corresponding to the X axis measurement of spin for a reliable cross-check. The computation is performed by tracing over the product of two matrices. The first matrix is the observable of interest, represented here by operator matrix O, and the second one is just matrix \hat{ρ} as follows:

Ō=Tr\hat{ρ}O, Eq. 16

where the over-bar denotes average value. It is worth recalling that the trace operation will yield the same answer irrespective of matrix order whether or not the matrices commute. Now, to deploy Eq. 16 for our cross-check we set O=σ₁ and obtain:

$$\overline{{σ}_{1}} = Tr ( [ \begin{matrix}\frac{1}{2} & \frac{1}{2} \\ \frac{1}{2} & \frac{1}{2}\end{matrix} ] [ \begin{matrix}0 & 1 \\ 1 & 0\end{matrix} ] ) = 1.$$

This means that the average value for a measurement along X axis is 1, or spin up. In fact, for the pure state under consideration this is exactly the expectation value which is written as [symbol] σ₁ [symbol] and whose prescription we have already introduced above (see Eqs. 10a & 10b). Spin up along X axis for sure indicates state |+ [symbol] ₓ. We have thus confirmed that the more general density matrix formalism correctly reproduces the expectation value.

We turn now to the mixed state introduced above. It is an ensemble of states |+ [symbol] _{z} and |− [symbol] _{z} occurring with equal probabilities. Clearly, this is not a coherent superposition of the two states, but rather a stream of these states with 50/50 probability. The density operator applied from Eq. 15 now yields:

$$\hat{ρ} = \frac{1}{2} ( {\vert + 〉}_{z} {}_{ z} 〈 + \vert + {\vert - 〉}_{z} {}_{ z} 〈 - \vert ) = [ \begin{matrix}\frac{1}{2} & 0 \\ 0 & \frac{1}{2}\end{matrix} ] = \frac{1}{2} I ,$$

where I is the 2×2 identity matrix. The application of Eq. 16 to find the average value of spin along any one of the three axes X, Y and Z (and indeed along any arbitrary direction indicated by unit vector û) will yield zero. We further note that the Von Neumann Entropy, which is defined as S=−Tr(ρ ln(ρ)), is maximum for our mixed state and minimum (zero) for the coherent superposition. Given perfect knowledge of our pure state versus the equiprobable statistics of our mixture this is the expected result. We also note that the same density operator was obtained when describing the Einstein Podolsky Rosen (EPR) states in U.S. patent application Ser. No. 14/182,281 (see Eq. 18).

The density matrix becomes an especially useful tool when dealing with entangled states. Such states may include entangled states that obey either Bose-Einstein or Fermi-Dirac statistics. These types of states are not found in classical information theory, but are of great interest in quantum information theory. Using the z-basis decomposition implicitly, the two possible two-qubit states that exhibit entanglement are:

$$\begin{matrix}\vert {φ}^{\pm } 〉 = \frac{1}{\sqrt{2}} ( \vert - , - 〉 \pm \vert + , + 〉 ) = \frac{1}{\sqrt{2}} ( \vert 00 〉 \pm \vert 11 〉 ) , & Eq . 17 a \\ \vert {ψ}^{\pm } 〉 = \frac{1}{\sqrt{2}} ( \vert - , + 〉 \pm \vert + , - 〉 ) = \frac{1}{\sqrt{2}} ( \vert 01 〉 \pm \vert 10 〉 ) . & Eq . 17 b\end{matrix}$$

We use here the convention that wave functions φ denote entities that obey Bose-Einstein statistics (they are correlated). Wave functions ψ denote entities that obey Fermi-Dirac statistics and are subject to the Pauli Exclusion Principle (they are anti-correlated). The latter cannot occupy the same quantum state, as evident from inspecting Eq. 17b. Maximally entangled states of Eqs. 17a&17b are also sometimes called Bell states by those skilled in the art.

Applying unitary evolution operators to pure and to entangled states, including the maximally entangled Bell states, is at the foundation of quantum computing. In fact, quantum logic gates are implementations of exactly such operators. Therefore, the ability to translate an algorithm into a form that can be “programmed” in quantum logic is of great interest. Considerable resources have been allocated to quantum computing. The algorithm of Peter Shor for prime number factoring is one of the promising applications for such quantum logic gates when finally developed. To date the largest prime number that has been factored by adiabatic quantum computation (AQC) is 143.

Still, despite the excitement and massive resources allocated to the development of quantum computers, many challenges and open questions remain. These include the number of quantum gates that can be made to cooperate reliably in the given physical instantiation, generation of entangled states, the overall physical system and conditions under which the gates are implemented, types of gates (e.g., Hadamard gate, Pauli gates, Phase shift gates, Toffoli gate etc.), quantum error correction codes and their practical efficacy as well as many others. Early ideas in this subject can be found in Feynman, Richard P., “Simulating Physics with Computers”, International Journal of Theoretical Physics 21 (6-7), pp. 467-488, 1982. Subsequent development is found in textbooks such as Nielsen, Michael A. and Chuang, Isaac L., “Quantum Computation and Quantum Information”, Cambridge University Press, 2000. Finally, current literature should be consulted for the progress being made in this exciting subject.

### 6. Prior Art Applications of Quantum Theory to Subject States

Since the advent of quantum mechanics, many have realized that some of its non-classical features may better reflect the state of affairs at the human grade of existence. In particular, the fact that state vectors inherently encode incompatible measurement outcomes and the probabilistic nature of measurement do seem quite intuitive upon contemplation. Thus, many of the fathers of quantum mechanics did speculate on the meaning and applicability of quantum mechanics to human existence. Of course, the fact that rampant quantum decoherence above microscopic levels tends to destroy any underlying traces of coherent quantum states was never helpful. Based on the conclusion of the prior section, one can immediately surmise that such extension of quantum mechanical models in a rigorous manner during the early days of quantum mechanics could not even be legitimately contemplated.

Nevertheless, among the more notable early attempts at applying quantum techniques to characterize human states are those of C. G. Jung and Wolfgang Pauli. Although they did not meet with success, their bold move to export quantum formalisms to large scale realms without too much concern for justifying such procedures paved the way others. More recently, the textbook by physicist David Bohm, “Quantum Theory”, Prentice Hall, 1979 ISBN 0-486-65969-0, pp. 169-172 also indicates a motivation for exporting quantum mechanical concepts to applications on human subjects. More specifically, Bohm speculates about employing aspects of the quantum description to characterize human thoughts and feelings.

In a review article published online by J. Summers, “Thought and the Uncertainty Principle”, http://www.jasonsummers.org/thought-and-the-uncertainty-principle/, 2013 the author suggests that a number of close analogies between quantum processes and our inner experience and through processes could be more than mere coincidence. The author shows that this suggestion is in line with certain thoughts on the subject expressed by Niels Bohr, one of the fathers of quantum mechanics. Bohr's suggestion involves the idea that certain key points controlling the mechanism in the brain are so sensitive and delicately balanced that they must be described in an essentially quantum-mechanical way. Still, Summers recognizes that the absence of any experimental data on these issues prevents the establishment of any formal mapping between quantum mechanics and human subject states.

The early attempts at lifting quantum mechanics from their micro-scale realm to describe human states cast new light on the already known problem with standard classical logic, typically expressed by Bayesian models. In particular, it had long been known that Bayesian models are not sufficient or even incompatible with properties observed in human decision-making. The mathematical nature of these properties, which are quite different from Bayesian probabilities, were later investigated in quantum information science by Vedral, V., “Introduction to quantum information science”, New York: Oxford University Press 2006.

Taking the early attempts and more recent related motivations into account, it is perhaps not surprising that an increasing number of authors argue that the basic framework of quantum theory can be somehow extrapolated from the micro-domain to find useful applications in the cognitive domain. Some of the most notable contributions are found in: Aerts, D., Czachor, M., & D'Hooghe, B. (2005), “Do we think and communicate in quantum ways? On the presence of quantum structures in language”, In N. Gontier, J. P. V. Bendegem, & D. Aerts (Eds.), Evolutionary epistemology, language and culture. Studies in language, companion series. Amsterdam: John Benjamins Publishing Company; Atmanspacher, H., Roemer, H., & Walach, H. (2002), “Weak quantum theory: Complementarity and entanglement in physics and beyond”, Foundations of Physics, 32, pp. 379-406; Blutner, R. (2009), “Concepts and bounded rationality: An application of Niestegge's approach to conditional quantum probabilities”, In Accardi, L. et al. (Eds.), Foundations of probability and physics-5, American institute of physics conference proceedings, New York (pp. 302-310); Busemeyer, J. R., Wang, Z., & Townsend, J. T. (2006), “Quantum dynamics of human decision-making”, Journal of Mathematical Psychology, 50, pp. 220-241; Franco, R. (2007), “Quantum mechanics and rational ignorance”, Arxiv preprint physics/0702163; Khrennikov, A. Y., “Quantum-like formalism for cognitive measurements”, BioSystems, 2003, Vol. 70, pp. 211-233; Pothos, E. M., & Busemeyer, J. R. (2009), “A quantum probability explanation for violations of ‘rational’ decision theory”, Proceedings of the Royal Society B: Biological Sciences, 276. Recently, Gabora, L., Rosch, E., & Aerts, D. (2008), “Toward an ecological theory of concepts”, Ecological Psychology, 20, pp. 84-116 have even demonstrated how this framework can account for the creative, context-sensitive manner in which concepts are used, and they have discussed empirical data supporting their view.

An exciting direction for the application of quantum theory to the modeling of inner states of subjects was provided by the paper of R. Blutner and E. Hochnadel, “Two qubits for C. G. Jung's theory of personality”, Cognitive Systems Research, Elsevier, Vol. 11, 2010, pp. 243-259. The authors propose a formalization of C. G. Jung's theory of personality using a four-dimensional Hilbert space for representation of two qubits. This approach makes a certain assumption about the relationship of the first qubit assigned to psychological functions (Thinking, Feeling, Sensing and iNtuiting) and the second qubit representing the two perspectives (Introversion and Extroversion). The mapping of the psychological functions and perspectives presumes certain relationships between incompatible observables as well as the state of entanglement between the qubits that does not appear to be borne out in practice, as admitted by the authors. Despite this insufficiency, the paper is of great value and marks an important contribution to techniques for mapping problems regarding the behaviors and states of human subjects to qubits using standard tools and models afforded by quantum mechanics.

Thus, attempts at applying quantum mechanics to phenomena involving subjects at macro-levels have been mostly unsuccessful. A main and admitted source of problems lies in the translation of quantum mechanical models to human situations. More precisely, it is not at all clear how and under what conditions to map subject states as well as subject actions or reactions to quantum states. It is not even apparent in what realms the mappings may be valid.

Finally, the prior art does not provide for a quantum informed approach to gathering data. Instead, the state of the art for development of predictive personality models based on “big data” collected on the web is ostensibly limited to classical data collection and classification approaches. Some of the most representative descriptions of these are provided by: D. Markvikj et al., “Mining Facebook Data for Predictive Personality Modeling”, Association for the Advancement of Artificial Intelligence, www.aaai.org, 2013; G. Chittaranjan et al., “Who's Who with Big-Five: Analyzing and Classifying Personality Traits with Smartphones”, Idiap Research Institute, 2011, pp. 1-8; B. Verhoeven et al., “Ensemble Methods for Personality Recognition”, CLiPS, University of Antwerp, Association for the Advancement of Artificial Intelligence, Technical Report WS-13-01, www.aaai.org, 2013; M. Komisin et al., “Identifying Personality Types Using Document Classification Methods”, Dept. of Computer Science, Proceedings of the Twenty-Fifth International Florida Artificial Intelligence Research Society Conference, 2012, pp. 232-237.

### Objects and Advantages

In view of the shortcomings of the prior art, it is an object of the present invention to provide computer implemented methods and computer systems that deploy a quantum representation for detecting the presence of a mutual interdependence or entanglement manifesting in a pair of subjects after they contextualize a certain proposition each according to their own values but in full awareness of each other.

These and other objects and advantages of the invention will become apparent upon reading the detailed specification and reviewing the accompanying drawing figures.

### SUMMARY OF THE INVENTION

The present invention relates to computer implemented methods and computer systems that are designed to determine a mutual interdependence or entanglement in a pair of subjects that jointly contextualize a proposition. The methods and systems extend to tracking or detecting the effects of entanglement that each subject in the entangled pair experiences. The present methods and computer system rely on known measurable indications and subsequent measurable indications from the subjects.

Any subject confronted by a proposition is free to contextualize it, i.e., apprehend, perceive, understand or value it in different and personal ways. The kind of subjects we are interested in here, are ones that while separated from each other adopt a known contextualization and exhibit a certain initial measurable indication in that contextualization of the proposition, which is typically about some item. The item at the core of the proposition is usually selected from the group consisting of a subject, an object and an experience, as well as any combination of one or more such items. In some cases the item may be scarce, limited, unique, constrained, desirable or it may have attributes or qualities that makes it appear thus to the subjects.

The confrontation of the subject by a proposition and the subject's choice of value to use in making sense of the proposition will be referred to herein as a contextualization of that proposition by that subject. Many different contextualizations of the same proposition are inherently available to a subject. Some of the available contextualizations are incompatible. These are represented by non-commuting quantum mechanical operators. Some other available contextualizations are compatible. These, on the other hand, are represented by commuting quantum mechanical operators.

The computer implemented method for detecting entanglement pertains to a joint subject state that involves a pair or two subjects. The joint subject state forms modulo a proposition that the subjects are confronted with or exposed to jointly. In the quantum representation adopted herein the two subjects contextualize the proposition when jointly confronted by it in accordance with rules that cause the formation of the joint subject state.

The pair of subjects is selected by a mapping module based on each of them individually exhibiting a known contextualization of the proposition prior to the formation of the joint subject state. Furthermore, prior to entering the joint state the subjects have known measurable indications in the known contextualization. An assignment module is used for assigning a subject value matrix PR_{V} for the known contextualization. In accordance with the quantum representation, the eigenvalues of the subject value matrix PR_{V} correspond to possible measurable indications in the contextualization that the subject value matrix PR_{V} stands for. Of course, these possible measurable indications include the known measurable indications that are exhibited by the selected pair of subjects.

Formation of the joint subject state is achieved by jointly exposing the pair of subjects to the proposition. This joint exposure or confrontation needs to occur in a manner that both subjects are aware they are facing the proposition together. Differently put, they are aware that the consequences of the contextualiztions they decide to adopt with respect to the proposition will affect them both. The joint subject state reflects this interdependence. In the quantum representation adopted herein, the interdependence is expressed in quantum entanglement.

A network monitoring unit is used for collecting subsequent measurable indications from the selected pair of subjects after formation of the joint subject state. In other words, subsequent measurable indications are collected after the subjects are entangled. Once the entangled state is established it will persist until decoherence due to interactions of the subjects with the environment erases it. Prior to decoherence, entanglement will persist irrespective of space-time separation between the subjects constituting the pair. For this reason, in some embodiments of the invention the subjects are separated after entanglement is established but prior to collecting the subsequent measurable indications. The step of separating the subjects can be advantageously performed in a computer system and thus entirely within a network environment. In other words, network communications between the pair of subjects are suspended.

Skilled artisans may perform Bell state test with entangled subjects when their separation is space-like before collecting the subsequent measurable indications from both of them. It is convenient in certain embodiments to collect the new measurable indications for an additional proposition that is incompatible with the original proposition. Preferably, however, both propositions are about the same item. In accordance with the quantum representation the incompatible proposition is represented by a secondary subject value matrix PR_{SV} that does not commute with the subject value matrix PR_{V}. Differently put, the original and known contextualization of the proposition as practiced by the subjects prior to entanglement associates with subject value matrix PR_{V} while the new contextualization of the additional proposition upon entanglement associates with secondary subject value matrix PR_{SV}.

A statistics module is used for estimating a measure of entanglement by comparing the known measurable indications with subsequent measurable indications or, in following more traditional Bell tests using just the subsequent measurable indications. In cases where a sufficiently reliable measure of entanglement can be obtained, the statistics module may proceed to further estimate a change in the quantum representation of the pair of subjects due to entanglement.

Advantageously, the method is implemented in a computer system that has many resources for facilitating interactions between selected subjects. For example, the step of jointly exposing them to the proposition to generate the joint subject state can be performed within the computer system. More preferably still, the computer system includes a network. The step of jointly exposing the subjects is then carried out within the network using its resources. For example, it is done by presenting both of the subjects with the proposition within the network using available screens or other communication affordances. Alternatively, joint exposure can be achieved by presenting the subjects with the proposition in real life.

A computer system according to the invention deploys the mapping module for selecting the pair of subjects that individually exhibit the known contextualization of the proposition and also exhibit known measurable indications in that known contextualization. The assignment module makes the subject value matrix PR_{V} assignment to represent the known contextualization. All possible measurable indications, including the ones known for the selected subjects, are eigenvalues of the subject value matrix PR_{V}.

The computer system has a mechanism for jointly exposing the pair of subjects to the proposition in order to precipitate the formation of the joint subject state. The rules under which the joint subject state forms include a sufficient amount of joint exposure time and clarity on behalf of both subjects that they are interdependent in their choice of contextualization. In other words, the choice of contextualization by either will, given potential manifestation of the eigenvalue that associates to the state, have a material impact on the other subject.

The network monitoring unit is used by the computer system for collecting subsequent measurable indications that are obtained after entanglement has taken place. In practical settings, this means that the network monitoring units has access to data either generated by the subjects and/or generated about the subjects. The data of interest contains indications or directly communicates the subsequent measurable indications of the subjects. The statistics module, which is preferably in direct communication with the network monitoring unit uses all available information, e.g., the known measurable indications as well as the subsequent measurable indications to estimate a measure of entanglement achieved by the computer system.

In some embodiments the computer system utilizes mechanisms or apparatus with a visualization component, e.g., a display screen or other similar affordance to present the proposition to the pair of subjects. For example, the display screens of the subjects' mobile or networked devices can serve this function. This is particularly advantageous in embodiments where the computer system comprises a network equipped with devices or elements that have visualization components that can be used for jointly exposing the subjects to the proposition.

In a preferred embodiment, the computer system is implemented in a network. Suitable networks include the Internet, the World Wide Web, a Wide Area Network (WAN) and a Local Area Network (LAN) as well as any other private or public networks capable of affording suitable communications channels between subjects. In the most preferred embodiment at least one of the subjects in the pair is further predefined with the aid of one or more social groups. In the simplest case, the mapping module uses as one of its selection criteria the membership or affiliation with a particular social group. Suitable social groups include Facebook, LinkedIn, Google+, MySpace, Instagram, Tumblr, YouTube and any other social group or socializing platform that aids in explicitly or implicitly segmenting its members. For example, the social group can manifest by an affiliation with one or more product sites on the network. These could be Amazon.com, Walmart.com, bestbuy.com, Groupon.com, Netflix.com, iTunes, Pandora, Spotify or any analogous product site.

The present invention, including the preferred embodiment, will now be described in detail in the below detailed description with reference to the attached drawing figures.

### BRIEF DESCRIPTION OF THE DRAWING FIGURES

FIG. 1A (Prior Art) is a diagram illustrating the basic aspects of a quantum bit or qubit.

FIG. 1B (Prior Art) is a diagram illustrating the set of orthogonal basis vectors in the complex plane of the qubit shown in FIG. 1A.

FIG. 1C (Prior Art) is a diagram illustrating the qubit of FIG. 1A in more detail and the three Pauli matrices associated with measurements.

FIG. 1D (Prior Art) is a diagram illustrating the polar representation of the qubit of FIG. 1A.

FIG. 1E (Prior Art) is a diagram illustrating the plane orthogonal to a state vector in an eigenstate along the u-axis (indicated by unit vector û).

FIG. 1F (Prior Art) is a diagram illustrating a simple measuring apparatus for measuring two-state quantum systems such as electron spins (spinors).

FIG. 1G (Prior Art) is a diagram illustrating the fundamental limitations to finding the state vector of an identically prepared ensemble of spinors with single-axis measurements.

FIG. 2 is a diagram illustrating the most important parts and modules of a computer system according to the invention in a basic configuration.

FIG. 3A is a diagram showing in more detail the mapping module of the computer system from FIG. 2 and the inventory store of relevant items.

FIG. 3B is a flow diagram of several initial steps performed by the mapping module to generate a quantum representation.

FIG. 3C is a diagram visualizing the operation of the assignment module in formally assigning quantum subject states |Sᵢ [symbol] to subjects Sᵢ qualifying for quantum representation.

FIG. 3D is a diagram that illustrates the derivation of value matrices PR for three specific subject values used in contextualizations by test subjects of an underlying proposition about a specific item.

FIG. 4 is a diagram to aid in the visualization of the computation of a quantum mechanical expectation value.

FIG. 5A is a diagram illustrating three separate situations in which two pairs of subjects that can entangle and a subject that cannot entangle are confronted by a proposition.

FIG. 5B is a diagram illustrating the underpinnings of the process of entanglement that leads to an anti-symmetric joint subject state.

FIG. 5C is a diagram illustrates the overall process of formation of the anti-symmetric joint subject state.

FIG. 5D is a diagram with a time line affording a more detailed look at the formation of the anti-symmetric joint subject state.

FIG. 5E is a diagram illustrating the consequences of entanglement between subjects in the anti-symmetric joint subject state.

FIG. 5F is a diagram illustrating the sense in which entanglement transcends contextualization by examining the non-locality aspect of the quantum representation adopted herein.

### DETAILED DESCRIPTION

The drawing figures and the following description relate to preferred embodiments of the present invention by way of illustration only. It should be noted that from the following discussion many alternative embodiments of the methods and systems disclosed herein will be readily recognized as viable options. These may be employed without straying from the principles of the claimed invention. Likewise, the figures depict embodiments of the present invention for purposes of illustration only.

Prior to describing the embodiments of the apparatus or computer systems and methods of the present invention it is important to articulate what this invention is not attempting to imply or teach. This invention does not take any ideological positions on the nature of the human mind or the mind of any subject that may qualify as a sentient subject or being, thus falling within the meaning of the term subject, test subject or observer as used in the present invention. This invention also does not try to answer any philosophical questions related to epistemology or ontology. The instant invention does not attempt, nor does it presume to be able to follow up on the suggestions of Niels Bohr and actually find which particular processes or mechanisms in the brain of a subject need or should be modeled with the tools of quantum mechanics. This work is also not a formalization of the theory of personality based on a correspondent quantum representation. Such formalization may someday follow, but would require a full formal motivation of the transition from Bayesian probability models to quantum mechanical ones. Formal arguments would also require a justification of the mapping between non-classical portions of subject/human emotional and thought spaces/processes and their quantum representation. The latter would include a description of the correspondent Hilbert space, including a proper basis, support, rules for unitary evolution, formal commutation and anti-commutation relations between observables as well as explanation of which aspects are subject to entanglement with each other and the environment (decoherence).

Instead, the present invention takes a highly data-driven approach to tracking selected subjects, which may herein be sometimes referred to as test subjects. The quantum states will be assigned to these subjects modulo or with respect to underlying propositions using pragmatic state vector assignments. In some implementations, the state vectors can be represented by quantum bits or qubits. In more robust approaches, the quantum representation may deploy density matrices instead of state vectors. Such transition in description will be clearly justified to those skilled in the art when the state of the subject is not reasonably pure.

The availability of “big data” that documents online life, and in particular online as well as real-life responses of subjects to various propositions including simple “yes/no” type questions, has made extremely large amounts of subject data ubiquitous. The test subjects can thus be isolated out of the large numbers of potentially available subjects based on measured data. Quantum mechanical tests require large numbers of identically or at least similarly prepared states to examine in order to ascertain any quantum effects. For the first time, these practical developments in “big data” and the capture of massive numbers of measurements permit one to apply the tools of quantum mechanics to uncover such quantum aspects of test subject behaviors or measurable indications as they manifest when confronted by underlying propositions, i.e., as a result of contextualizations. Specifically, it is finally feasible to set up a quantum mechanical model of test subject states and check for signs of quantum mechanical relationships and quantum mechanical statistics in the context of certain propositions that the test subjects perceive.

Thus, rather than postulating any a priori relationships between different states, e.g., the Jungian categories, we only assume that self-reported or otherwise obtained/derived data about test subjects and their contextualizations of underlying propositions of interest is reasonably accurate. In particular, we rely on the data to be sufficiently accurate to permit the assignment of state vectors or qubits to the test subjects. We also assume that the states suffer relatively limited perturbation and that they do not evolve quickly enough over time-frames of measurement(s) (long decoherence time) to affect the model. Additional qualifications as to the regimes or realms of validity of the model will be presented below as required.

No a priori relationships between different state vectors or qubits representing test subjects and their contextualizations of propositions is presumed. Thus, the assignment of state vectors or qubits in the present invention is performed in the most agnostic manner possible. This is done prior to testing for any complicated relationships. Preferably, the subject state assignments with respect to the underlying proposition are first tested empirically based on historical data available for the subjects. In this manner the correct set of test subjects can be isolated. Curation of relevant metrics is performed to aid in the process of discovering quantum mechanical relationships in the data. The curation step preferably includes a final review by human experts or expert curators that may have direct experience of relevant state(s) as well as well as experience(s) when confronted by the underlying propositions under investigation. Specifically, the human curator should have a “personal understanding” of the various ways in which the underlying proposition may be contextualized by the different test subjects that are being selected in accordance with the invention.

Before describing the act of perturbing a subject's contextualization and detecting the effects of such perturbation it is important to review the foundations of a quantum representation on which the idea of tracking subject behaviors or, more generally, their measurable indications is based. To accomplish this we will first review a general apparatus. The main parts and modules of such an apparatus are embodied in a computer system 100 designed for tracking the behaviors of subjects is illustrated in FIG. 2. Computer system 100 is designed around a number of subjects S₁, S₂, . . . , Sₘ. For convenience, subjects Sᵢ, S₂, . . . , Sₘ will be enumerated with the aid of index i thus referring to subjects Sᵢ, where i=1, 2, . . . , m and m is the total number of subjects.

All subjects Sᵢ in the present embodiment are human beings. They may be selected here from a much larger group of many subjects that are not expressly shown. In the subsequent description some of these additional subjects that were not chosen will be introduced separately. In principle, subjects Sᵢ can embody any sentient beings other than humans, e.g., animals. However, the efficacy in applying the methods of invention will usually be highest when dealing with human subjects.

Subject S₁ has a networked device 102a, here embodied by a smartphone, to enable him or her to communicate data about them in a way that can be captured and processed. In this embodiment, smartphone 102a is connected to a network 104 that is highly efficient at capturing, classifying, sorting, and storing data as well as making it highly available. Thus, although subject S₁ could be known from their actions observed and reported in regular life, in the present case subject S₁ is known from their online presence and communications as documented on network 104.

Similarly, subject S₂ has a networked device 102b, embodied by a smart watch. Smart watch 102b enables subject S₂ to share personal data just like subject S₁. For this reason, watch 102b is also connected to network 104 to capture the data generated by subject S₂. Other subjects are similarly provisioned, with the last or m-th subject Sₘ shown here deploying a tablet computer with a stylus as his networked device 102m. Tablet computer 102m is also connected to network 104 that captures data from subjects. The average practitioner will realize that any networked device can share some aspect of the subject's personal data. In fact, devices on the internet of things, including simple networked sensors that are carried, worn or otherwise coupled to some aspect of the subject's personal data (e.g., movement, state of health, or other physical or emotional parameter that is measurable by the networked sensor) are contemplated to belong to networked devices in the sense of the present invention.

Network 104 can be the Internet, the World Wide Web or any other wide area network (WAN) or local area network (LAN) that is private or public. Furthermore, some or all subjects Sᵢ may be members of a social group 106 that is hosted on network 104. Social group or social network 106 can include any online community such as Facebook, LinkedIn, Google+, MySpace, Instagram, Tumblr, YouTube or any number of other groups or networks in which subjects Sᵢ are active or passive participants. Additionally, documented online presence of subjects Sᵢ includes relationships with product sites such as Amazon.com, Walmart.com, bestbuy.com as well as affinity groups such as Groupon.com and even with shopping sites specialized by media type and purchasing behavior, such as Netflix.com, iTunes, Pandora and Spotify. Relationships from network 106 that is erected around an explicit social graph or friend/follower model are preferred due to the richness of relationship data that augments documented online presence of subjects Sᵢ.

Computer system 100 has a memory 108 for storing measurable indications a, b that correspond to state vectors or just simply states |Sᵢ [symbol] in internal spaces 110a, 110b, . . . , 110m of subjects Sᵢ defined modulo an underlying proposition 107. In accordance with the present invention, measurable indications a, b are preferably chosen to be mutually exclusive indications. Mutually exclusive indications are actions, responses or still other indications that subjects Sᵢ cannot manifest simultaneously. For example, measurable indications a, b are mutually exclusive when they correspond to “YES”/“NO” type responses, choices, actions or any other measurable indications of which subjects Sᵢ can manifest just one at a time with respect to underlying proposition 107. Subjects Sᵢ also preferably report, either directly or indirectly (in indirect terms contained in their on-line communications) their measurable indications via their networked devices 102a, 102b, . . . , 102m.

It should be duly noted that it is not a limitation of the quantum representation adopted herein to require that measurable indications come in pairs, such as measurable indications a, b in the present example. Measurable indications can span many values, as any person skilled in the art will recognize. It is also not a limitation that the values of such pairs exhibit discrete precipitation type; they may instead cover a continuous range. The reader is referred to the teachings contained in U.S. patent application Ser. No. 14/324,127 to review why the choice of measurable indications that precipitate as pairs of discrete values, and in particular as mutually exclusive pairs is advantageous.

In the first example, underlying proposition 107 is associated with an item that is instantiated by a specific object 109a. It is noted that specific object 109a is selected here in order to ground the rather intricate quantum-mechanical explanation to follow in a very concrete setting for purposes of better understanding and more practical teaching of the invention. Thus, underlying proposition 107 revolves around object 109a being a pair of shoes that subjects Sᵢ have been exposed to on their home log-in pages to network 104. For example, the log-in page could have been Yahoo News and shoes 109a were presented next to typical items such as Khardashians or Snookies.

The nature of any underlying proposition in the sense of the invention is that it is “about something”. It is that “something that it's about” that leads to the contextualizations of the underlying proposition by subjects Sᵢ according to their frames of mind, apprehensions, conceptions, context rule(s) or, most generally put, their values. The “something that it's about” is generally one or more items that are either physical or non-physical. In the present example the item is instantiated by an object, namely shoes 109a. However, items can be any commonly perceived objects or even commonly perceived subjects or experiences.

For example, a legitimate item can be one of subjects Sᵢ from the point of view of any other subject. Still another permissible type or category of items includes non-physical or experiential goods such as commonly perceived experiences. The experience of watching a movie, flying a kite, meeting a subject, driving a car and so on are therefore legitimate items. It is important, however, that qualifying items be commonly perceived by subjects Sᵢ.

By commonly perceived we specifically do not mean that they are contextualized according to the same value by all subjects Sᵢ. Instead, commonly as used herein means that at least in principle all subjects Sᵢ are capable of apprehending the underlying proposition about the item in question. For example, if the item is the experiential good of driving a car, then it is a commonly perceived item for virtually all subjects Sᵢ that live in developed countries. On the other hand, if the experiential good is a religious conversion to a specific deity then, most likely, only subjects Sᵢ that belong to that religious group commonly perceive that item. It is on this common perceptual basis that inclusion of just any subjects in general for the purpose of tracking is usually not productive. For this reason, it is advantageous to carefully select or vet subjects Sᵢ that are known to commonly perceive the item(s) that are used in formulating the underlying proposition(s) before commencing any tracking, testing and/or simulating activities.

The term contextualization will be used herein to denote a process. It is the process that commences with a subject being exposed to or confronted with an underlying proposition. The subject is free to apprehend, perceive, understand, evaluate and/or value in any of the number of personal ways that the subject can select. This confrontation of any subject including the subjects we are interested in by the underlying proposition as well as that subject's choice about how or in accordance with what value to make sense of the underlying proposition will be referred to herein as a contextualization of the underlying proposition by that subject.

Typically, many different contextualizations of the same underlying proposition are available to any one of subjects Sᵢ. Some of the available contextualizations are incompatible. These will later be represented by non-commuting quantum mechanical operators introduced by the quantum representation according to the invention. Some other available contextualizations are compatible. These, on the other hand, will later be represented by commuting quantum mechanical operators. Note that in some cases we may refer to the propositions as being incompatible. The reason for this ambiguity in the use of language is that quantum mechanics is rather difficult to translate directly into human language without any ambiguities. In fact, the Uncertainty Principle that we are invoking is the very definition of ambiguity of frame choice or “how to understand” or “how to take” a given proposition. Nevertheless, when referring to incompatible contextualizations, apprehensions, frames of mind, propositions, and more generally values, which is our preferred term whenever possible, we do mean that the quantum mechanical operators associated with these will be non-commuting rather than commuting. By the term non-commuting we mean that the commutator between these quantum mechanical operators is non-zero.

One of the main aspects of the present invention relates to enabling computer system 100 to track the behaviors of subjects Sᵢ that are generated in response to contextualizations. We are interested in behaviors generated irrespective of the type of contextualizations actually experienced by subjects. More precisely still, system 100 is designed to track measurable indications a, b that include any type of behavior, action, response or any other indication that can be measured or reported within the framework set up by computer system 100. From the point of view of the quantum representation, measurable indications are measurements. Measurements are the real-valued results that manifest or emerge as fact in response to quantum measurement. The nature of measurable indications generated as a result of contextualizations of underlying proposition 107 by subjects Sᵢ will be discussed in much more detail below.

In the present embodiment, measurable indications a, b are captured in data files 112-S1, 112-S2, . . . , 112-Sm that are generated by subjects S₁, S₂, . . . , Sₘ. Conveniently, following socially acceptable standards, data files 112-S1, 112-S2, . . . , 112-Sm are shared by subjects Sᵢ with network 104 by transmission via their respective networked devices 102a, 102b, . . . , 102m. Network 104 either delivers data files 112-S1, 112-S2, . . . , 112-Sm to any authorized network requestor or channels it to memory 108 for archiving and/or later use. Memory 108 can be a mass storage device for archiving all activities on network 104, or a dedicated device of smaller capacity for tracking just the activities of some subjects of which subjects Sᵢ are a subset.

It should be pointed out that in principle any method or manner of obtaining the chosen measurable indications, i.e., either a or b, from subjects Sᵢ is acceptable. Thus, the measurable indications can be produced in response to direct questions posed to subjects Sᵢ, a “push” of prompting message(s), or externally unprovoked self-reports that are conscious or even unconscious (e.g., when deploying a personal sensor as the networked device that reports on some body parameter such as, for example, heartbeat). Preferably, however, the measurable indications are delivered in data files 112-S1, 112-S2, . . . , 112-Sm generated by subjects Sᵢ. This mode enables efficient collection, classification, sorting as well as reliable storage and retrieval from memory 108 of computer system 100. The advantage of the modern connected world is that large quantities of self-reported measurable indications of states |Sᵢ [symbol] in internal spaces 110a, 110b, . . . , 110m are generated by subjects Sᵢ and shared, frequently even in real time, with network 104. This represents a massive improvement in terms of data collection time, data freshness and, of course, sheer quantity of reported data.

Subjects Sᵢ can either be aware or not aware of their respective measurable indications. For example, data files 112-S1, 112-S2, . . . , 112-Sm of subjects Sᵢ reporting of their responses, actions or other indications can be shared among subjects Sᵢ such that everyone is informed. This may happen upon request, e.g., because subjects Sᵢ are fiends in social network 106 and may have elected to be appraised of their friends' responses, actions and other indications such as parameters of their well-being (e.g., those measured by personal sensors mentioned above), or it may be unsolicited. The nature of the communications broadcasting the choices can be one-to-one, one-to-many or many-to-many.

In principle, any mode of communication between subjects Sᵢ is permissible including blind, one-directional transmission. For this reason, in the present situation any given subject can be referred to as the transmitting subject and another subject can be referred to as the receiving subject to more clearly indicate the direction of communication in any particular case. Note that broadcasts of responses, actions or other measurable indications from the subjects need not be carried via network 104 at all. They may occur via any medium, e.g., during a physical encounter between transmitting and receiving subjects or by the mere act of one subject observing the chosen response, action or other measurable indication of another subject. Indeed, as mentioned above, the method of the invention can be practiced in situations where no inter-subject communications take place at all and all subjects Sᵢ merely report their measurable indications via network 104.

When inter-subject communications takes place, the exposure of receiving subjects to broadcasts of transmitting subjects carrying any type of information about the transmitter's choice of measurable indication vis-à-vis underlying proposition 107 may take place online or offline (e.g., in real life). Preferably, however, all broadcasts are carried via network 104 or even within social network 106, if all transmitting and receiving subjects Sᵢ are members of network 106.

Computer system 100 is equipped with a separate computer or processor 114 for making a number of crucial assignments based on measurable indications a, b contained in data files 112-S1, 112-S2, . . . , 112-Sm of subjects Sᵢ. For this reason, computer 114 is either connected to network 104 directly, or, preferably, it is connected to memory 108 from where it can retrieve data files 112-S1, 112-S2, . . . , 112-Sm at its own convenience. It is noted that the quantum representation underlying the present invention will perform best when large amounts of data are available. Therefore, it is preferred that computer 114 leave the task of storing and organizing data files 112-S1, 112-S2, . . . , 112-Sm as well as any relevant data files from other subjects to the resources of network 104 and memory 108, rather than deploying its own resources for this job.

Computer 114 has a mapping module 115 for finding an internal space or a values space that is shared by subjects Sᵢ. Module 115 can be embodied by a simple non-quantum unit that compares records from network 104 and/or social network 106 to ascertain that subjects Sᵢ are friends or otherwise in some relationship to one another. Based on this relationship and/or just propositions over which subjects Sᵢ have interacted in the past, mapping module 115 can find the shared or common internal space that will henceforth be referred to herein as community values space. It is important that mapping module 115 confirm that the community values space is shared modulo underlying proposition 107 in particular.

The community values space corresponds to a regime or realm of shared excitements, interests, proclivities, beliefs, likes, dislikes and/or opinions over various items represented, among other, by objects, subjects or experiences (e.g., activities). For the sake of a simple example, all subjects Sᵢ that are candidates for the subset which can be considered as a group or community can be interested in shoes, sports, coffee, car racing, movies, dating and making money. In most practical applications, however, it will be sufficient to confirm that subjects Sᵢ are aware of the same items. This means that they perceive these items in the group or community values space common to the subset/group/community of subjects Sᵢ. Of course, that certainly does not mean that all subjects Sᵢ will or are even likely to contextualize the underlying propositions about the items of which they are all aware in the same way. The meaning of this last statement will be explained in much more detail below.

Computer 114 is equipped with a creation module 117 that is connected to mapping module 115. Creation module 117 is designed for positing the selected subjects Sᵢ that belong to a group or community by virtue of sharing a community values space modulo proposition 107. The action of positing is connected with the quantum mechanical action associated with the application of creation operators. Also, annihilation operators are used for un-positing or removing subjects Sᵢ from consideration.

The creation and annihilation aspects of the operation of creation module 117 are required for formal positing of the state vectors (and in more robust representations of the density matrices) corresponding to quantized entities. These steps depend on whether the entity obeys the Fermi-Dirac anti-consensus statistics (F-D statistics) or the Bose-Einstein consensus statistics (B-E statistics) as well as several other considerations due to the quantum mechanical representation. All of these aspects have been previously described in detail in U.S. patent application Ser. No. 14/324,127. They will be reviewed here to the extent required to contextualize the present invention.

Further, computer 114 has an assignment module 116 that is connected to creation module 117. Assignment module 116 is designed for the task of making certain assignments based on the quantum representations adopted by the instant invention. More precisely, assignment module is tasked with assigning to each one of the selected subjects Sᵢ discovered by mapping module 115 and posited by creation module 117 a subject state |Sᵢ [symbol] . All assigned subject states |Sᵢ [symbol] reside in a group or community state space [symbol] ^{(C)}, which is the Hilbert space associated with the community values space.

Assignment module 116 is indicated as residing in computer 114, but in many embodiments it can be located in a separate processing unit altogether. This is mainly due to the nature of the assignments being made and the processing required. More precisely, assignments related to quantum mechanical representations are very computationally intensive for central processing units (CPUs) of regular computers. In many cases, units with graphic processing units (GPUs) are more suitable for implementing the linear algebra instructions associated with assignments dictated by the quantum model that assignment module 116 has to effectuate.

Computer system 100 has a graphing module 119 connected to assignment module 116. Computer 114 deploys graphing module 119 for placing subject states |Sᵢ [symbol] , as assigned by assignment module 116, on a graph or any construct that encodes the interconnections that exist between subjects Sᵢ. In cases where the interconnections are tenuous, uncertain or even unknown, graphing module 119 may place subject states |Sᵢ [symbol] in a disconnected context (i.e., on nodes/vertices without any connecting edges). Lack of interconnections indicates no inter-subject communications.

In cases where interconnections are known, e.g., from a social graph that interconnects subjects Sᵢ, graphing module 119 places subject states |Sᵢ [symbol] of subject states Sᵢ at the corresponded nodes or vertices of the social graph. In general, however, the mapping as understood herein reaches beyond the concept of one subject per vertex in a social graph setting—in this larger context the mapping is understood to be a surjective mapping. In other words, the mapping is onto the graph but not typically one-to-one. Graphs as defined herein include any type of structures that include interconnections, e.g., links or edges, between entities that may be related to one or more vertices, nodes or points. For example, the graph may be a social graph, a tree graph, a general interconnected diagram or chart (also see graph theory and category theory). In some embodiments described herein the chosen graph corresponds to a physical system, such as a lattice or other less-organized structures such as spin-glass. Various aspects of the graphing or mapping process including adjustments and simplifications (e.g., pruning) have been previously discussed in U.S. patent application Ser. No. 14/324,127. Therefore, only the aspects of graphing most relevant to the present invention and the below examples will be discussed herein.

Computer 114 also has a statistics module 118 connected to graphing module 119. Statistics module 118 is designed for estimating various fundamental quantum parameters of the graph model that lead to classical probabilities and/or large-scale phenomena and behaviors. In some embodiments statistics module 118 also estimates or computes classical probabilities. Most importantly, however, statistics module 118 estimates a degree of incompatibility between the values according to which subjects Sᵢ contextualize underlying propositions of interest in the social values space or rather in its quantum equivalent—community state space [symbol] ^{(C)}.

Computer 114 is further provisioned with a prediction module 122 that is in turn connected to statistics module 118. The quantum interactions between the various quantum states |Sᵢ [symbol] imported onto the graph by graphing module 119 are used by prediction module 122 for predicting subject states |Sᵢ [symbol] about underlying proposition 107. Prediction module 122 is connected to statistics module 118 in order to receive the estimated probabilities and value information. Of course, it also receives as input the data generated and prepared by the previous modules, including data about the graph generated by graphing module 119 based on still prior inputs from assignment module 116, creation module 117 and mapping module 115.

Prediction module 122 can reside in computer 114, as shown in this embodiment or it can be a separate unit. For reasons analogous to those affecting assignment module 116, prediction module 122 can benefit from being implemented in a GPU with associated hardware well known to those skilled in the art.

Computer system 100 has a network monitoring unit 120. Unit 120 monitors and tracks at the very least the network behaviors and communications of subjects Sᵢ in the identified group or community. Network monitoring unit 120 preferably monitors entire network 104 including members of specific social groups 106. When specific subjects Sᵢ are selected for tracking and for any subsequent model, simulation and/or prediction, they thus fall into a subset of all subjects tracked by monitoring unit 120. To be effective, unit 120 is preferably equipped with wire-rate data interception capabilities for rapid ingestion and processing. This enables unit 120 to capture and process data from data files 112 of large numbers of subjects connected to network 104 and discern large-scale patterns in nearly real-time.

Statistics module 118 is connected to network monitoring unit 120 to obtain from it behavior information for maintaining up-to-date its classical event probabilities as well as quantum parameters, especially including subject contextualizations. It is duly noted, that computer 104 can gather relevant information about the subjects on its own from archived data files 112 in memory 108. This approach is not preferred, however, due to concerns about data freshness and the additional computational burden placed on computer 104.

Computer system 100 has a random event mechanism 124 connected to both statistics module 118 and prediction module 122. From those modules, random event mechanism can be seeded with certain estimated quantum parameters as well as other statistical information, including classical probabilities to randomly generate events on the graph in accordance with those probabilities and statistical information. Advantageously, random event mechanism 124 is further connected to a simulation engine 126 to supply it with input data. In the present embodiment simulation engine 126 is also connected to prediction module 122 to be properly initialized in advance of any simulation runs. The output of simulation engine 126 can be delivered to other useful apparatus where it can serve as input to secondary applications such as large-scale tracking, modeling, simulation and/or prediction mechanisms for social or commercial purposes or to market analysis tools and online sales engines. Furthermore, simulation engine 126 is also connected to network monitoring unit 120 in this embodiment in order to aid unit 120 in its task of discerning patterns affecting subjects Sᵢ (as well as other subjects, as may be required) based on data passing through network 104.

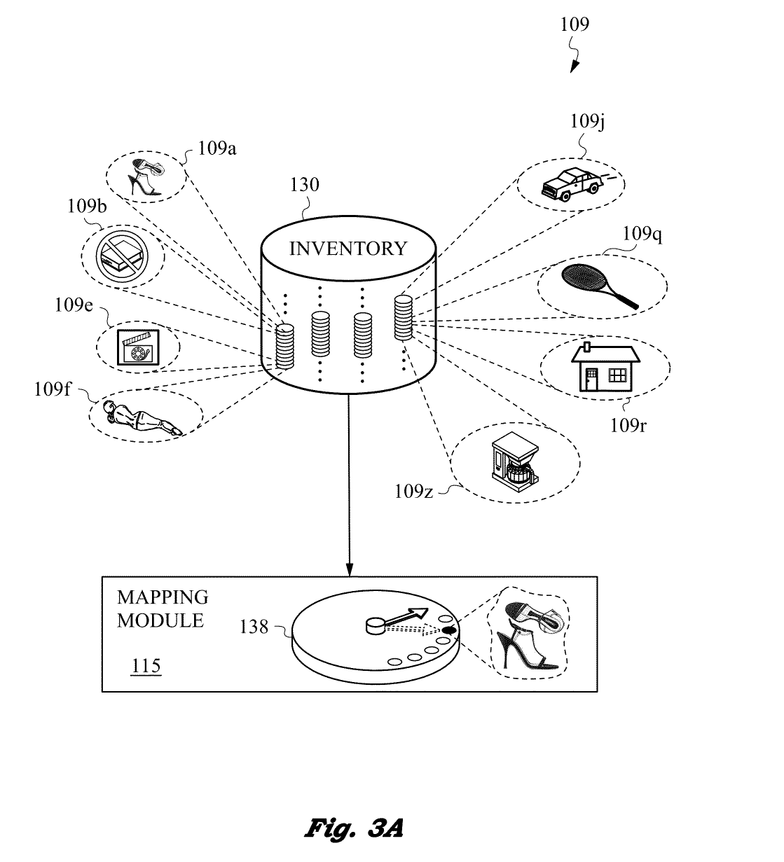

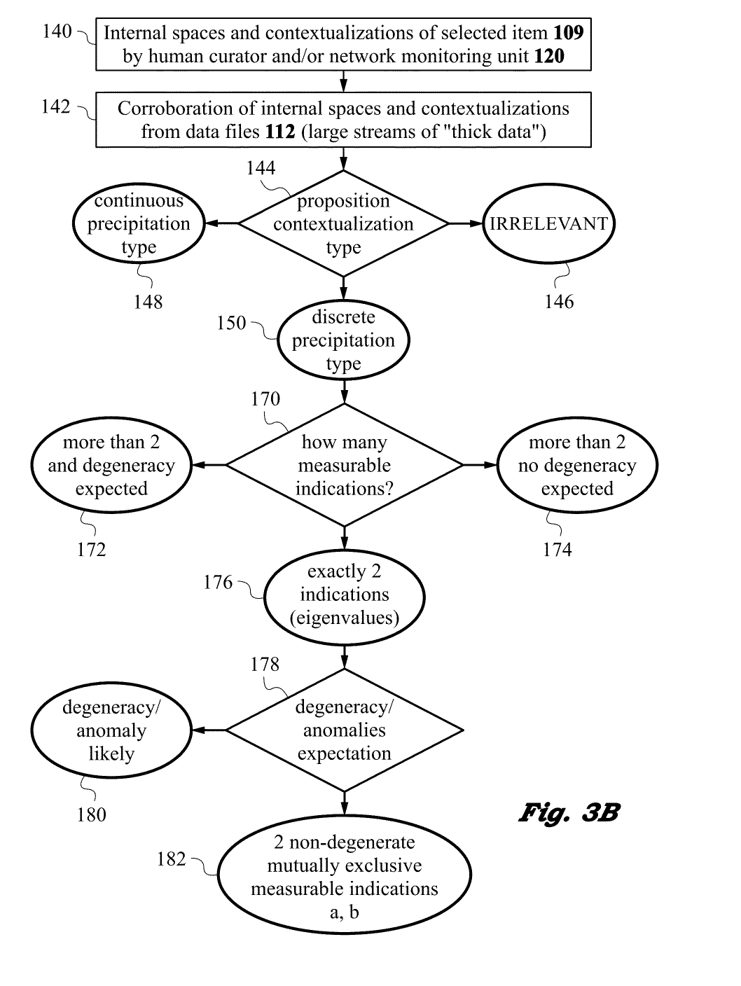

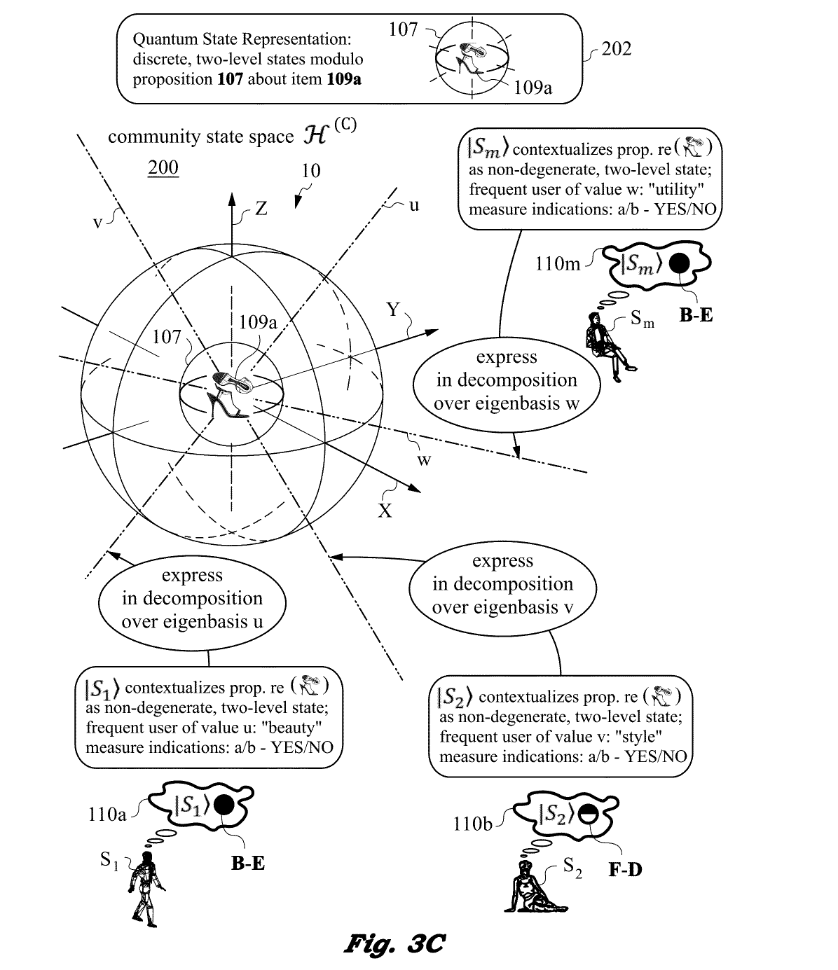

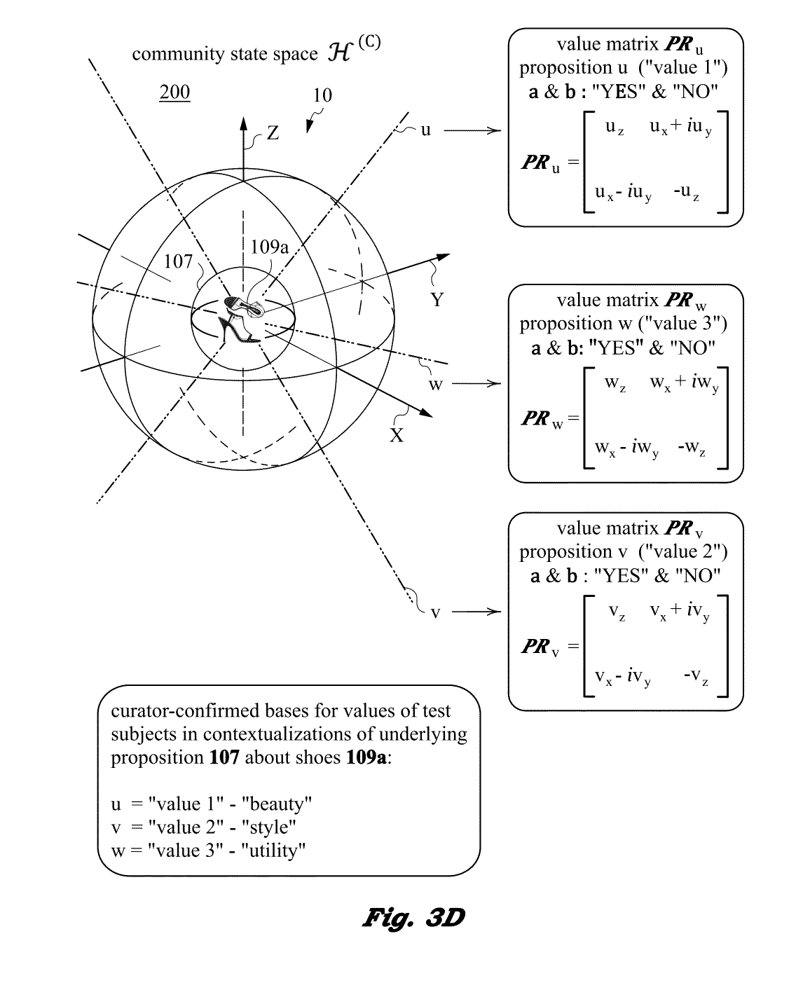

We will now examine the operation of computer system 100 in incremental steps guided by the functions performed by the modules introduced in FIG. 2 and any requisite secondary resources. Our starting point is mapping module 115 in conjunction with an inventory store 130 to which it is connected as shown in FIG. 3A. Computer system 100 is designed to work with many underlying propositions 107 about different items 109. In other words, item 109a that is an object instantiated by the pair of shoes depicted in FIG. 2 is merely one exemplary object that is used for the purpose of a more clear and practical explanation of the present invention.

Meanwhile, inventory store 130 contains a large number of eligible items. As understood herein, items 109 include objects, subjects, experiences (aka experiential goods) and any other items that subjects Sᵢ can contextualize in their minds to yield underlying proposition 107. Preferably, a human curator familiar with human experience and specifically with the lives and cognitive expectations of subjects under consideration should review the final inventory of items 109. The curator should not include among items 109 any that do not register any response, i.e., those generating a null response among the subjects. Responses obtained in a context that is not of interest may be considered as mis-contextualized and the item that provokes them should be left out if their consideration is outside the scope of tracking. All null responses and mis-contextualizations should preferably be confirmed by prior encounters with the potentially irrelevant item by subjects Sᵢ. The curator may be able to further understand the reasons for irrelevance and mis-contextualization to thus rule out the specific item from inventory store 130.

For example, a specific item 109b embodied by a book about ordinary and partial differential equations is shown as being deselected in FIG. 3A. The elimination of book 109b is affirmed by the human curator, who understands the human reasons for the book's lack of appeal. In the case at hand, all subjects reporting on network 104 are members of a group that does not consider the language of mathematics relevant to their lives. Thus, most of the time that book 109b is encountered by the subjects it evokes a null response as they are unlikely to register its existence. The possible exception is in the case of unanticipated contextualization, e.g., as a “heavy object” for purposes of “weighing something down”. If the prediction does not want to take into account such mis-contextualization then book 109b should be left out. If, on the other hand, contextualization of textbooks as heavy objects were of interest in tracking, then book 109b should be kept in inventory store 130.

It is also possible to supplement or, under some circumstances even replace the vetting of items 109 by a human curator with a cross-check deploying network monitoring unit 120. That is because monitoring unit 120 is in charge of reviewing all data files 112 to track and monitor communications and behaviors of all subjects on network 104. Hence, it possesses the necessary information to at the very least supplement human insights about reactions to items 109 and their most common contextualizations. For example, despite the intuition of the human curator book 109b could have provoked a reaction and anticipated contextualization, e.g., as a study resource, by at least a few subjects. Such findings would be discovered by network monitoring unit 120 in reviewing data files 112. These findings should override the human curator's judgment in a purely data-driven approach to tracking. Such pragmatism is indeed recommended in the preferred embodiments of the present invention to ensure discovery of quantum effects and derivation of correspondent practical benefits from these findings.

After vetting by the human curator and corroboration by network monitoring unit 120, inventory store 130 will contain all items of interest to the subjects and presenting to them in contextualizations that are within the scope of tracking. For example, items 109a, 109q, 109r and 109z from store 130 all fall into the category of objects embodied here by shoes, a tennis racket, a house and a coffee maker. A subject 109f embodied by a possible romantic interest to one or more subjects Sᵢ to be confronted by proposition 107 is also shown. Further, store 130 contains many experiential goods of which two are shown. These are experiences 109e, 109j embodied by watching a movie and taking a ride in a sports car, respectively. Numerous other objects, subjects and experiences are kept within store 130 for building different types of underlying propositions 107.

In order to follow the next steps with reference to a concrete example to help ground the explanation, we consider shoes 109a that were chosen by mapping module 115 from among all vetted items 109 in inventory store 130. To make the choice module 115 has a selection mechanism 138. Mechanism 138 is any suitable apparatus for performing the selection among items 109 in store 130. It is noted that selection mechanism 138 can either be fully computer-implemented for picking items 109 in accordance with a computerized schedule or it can include an input mechanism that responds to human input. In other words, mechanism 138 can support automatic or human-initiated selection of items 109 for tracking of contextualizations under the quantum representation of the present invention.

FIG. 3B illustrates the steps performed by mapping module 115 in further examining the internal spaces 110a, 110b, . . . , 110m of subjects Sᵢ and their contextualizations. More precisely, mapping module 115 takes the first formal steps to treating these concepts in accordance with a quantum representation as adopted herein. Any specific quantum representation will apply in the community values space postulated to exist between subjects Sᵢ. It should be remarked here that all steps performed to arrive at a quantum representation of subjects Sᵢ in their contextualizations of the underlying propositions about the item also apply to obtaining a quantum representation of any additional or separate subject(s). Such subject(s) may or may not share the same community values space but may nonetheless be of interest.

In a first step 140, mapping module 115 selects item 109 and presumes that item 109 registers in the community values space. The observed contextualizations of item 109 as found by network monitoring unit 120 and/or the human curator are also imported by mapping module 115. Obtaining a large amount of data at this pre-tracking or calibration stage is very advantageous.

In a second step 142, mapping module 115 corroborates the existence of the overall internal space, namely community values space and of the contextualizations by cross-checking data files 112. In performing step 142, mapping module 115 typically accesses memory 108 and archived data files 112. This allows mapping module 115 to look over “thick data”, i.e., data files 112 that present a historically large stream of information that relates to item 109. In this manner the relevance of item 109 and hence its registration specifically in internal spaces 110a, 110b, . . . , 110m belonging to the select subjects Sᵢ forming the presumptive community or group can be further ascertained and more carefully quantified. For example, a number of occurrences of a response, a reference to or an action involving item 109 over time is counted. At this point, if item 109 has an ephemeral existence in the minds of the subjects then mapping module 115 could provide that information to the human user. Should prediction of fads not be of interest for the prediction or simulation, then the human user of computer system 100 could stop the process and induce the choice of a different item 109.

Assuming that item 109 remains of interest, then mapping module 115 proceeds to step three 144. Step 144 is important from the point of view of the quantum representation as it relates to the type of contextualization of underlying proposition 107 about item 109 by subjects Sᵢ. We consider two precipitation types and a null result or “IRRELEVANT” designated by 146. Of course, the careful reader will have noticed that items 109 that induce a null response encoded here by “IRRELEVANT” 146 were previously eliminated. However, since step 144 determines the precipitation for each subject concerned, and some of the subjects may not register item 109 despite the fact that a large number of their peers do, it is necessary to retain the option of null outcome 146 in step 144.

The first precipitation type being considered herein is a continuous precipitation type 148. The second type is a discrete precipitation type 150. Although continuous precipitation type 148 certainly admits of a quantum representation and has been discussed in more detail in U.S. patent application Ser. No. 14/324,127 we will focus on discrete precipitation type 150 in the present discussion. That is because despite the fact that continuous precipitation type 148 can be used in apparatus and methods of the invention, it is more difficult to model it with graphs and the mathematical formalism is more involved. Furthermore, such continuous precipitation type 148 does not typically yield clearly discernible, mutually exclusive responses by subjects in their contextualizations (e.g., modulo underlying proposition 107 about shoes 109a in the present example). In other words, in the case of shoes 109a as an example, continuous precipitation type 148 in the contextualization of say “LIKE” could yield a wide spread in the degree of liking of shoes 109a for a multitude of reasons and considerations. Of course, a skilled artisan will be able to adopt the present teachings to continuous cases using standard tools known in the art.

In preferred embodiments of the invention we seek simple precipitation types corresponding to simple contextualizations of underlying proposition 107. In other words, we seek to confirm the community or group of subjects Sᵢ in whose minds or internal spaces 110a, 110b, . . . , 110m proposition 107 about shoes 109a induces discrete precipitation type 150. This precipitation type should apply individually to each subject making up such a group or community. Of course, subjects embedded in their normal lives cannot be tested for precipitation type entirely outside the context they inhabit. Some error may thus be present in the assessment of precipitation type for each subject. To the extent possible, such error can be kept low by reviewing previous precipitation types the subject under review exhibited with respect to similar propositions and ideally similar propositions about the same item. Further, a review of precipitation type by the human curator is advantageous to corroborate precipitation type.

It is further preferred that the contextualization be just in terms of a few mutually exclusive states and correspondent mutually exclusive responses or, more generally measurable indications that the subject can exhibit. Most preferably, the contextualization of underlying proposition 107 corresponds to discrete precipitation type 150 that manifests only two orthogonal internal states and associated mutually exclusive responses such as “YES” and “NO”. In fact, for most of the present application we will be concerned with exactly such cases for reasons of clarity of explanation. Once again, review by the human curator is highly desirable in estimating the number of internal states.

Additionally, discrete precipitation type 150 into just two orthogonal states associated with two distinct eigenvalues corresponds to the physical example of spinors that we have already explored in the background section. Many mathematical and applied physics tools have been developed over the past decades to handle these entities. Thus, although more complex precipitation types and numerous orthogonal states can certainly be handled by the tools available to those skilled in the art (see, e.g., references on working in the energy or Hamiltonian eigen-basis of general systems), cases where subjects' internal states are mapped to two-level quantum systems are by far the most efficient. Also, two-level systems tend to keep the computational burden on computer system 100 within a reasonable range and do not require excessively large amounts of data files 112 to set up in practice. Two-level systems will also tend to keep the computational burden low even when the more robust descriptions of subject states in terms of correspondent density matrices have to be implemented.

For the above reasons we now continue with the case of discrete precipitation type 150 modulo proposition 107 about shoes 109a admitting of only discrete and orthogonal eigenstates. In other words, internal states |Sᵢ [symbol] residing in internal spaces 110a, 110b, . . . , 110m decompose into superpositions of these few discrete and orthogonal eigenstates.

In this most preferred case, discrete precipitation type 150 induces subjects Sᵢ to contextualize underlying proposition 107 about shoes 109a in terms of just two mutually exclusive states manifesting in mutually exclusive responses such as “YES” and “NO”. Thus, the manner in which subjects Sᵢ contextualize proposition 107 in this preferred two-level form can be mapped to quantum-mechanically well-understood entities such as simple spinors or qubits. However, before proceeding to the next step performed by mapping module 115 with subjects Sᵢ that do fall into the above preferred discrete precipitation type 150 with two eigenstates and two eigenvalues, it is important to ensure proper quantum behavior of the assigned states |Sᵢ [symbol] in common values space replaced at this point by community state space [symbol] ^{(C)}, as will be appreciated by one skilled in the art.

We now turn our attention to step 170 in which mapping module 115 confirms the number of measurable indications or eigenvalues associated with discrete precipitation type 150 to be two (2), as selected for the most preferred case. We should briefly remark on the other possibilities that we are not discussing in detail. In case 172 more than two eigenvalues are expected and some of them are associated with different state vectors. This is a classic case of a quantum mechanical system with degeneracy. In other words, the system has several linearly independent state vectors that have the same eigenvalues or measurable indications. Those skilled in the art will recognize that this typical situation is encountered often when working in the “energy-basis” dictated by the Hamiltonian.

In case 174 more than two eigenvalues are expected and all of them are associated with different state vectors. Such systems can correspond to more complicated quantum entities including spin systems with more than two possible projections along the axis on which they precipitate (e.g., total spin 1 systems). Quantum mechanical systems that are more than two-level but non-degenerate are normally easier to track than systems with degeneracy. Those skilled in the art will recognize that cases 172 and 174 can be treated with available tools.

In the preferred embodiment of the instant invention, however, we concentrate on case 176 selected in step 170 in which there are only two eigenvalues or two measurable indications. In other words, we prefer to base the apparatus and methods of invention on the two-level system. As mentioned above, it is desirable for the human curator that understands subjects Sᵢ to review these findings to limit possible errors due to misjudgment of whether the precipitation is non-degenerate and really two-level. This is preferably done by reviewing historical data of subject responses, actions and any indications available (e.g., from data files 112 archived in memory 108) that are used by mapping module 115 in making the determinations. We thus arrive at a corroborated selection of subjects Sᵢ that apparently form a community or group and exhibit discrete precipitation with just two eigenvalues and whose states |Sᵢ [symbol] in internal spaces 110a, 110b, . . . , 110m can therefore be assigned to two-level wave functions.

A final two-level system review step 178 may optionally be performed by mapping module 115. This step should only be undertaken when subjects Sᵢ can be considered based on all available data and, in the human curator's opinion, as largely independent of their social group and the overall environment. In other words, the level of quantum entanglement of subject states |Sᵢ [symbol] with the environment and with each other is low as determined with standard tools. The reader is here referred to U.S. patent application Ser. No. 14/182,281, the references cited therein and further standard references discussing Bell's Inequality, Bell single-channel and multi-channel tests.

In human terms, low levels of entanglement are likely to apply to subjects that are extremely individualistic and formulate their own opinions without apparent influence by others within their community/group or outside of it. When such radically individualistic subjects are found, their further examination is advantageous to bound potential error in assignments of state vectors |Sᵢ [symbol] and/or in the case of more rigorous procedures, any errors in the estimation of states |Sᵢ [symbol] or more robust expressions formulated with the aid of density matrices.

Preferably, mapping module 115 should divide case 176 into sub-group 180 and sub-group 182. Sub-group 180 is reserved for subjects Sᵢ that despite having passed previous selections exhibit some anomalies or couplings. These are potentially due to inter subject entanglement and/or subject to environment entanglement. Subjects Sᵢ with states |Sᵢ [symbol] manifesting substantial levels of entanglement and/or other anomalies that may cause degeneracy or other unforeseen issues should be put in sub-group 180. These subjects should be eliminated from being used in further prediction or simulation if only pure states are used. They may be retained, however, if a suitable density matrix representation is possible, as will be appreciated by those skilled in the art.

Meanwhile, sub-group 182 is reserved for confirmed well-behaved subjects Sᵢ whose states |Sᵢ [symbol] reliably manifest in two-level, non-degenerate, measurable indications a and b modulo underlying proposition 107 about the chosen item 109 (or an item very similar to item 109) as confirmed by historical data. These subjects will be assigned two-level state vectors |Sᵢ [symbol] by assignment module 116 as explained in more detail below. At this point the reader may again refer to U.S. patent application Ser. No. 14/182,281 that explains qubit-type state vector assignments in situations that center on individual subjects divorced from community effects.

In addition to selecting subjects Sᵢ that can be assigned to two-level states |Sᵢ [symbol] , mapping module 115 examines the community values space. In other words, module 115 also confirms that all subjects Sᵢ that have been qualified in the prior steps (found to exhibit the desired discrete, non-degenerate, two-level precipitation type with respect to proposition 107 about item 109a) really inhabit a group or community values space that can be represented by a single community state space [symbol] ^{(C)}. More information about this process, tensor product spaces and the requisite tools is found in U.S. patent application Ser. No. 14/324,127.

For the remaining portion of the present teachings, it will be assumed that all subjects Sᵢ are indeed found to be in sub-group 182 and thus justify assignment of state vectors or states |Sᵢ [symbol] in community state space [symbol] ^{(C)}. Furthermore, it will also be assumed herein that all subjects Sᵢ are within the appropriate range of validity of the quantum representation for the underlying propositions under study and given the items that these propositions are about. This last point is preferably confirmed by mapping module 115 prior to handing off information about subjects Sᵢ to assignment module 116 for state assignment, as discussed below. For a more thorough treatment of issues relating to renormalization and other relevant considerations in the application of the quantum representation the reader is referred to U.S. patent application Ser. No. 14/504,435.

FIG. 3C is a diagram to help in visualizing the operations performed by creation module 117 and assignment module 116. This drawing figure focuses in particular on three selected test subjects Sᵢ, S₂ and Sₘ with their respective internal spaces 110a, 110b, and 110m posited in community values space 200. The last is represented quantum mechanically by community state space [symbol] ^{(C)}. An overall context 202 for the quantum representation is included at the top of FIG. 3C. Context 202 reminds us that in their quantum mechanical representation states |Sᵢ [symbol] of all subjects Sᵢ behave as discrete, two-level systems based on the determinations made by mapping module 115 as described above. Each of those can be conveniently represented with the aid of Bloch sphere 10 as already introduced in the background section.

Creation module 117 formally posits or creates selected subjects Sᵢ that belong to the community by virtue of sharing community values space 200 modulo proposition 107. The action of positing is connected with the quantum mechanical action associated with the application of creation operators. Also, annihilation operators are used for un-positing or removing quantum states |Sᵢ [symbol] of subjects Sᵢ from consideration. Just to recall the physics assumptions being used herein when creating and annihilating states, it is important to know what type of state is being created or annihilated. Symmetric wave functions are associated with elementary (gauge) and composite bosons. Bosons have a tendency to occupy the same quantum state under suitable conditions (e.g., low enough temperature and appropriate confinement parameters). The operators used to create and annihilate bosons are specific to them. Meanwhile, fermions do not occupy the same quantum state under any conditions and give rise to the Pauli Exclusion Principle. The operators used to create and annihilate fermions are specific to them as well.

Again, it may be difficult to discern such competitive dynamic modulo proposition 107 about the same pair of shoes 109a or the need for an anti-symmetric joint state from data files 112 and communications found in traffic propagating via network 104 and within social network 106. This is why creation module 117 has to review data files 112 as well as communications of test subjects Sᵢ containing indications exhibited in situations where both were present and were confronted by propositions as similar or close as possible to proposition 107 about shoes 109a. The prevalence of “big data” as well as “thick data” that subjects produce in self-reports is again very helpful. The human curator that understands the lives of test subjects Sᵢ should preferably exercise their intuition in reviewing and approving the proposed F-D anti-consensus statistic or B-E consensus statistic based on data from pairs of subjects Sᵢ modulo proposition 107 about shoes 109a.

Once all subjects Sᵢ have their statistics determined to be either B-E consensus or F-D anti-consensus creation module 117 can properly posit them in community values space 200 as quantum states |Sᵢ [symbol] . All subject states |Sᵢ [symbol] corresponding to subjects Sᵢ exhibiting B-E consensus statistic are created by bosonic creation operator â^{†}. All subject states |Cₖ [symbol] corresponding to subjects Sᵢ exhibiting F-D anti-consensus statistic are created by fermionic creation operator ĉ^{†}. All subjects states |Sᵢ [symbol] irrespective of statistics are posited in shared community values space 200 represented by community state space [symbol] ^{(C)}.

Assignment module 116 is the one that formally associates the quantum representation to all subjects Sᵢ. This is shown explicitly only for the three states |S₁ [symbol] , |S₂ [symbol] , |Sₘ [symbol] corresponding to internal spaces 110a, 110b, 110m of three select subjects S₁, S₂, Sₘ in FIG. 3C for reasons of clarity. In the present drawing figure we see subject S₁ with internal state 110a already assigned to a two-level quantum state vector or simply state |S₁ [symbol] with a B-E marking. The marking serves to remind us that subject S₁ exhibits B-E consensus statistic with respect to other subjects Sᵢ when contextualizing proposition 107 about shoes 109a. Furthermore, based on historical data in data files 112-S1 stored in memory 108, mapping module 115 has determined that the most likely value applied by subject S₁ in contextualization of proposition 107 about item 109, i.e., shoes 109a in the present example, concerns their “beauty”. Since the precipitation type of subject states |S₁ [symbol] is two-level the two possible measurable indications a, b map to a “YES” indication and a “NO” indication.

Given all available information about subject S₁, assignment module 116 estimates and expresses states |S₁ [symbol] in a decomposition in the u-basis which corresponds to value “beauty”. Of course, if available assignment module 116 uses the most recent measurement. State “UP” along u is taken as the eigenstate in which subject S₁ finds shoes 109a beautiful with the associated eigenvalue or measurable indication being “YES”. State “DOWN” along u is taken as the eigenstate in which subject S₁ finds shoes 109a not beautiful with the associated eigenvalue or measurable indication being “NO”. The measurable indications a, b in this case are two mutually exclusive responses “YES” and “NO”.

Meanwhile, subject S₂ with internal state 110b is assigned their discrete, two-level estimated state |S₂ [symbol] with an F-D marking. The latter serves to remind us that subject S₂ exhibits F-D anti-consensus statistic with respect to other subjects Sᵢ when contextualizing proposition 107. In this case, mapping module 115 has determined that the most common value applied by subject S₂ in contextualizing proposition 107 about shoes 109a (or any sufficiently similar contextualization, as noted above) concerns their “style”. Thus, in any measurement the a or “YES” indication indicates that subject S₂ judges shoes 109a to be stylish. The corresponding eigenstate is taken “UP” along v. The b or “NO” indication indicates that subject S₂ judges shoes 109a to not be stylish. The corresponding eigenstate is taken “DOWN” along v.

State |S₂ [symbol] estimated for subject S₂ by assignment module 116 is posited to also reside in the same Hilbert space as state |S₁ [symbol] of subject S₁, namely in community state space [symbol] ^{(C)}. Belonging to the same values space 200 can be confirmed in finding evidence from contemporaneous and historical data files 112-S1, 112-S2 of subjects S₁ and S₂ (see FIG. 2). Mentions or even discussion of items similar as well as specifically item 109a is an indication of contextualizing in shared values space 200.

Subject Sₘ with internal state 110m is also assigned their discrete, two-level estimated or measured state |Sₘ [symbol] by assignment module 116 with a B-E marking designating consensus statistic with respect to other subjects Sᵢ when contextualizing proposition 107. In the case of subject Sₘ, mapping module 115 determined that the most common value applied by subject Sₘ in contextualizing proposition 107 about shoes 109a (or any sufficiently similar contextualization, as noted above) concerns their “utility”. Thus, in any measurement the a or “YES” indication indicates that subject Sₘ judges shoes 109a to be useful. The corresponding eigenstate is taken “UP” along w. The b or “NO” indication indicates that subject Sₘ judges shoes 109a to not be useful. The corresponding eigenstate is taken “DOWN” along w. Thus decomposed in the w-eigenbasis state |Sₘ [symbol] of subject Sₘ is processed and finally placed in community state space [symbol] ^{(C)}.

Proceeding in this manner, assignment module 116 assigns community subject states |Sᵢ [symbol] that are posited in community state space [symbol] ^{(C)} to each one of subjects Sᵢ along with their B-E or F-D consensus statistics. This is done based on the best available and most recent information from data files 112 as well as communications gleaned from network 104. To ensure data freshness, assignment module 116 is preferably connected to network monitoring unit 120. The latter can provide most up-to-date information about subjects Sᵢ to allow assignment module 116 to assign the best possible estimates of states |Sᵢ [symbol] based on measurements of similar propositions or even to assign the measured states if recent measurement of the proposition at hand is available for the given subjects. This should always be done as part of pre-calibration at the start of a tracking run or else a prediction or simulation run. A person skilled in the art may consider the actions of assignment module 116 to represent assignment of estimates and may indicate this by an additional notational convenience. In some cases a “hat” or an “over-bar” are used. In order to avoid undue notational rigor we will not use such notation herein and simply caution the practitioner that the assigned state vectors as well as matrix operators we will derive below from the already introduced eigenbases are estimates.

A person skilled in the art will note that, depending on the embodiment, the distribution of functions between modules 115, 117 and 116 and even network monitoring unit 120 can be adjusted. Irrespective of the division of tasks, these modules need to share information to ensure that the most accurate possible quantum representation is achieved.

In general, measurable indications a, b transcend the set of just mutually exclusive responses that can be articulated in data files 112-S1 or otherwise transmitted by a medium carrying any communications generated by subject S₁. Such indications can include actions, choices between non-communicable internal responses, as well as any other choices that subject S₁ can make internally but is unable to communicate about externally. Because such “internal” choices are difficult to track, unless community subject S₁ is under direct observation by another human that understands them, they may not be of practical use in the present invention.

On the other hand, mutually exclusive responses that can be easily articulated by subject S₁ are suitable in the context of the present invention. The actual decomposition into the corresponding eigenvectors or eigenstates and eigenvalues that correspond to the measurable indications a, b, as well as the associated complex coefficients, probabilities and other aspects of the well-known quantum formalism will not be discussed herein. These aspects have been previously explained in great detail in U.S. patent application Ser. No. 14/324,127 to which the reader is referred for corresponding information.

It is important to realize that the assignment by assignment module 116 of states |S₁ [symbol] to first community subject S₁ will most often be an estimate. Of course, it is not an estimate in the case of confirmed and very recent measurement. Measurement occurs when subject S₁ has just yielded one of the measurable indications, which corresponds to an eigenvalue λᵢ that associates with an eigenvector in that eigenbasis. At that point, assignment module 116 simply sets state |S₁ [symbol] equal to that eigenvector. The estimate of states |S₁ [symbol] is valid for underlying proposition 107 about shoes 109a. The estimate reflects the contextualization by subject S₁ at a certain time and will generally change as the state of subject S₁ evolves with time. The same is true for the measured state since all states evolve (only eigenvalues observed during quantum measurements represent facts that are immutable records of which a history can be made).

Updates to the estimates and prior measurements of all quantum states are preferably derived from contextualizations that have been actually measured within a time period substantially shorter than or less than a decoherence time. Since no contextualizations are identical, even if only due to temporal evolution of the state, similar contextualizations should be used in estimating states whenever available. In other words, estimates based on propositions about items that are similar to proposition 107 about shoes 109a should be used. This strategy allows assignment module 116 to always have access to an up-to-date estimated or measured state vector.

Quantum states modulo certain propositions may exhibit very slow evolution on human time scales, e.g., on the order of months, years or even decades. States with very long decoherence times are advantageous because they do not require frequent updates after obtaining a good first estimate or preferably even a measurement. For states that evolve more quickly, frequent updates will be required to continuously maintain fresh states. Contextualizations modulo some propositions may evolve so rapidly on human time scales that keeping up-to-date estimates or measurements may be challenging. For example the change in state from “fight” to “flight” modulo an underlying proposition 107 about item 109 instantiated by a wild tiger (or item 109b instantiated by the book covering ordinary and partial differential equations) can evolve on the order of split seconds. Therefore, in considering any particular proposition data and estimated state freshness may be crucial for some tracking activities while barely at all for others. A review of estimates, measurements and their freshness by the human curator is thus recommended before commencing any tracking processes and even more so before attempting any prediction or simulation runs.

Preferably, network monitoring unit 120 curates what we will consider herein to be estimated quantum probabilities pₐ, p_{b} for the corresponding measurable indications a, b of all quantum states |Sᵢ [symbol] . Of course, a human expert curator or other agent informed about the human meaning of the information available in network 104 about subjects Sᵢ should be involved in setting the parameters on unit 120. The expert human curator should also verify the measurement in case the derivation of measurable indications actually generated is elusive or not clear from data files 112-Si. Such review by an expert human curator will ensure proper derivation of estimated quantum probabilities pₐ, p_{b}. Appropriate human experts may include psychiatrists, psychologists, counselors and social workers with relevant experience.

In some embodiments assignment module 116 may itself be connected to network 104 such that it has access to documented online presence and all data generated by test subjects Sᵢ in real time. Assignment module 116 can then monitor the state and online actions of subjects Sᵢ without having to rely on archived data from memory 108. Of course, when assignment module 116 resides in a typical local device such as computer 114, this may only be practicable for tracking a few very specific subjects or when tracking subjects that are members of a relatively small social group 106 or other small subgroups of subjects with known affiliations.

In the present example, contextualization of proposition 107 about shoes 109a by any one of subjects Sᵢ that exhibits the two-level, non-degenerate precipitation type is taken to exhibit two of the most typical opposite responses, namely “YES” and “NO”. In general, however, mutually exclusive measurable indications or responses can also be opposites such as “high” and “low”, “left” and “right”, “buy” and “sell”, “near” and “far”, and so on. Proposition 107 may evoke actions or feelings that cannot be manifested simultaneously, such as liking and disliking the same item at the same time, or performing and not performing some physical action, such as buying and not buying an item at the same time. Frequently, situations in which two or more mutually exclusive responses are considered to simultaneously exist lead to nonsensical or paradoxical conclusions. Thus, in a more general sense mutually exclusive responses in the sense of the invention are such that the postulation of their contemporaneous existence would lead to logical inconsistencies and/or disagreements with fact. This does not mean that any one of subjects Sᵢ may not internally experience such conflicts, but it does mean that they cannot act them out in practice (i.e., you can't buy and not buy shoes 109a at the exact same time).

Sometimes, after exposure to proposition 107 any one of subjects Sᵢ reacts in an unanticipated way and no legitimate response can be obtained in the contextualization of proposition 107. The quality of tracking will be affected by such “non-results”. Under these circumstances devoting resources to assigning and monitoring of subject state |Sᵢ [symbol] and monitoring of their expectation value becomes an unnecessary expenditure. Such non-response can be accounted for by classical null response probability pₙᵤₗₗ, and as also indicated in prior teachings (see U.S. patent application Ser. Nos. 14/182,281 and 14/224,041). In some cases, non-results or spurious responses can be due to being outside the range of validity for the quantum representation of the specific subject. This issue is renormalization-related and has been previously addressed in U.S. patent application Ser. No. 14/504,435. In a preferred embodiment, as mentioned above, mapping module 115 confirms the range of validity to eliminate form consideration subjects Sᵢ whose states that may exhibit renormalization-related issues.

In preferred embodiments of computer system 100 and methods of the present invention, it is preferable to remove non-responsive subjects Sᵢ after a certain amount of time corroborated by the human curator. The amount of time should be long in comparison with the decoherence time. Therefore, any subject observed to generate “non-results” for a comparatively long time is removed from community state space [symbol] ^{(C)} by action with a corresponding annihilation operator. This is tantamount to removing the subject from tracking. This action is also referred to as annihilation in the field of quantum field theory. It is here executed in analogy to its action in a field theory by the application of fermionic or bosonic annihilation operator ĉ or â in creation module 117. The type of annihilation operator depends on whether subject state exhibited B-E consensus or F-D anti-consensus statistic during its original creation.

FIG. 3D illustrates another important function performed by assignment module 116. This function is to convert into quantum representation subject values (not to be confused with numeric values—here we mean human values or judgment criteria). The values we mean here are those that subjects Sᵢ apply in their contextualizations, apprehensions, frames of mind, judgments and/or assessments. FIG. 3D continues with the same example, namely the one focused on subjects S₁, S₂ and Sₘ. Instead of reviewing the quantum states, however, assignment module 116 now trains on the eigenvectors that make up the u-, v- and w-eigenbases. These eigenbases are associated with contextualizations of the underlying proposition using the values of “beauty”, “style” and “utility”, respectively.

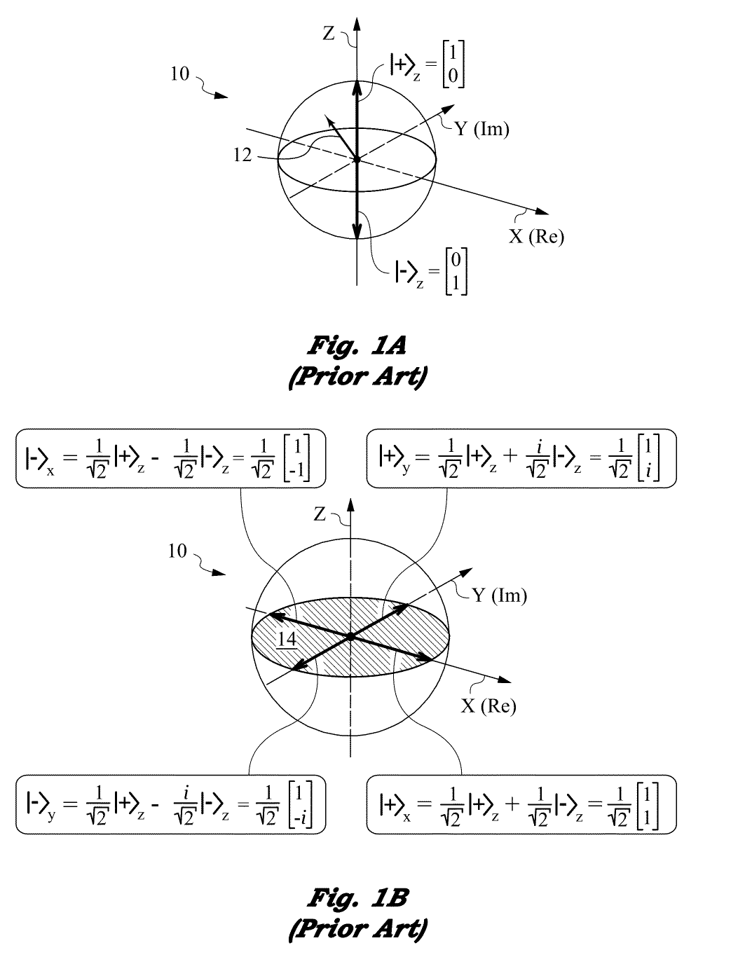

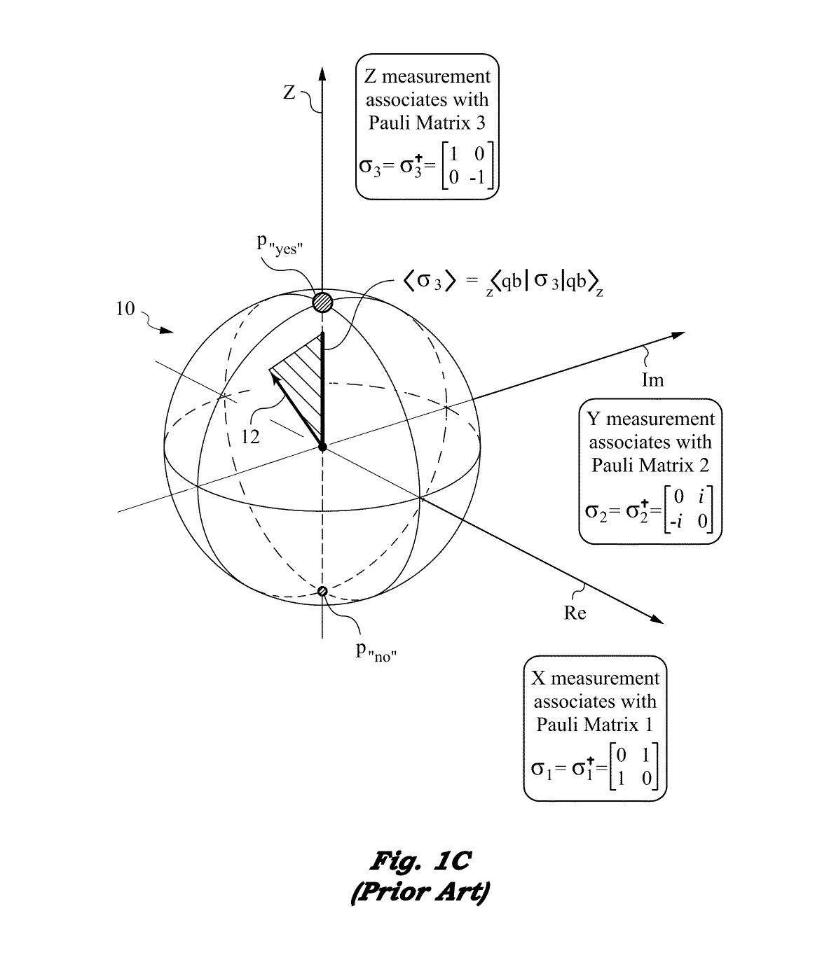

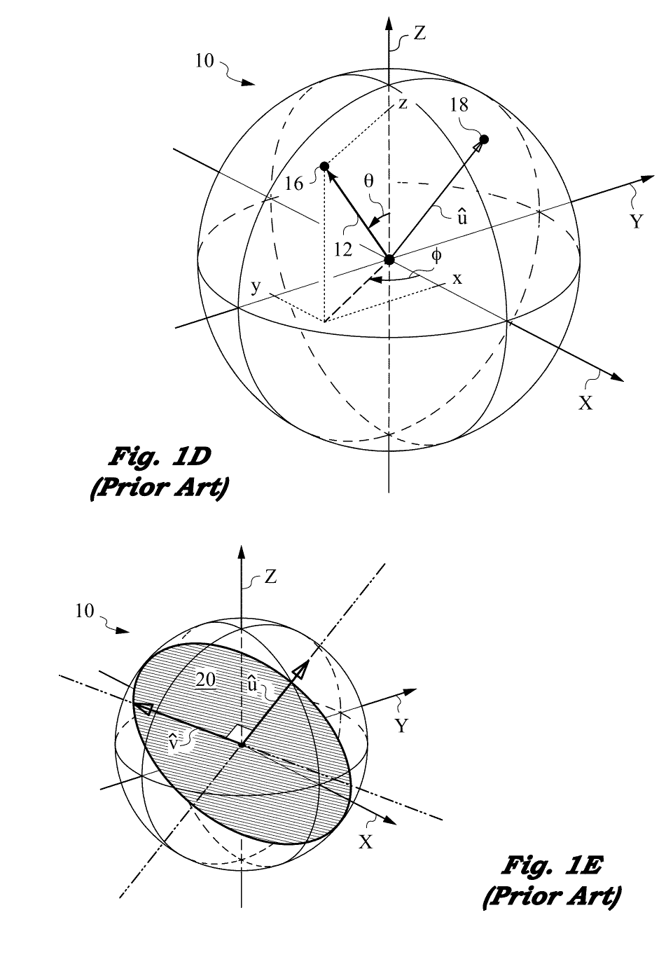

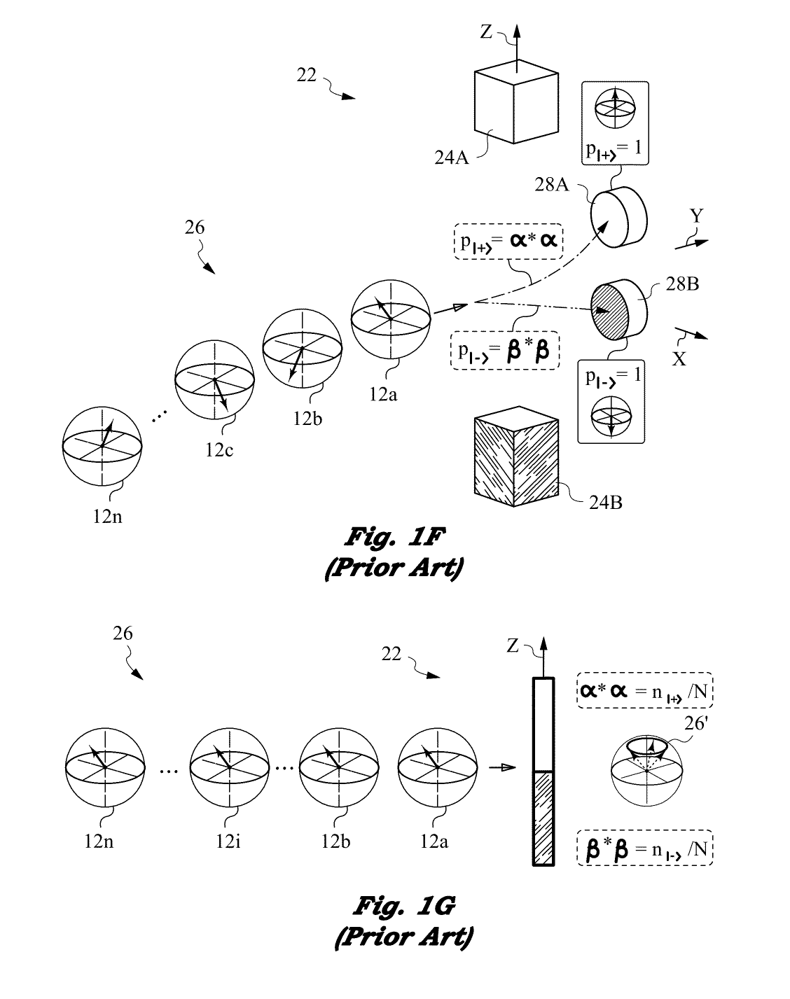

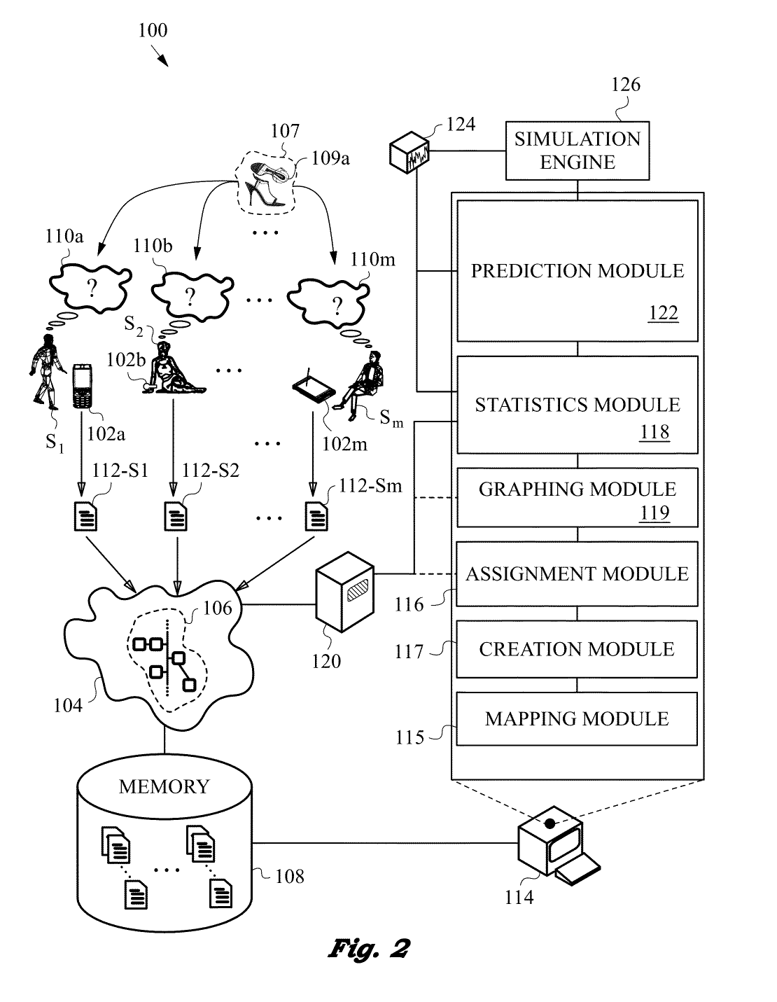

As we know from standard quantum mechanics, since states |Sᵢ [symbol] are two-level they can be spectrally decomposed in bases with two eigenvectors. The spectral decompositions of states |S₁ [symbol] , |S₂ [symbol] , |Sₘ [symbol] belonging to subjects S₁, S₂ and Sₘ as shown in FIG. 3C have already introduced the u-, v- and w-eigenbases. Each of these three eigenbases has two eigenvectors that are not explicitly drawn here (see, e.g., FIGS. 1A & 1B and corresponding description in the background section). In other words, the eigenvectors in this example come in pairs. There is one “UP” and one “DOWN” eigenvector in each of the three eigenbases. Equivalently put, we have eigenvectors that are parallel and anti-parallel with the u, v and w rays shown in FIGS. 3C & 3D.

By convention already introduced above, we take “UP” eigenvectors to mean that the subject is experiencing a state of positive judgment in that value (contextualization yields positive value judgment). Therefore, the “UP” eigenvector is associated with the first eigenvalue λ₁ that we take to stand for the “YES” measurable indication a. The “DOWN” eigenvectors mean the state of negative judgment in that value. Hence, the second eigenvalue λ₂ that goes with the “DOWN” eigenvector is taken to stand for “NO” measurable indication b.

In the quantum representation of contextualizations as implemented by assignment module 116 the eigenvector pairs describe the different values that subjects may deploy. Subjects Sᵢ can contextualize proposition 107 with any chosen value described by the eigenvector pairs but they can only choose one at a time. In fact, in many applications of the present apparatus and methods it is advantageous to obtain measurable indications a, b (or eigenvalues λ₁, λ₂) from many subjects Sᵢ in at least two different eigenvector bases or, equivalently, in two different contextualizations.

Based on the rules of linear algebra, subject states |Sᵢ [symbol] forming the quantum representation of subjects Sᵢ modulo underlying proposition 107 can be expressed in any contextualization or using any of the available values. This is ensured by the spectral decomposition theorem. We have already used this theorem above in FIG. 3C for subject state decompositions in terms of eigenvectors. To wit, we have expressed subject states |S₁ [symbol] of subject S₁ in the u-basis, subject state |S₂ [symbol] of subject S₂ in the v-basis, and subject state |Sₘ [symbol] of subject Sₘ in the w-basis.

In FIG. 3D we proceed further and introduce value matrices PRⱼ whose eigenvectors are the very eigenvectors we have already deployed. Conveniently, we thus express the different bases or eigenbases with corresponding value matrices PRⱼ that have these eigenvectors in their eigenbases. Value matrices PRⱼ represent quantum mechanical operators (Hermitian matrices). In the case of our two-level systems are related to the Pauli matrices already introduced in the Background section.

The quantum mechanical prescription for deriving the proper operator or “beauty” value matrix PRᵤ is based on knowledge of the unit vector û along ray u. The derivation has already been presented in the background section in Eq. 13. To accomplish this task, we decompose unit vector û into its x-, y- and z-components. We also deploy the three Pauli matrices σ₁, σ₂, σ₃. By standard procedure, we then derive value matrix PRᵤ as follows:

PRᵤ=û· σ̅=uₓσ₁+u_{y}σ₂+u_{z}σ₃. Eq. 18a

The same procedure yields the two remaining value matrices PRᵥ, PR_{w} that, in our quantum representation, stand for contextualizations using the values of “style” and “beauty”, respectively. Once the decompositions of unit vectors \hat{v}, ŵ along rays v, w are known, these are expressed as follows:

PRᵥ=\hat{v}· σ̅=vₓσ₁+v_{y}σ₂+v_{z}σ₃, Eq. 18b

and

PR_{w}=ŵ· σ̅=wₓσ₁+w_{y}σ₂+w_{z}σ₃. Eq. 18c

All three value matrices PRᵤ, PRᵥ, PR_{w} obtained from these equations are shown in FIG. 3D in association with their corresponding rays u, v and w.

Per standard rules of quantum mechanics, we take value matrices PRⱼ to act on or be applied to subject states |Sᵢ [symbol] to yield eigenvalues λₖ associated with measurable indications modulo underlying proposition 107 as exhibited by subjects Sᵢ. The eigenvalues, of course, stand for the “YES” and “NO” measurable indications. The practitioner is here reminded that prior to the application of the corresponding value matrix the subject state should be expressed in the eigenbasis of that value matrix. In the case of values represented with value matrices PRᵤ, PRᵥ, PR_{w} we are clearly not dealing with eigenvector bases that are completely orthogonal (see FIG. 1E and discussion of the Uncertainty Principle in the Background section). Thus, contextualizations with these values are not completely incompatible. However, they are far from compatible, since u-, v- and w-produce clearly different unit vectors.

In some embodiments it will be advantageous to select two or more different eigenvector bases (depending on dimensionality of state space [symbol] ^{(C)} represented by two or more value matrices PRⱼ that are non-commuting and thus subject to the Heisenberg Uncertainty relation. Measurements obtained over test subjects Sᵢ contextualizing with incompatible values as encoded by such non-commuting value matrices PRⱼ will be useful in further explorations and in constructing views for classical representations. The measurable indications obtained when contextualizing with such non-commuting value matrices PRⱼ cannot have simultaneous reality. In other words, they cannot be measured/observed in any one of subjects Sᵢ at the same time.

Armed with the quantum mechanical representation thus mapped, many computations and estimations can be undertaken. The reader is referred to the co-pending application Ser. Nos. 14/182,281; 14/224,041 and 14/324,127 for further teachings about the extension of the present quantum representation to simple measurements. Those teachings also encompass computation of outcome probabilities in various bases with respect to different propositions typically presented to just one or two subjects. The teachings partly rely on trying to minimize the effects from interactions between the environment and the state that stands in for the subject of interest. It is also assumed for the purposes of those teachings that the states are reasonably pure allowing us to build up our intuition without having to move to the density matrix representation of subject states.

In the present invention we will continue building on the intuition from simple situations of reasonably pure states. That is because teachings based on pure states are easily translated by those skilled in the art to the more complex situations in which, e.g., several pure states are possible for a single subject. Given that the density matrix is thus obtained from probabilities of two or more pure states, as already shown in the Background section, a person skilled in the art will be able to adapt these teachings to construct requisite density matrices. Thus, more complicated situations in which subject states are mixtures and entanglement between subjects exists can be properly accounted for based on the teachings of the present quantum representation.

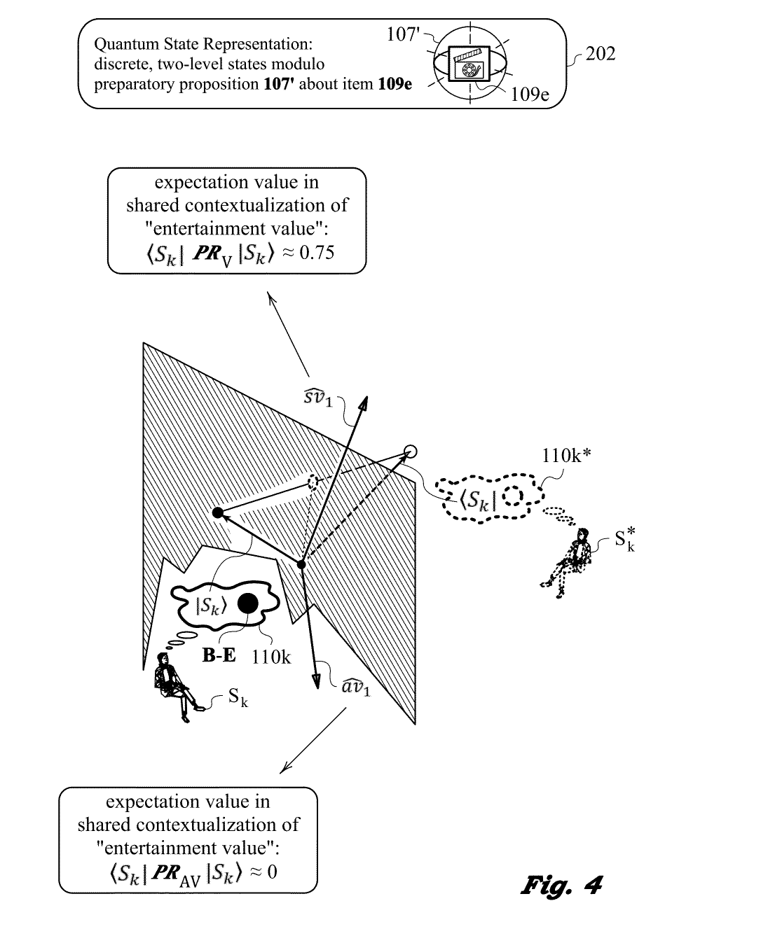

In order to better understand important aspects of the invention we now refer to FIG. 4 to review the computation of an expectation value for a measurement. Here we see a single subject Sₖ with a pure state |Sₖ [symbol] representing their internal state 110k at some initial time tₒ. A reasonably pure quantum state representation for subject Sₖ has been confirmed by mapping module 115 (see FIG. 2). The state fits the description of discrete and two-level modulo a preparatory proposition 107′ about item 109e. In this example item 109e happens to be an experience and more particularly still and experiential good embodied by a movie. Overall context 202 for the quantum representation valid in this example is included at the top of FIG. 4.

Creation module 117 (see FIG. 2) is informed by historical data (possibly further corroborated by a human curator) about the consensus type of subject Sₖ. In this exemplary case, the nature of subject Sₖ modulo preparatory proposition 107′ about movie 109e is B-E consensus type, or more simply put consensus seeking. Thus, creation module 117 has used a bosonic creation operator to posit states |Sₖ [symbol] , as duly marked in FIG. 4.

The most commonly adopted contextualization practiced by subject Sₖ in considering preparatory proposition 107′ about movie 109e is gleaned from “thick data” available on network 104 (potentially in social network 106 if subject Sₖ is a member). In the present example, this most commonly adopted contextualization is encapsulated by the concept of “entertainment value”. In other words, subject Sₖ typically apprehends proposition 107′ presenting movie 109e as an opportunity to be entertained.

Once again, it is the job of assignment module 116 (see FIG. 2), appraised of information about subject Sₖ to formally translate subject state 110k under the “entertainment value” contextualization into quantum representation. First, the value used in the contextualization is presented in the form of a subject value matrix PR_{V}. Since the system is two-level, subject value matrix PR_{V} has two eigenvectors |sv₁ [symbol] , |sv₂ [symbol] and two corresponding eigenvalues λ₁, λ₂. In the present example, eigenvector |sv₁ [symbol] is taken for “entertaining” with corresponding eigenvalue λ₁ standing for the measurable indication that subject Sₖ yields when entertained. In our example, this measurable indication will be also referred to by λ₁ to simplify the notation. Furthermore, it will be counted as a response of: λ₁=“YES” response for “entertainment value”. Second eigenvector |sv₂ [symbol] is taken for “not entertaining” with corresponding eigenvalue λ₂ standing for the measurable indication that subject Sₖ yields when not entertained. This negative measurable indication referred to by λ₂ is counted as a response of: λ₂=“NO” response for “entertainment value”. Finally, in keeping with the above convention, the complex coefficients for the spectral decomposition of subject state |Sₖ [symbol] in the basis offered by subject value matrix PR_{V} are represented by the familiar α, β. This means that assignment module 116 outputs the manifestly Hermitian subject value matrix PR_{V}:

$${PR}_{V} = \vert \begin{matrix}{V}_{x} & {V}_{x} + i {V}_{y} \\ {V}_{x} - i {V}_{y} & - {V}_{x}\end{matrix} \vert , \qquad Eq . 19$$

where capital V (rather than lower-case we were using before) now stands for the corresponding ray in Hilbert space. Also, assignment module 116 outputs subject state |Sₖ [symbol] decomposed in the eigenbasis of subject value matrix PR_{V}:

|Sₖ [symbol] _{V}=α_{V}|sv₁ [symbol] +β_{V}|sv₂ [symbol] _{V}, Eq. 20a

where we use the capital V subscripts to remind ourselves that the quantum representation is in the eigenbasis of subject value matrix PR_{V}.

Given this decomposition we will expect that a measurement using the contextualization expressed with subject value matrix PR_{V} will yield the following probabilities for “YES” and “NO” measurable indications or responses of subject Sₖ encoded in eigenvalues λ₁, λ₂:
p_{“YES”}=α_{V}*α_{V} (probability of observing subject Sₖ manifest eigenvalue λ₁);
p_{“NO”}=β_{V}*β_{V} (probability of observing subject Sₖ manifest eigenvalue λ₂).

At this point “thick” data about subject Sₖ is used by assignment module 116 to estimate the complex coefficients and the probabilities. Advantageously, the deployment of the invention in network 104 captures large amounts of “thick” and recent data to help in estimating these coefficients and probabilities. In some cases the estimate may be very good, e.g., when based on a recent measurement. For example, there may exist a recent record, e.g., in a data file 112 (see FIG. 2) of subject Sₖ effectively stating: “I find movie 109e to be of excellent entertainment value”. In this case the decomposition is simple and consists only of the first eigenvector |sv₁ [symbol] _{V} with p_{“YES”}=p_{|sv}_{₁} [symbol] =α_{V}=1 (p_{“no”}=p_{|sv}_{₂}=β_{V}=0). In the opposite case, where subject Sₖ effectively stated: “I find movie 109e to be of no entertainment value” we again obtain an excellent estimate. Namely, the decomposition consists only of the second eigenvector |sv₂ [symbol] _{V} with p_{“NO”}=β_{V}=1 (p_{“YES”}=α_{V}=0). The reason why even such measurements should be treated as estimates is due to temporal evolution and decoherence effects that set in with the passage of time. This is also the reason why fresh data is of utmost importance for propositions whose evaluation by a human mind changes quickly with time.

Assignment module 116 can also assign a mixed state for subject Sₖ in case he or she is known to exhibit a less common but still often deployed alternative contextualization. For example, in a simple case subject Sₖ may be known from historical records to deploy the alternative contextualization of “educational value” with respect to proposition 107′ about movie 109e. For the sake of the present example, the probability that subject Sₖ actually adopts this alternative contextualization is 10%. This is expressed with an alternative subject value matrix PR_{AV}.

Given this information, module 116 produces an estimate of subject states |Sₖ [symbol] decomposed in the eigenbasis of alternative subject value matrix PR_{AV}:

|Sₖ [symbol] _{AV}=α_{AV}|av₁ [symbol] _{AV}+β_{AV}|av₂ [symbol] _{AV}, Eq. 20b

with the subscript AV denoting that the quantum representation is in the eigenbasis of alternative subject value matrix PR_{AV}.

Given that subject Sₖ may have some probability of being in a pure state in the eigenbasis of PR_{AV}, the two pure states can be combined. The correct quantum mechanical prescription has already been provided in the Background section (see Eq. 15) and leads to the following density operator for our example:

\hat{ρ}=Σᵢpᵢ|ψᵢ [symbol] ψᵢ|=(0.9)|Sₖ [symbol] _{VV} [symbol] Sₖ|+(0.1)|Sₖ [symbol] _{AVAV} [symbol] Sₖ|. Eq. 21

The pᵢ's in this case represent the relative probabilities (summing to one in order to preserve the normalization condition discussed above) that subject Sₖ will apply contextualization “entertainment value” and “educational value”, respectively. In our example the probability of subject state |Sₖ [symbol] _{V} is 90% (0.9) since contextualization with alternative subject value matrix PR_{AV} and hence of |Sₖ [symbol] _{AV} has a likelihood of 10% (0.1). In any particular case, these probabilities are computed from the historical records about subject Sₖ and may be further corroborated/vetted by the human curator.

In a preferred embodiment, proposition 107′ is presented to subject Sₖ on the screen of their networked device (see FIG. 2 for a few non-limiting examples of networked devices). Alternatively, it is presented to them in any convenient way capable of displaying enough information about movie 109e to register as viable proposition. Indeed, the presentation can even be in person—i.e., presentation of proposition 107′ about movie 109e is made during a real life encounter with another subject or by some proxy, mechanism or message including written and/or drawn information (e.g., an advertisement).

FIG. 4 illustrates subject states |Sₖ [symbol] and its dual bra vector state [symbol] Sₖ|. This drawing indicates by unit vector [symbol] the “entertaining” eigenvector in the most commonly adopted contextualization of “entertainment value” expressed by subject value matrix PR_{V}. The drawing further shows by unit vector [symbol] the “educational” eigenvector in the alternative contextualization of “educational value”. Per our quantum representation we postulate that at the time subject Sₖ's states |Sₖ [symbol] is measured and collapses to either of these two eigenvectors the corresponding eigenvalue manifests. Specifically, collapse of |Sₖ [symbol] to |sv₁ [symbol] will coincide with subject Sₖ manifesting λ₁=“YES” meaning “yes movie 109e is entertaining”. The collapse of |Sₖ [symbol] to |av₁ [symbol] will coincide with subject Sₖ manifesting λ₁=“YES” meaning “yes movie 109e is educational”. Also in agreement with the quantum representation, the probability of collapse will start at zero at initial time tₒ and will keep increasing for as long as preparatory proposition 107′ is being apprehended by subject Sₖ.

Eigenvectors [symbol] ₂, [symbol] ₂ representing the state |Sₖ [symbol] of subject Sₖ at the moment of measuring eigenvalues λ₂=“NO” for “no movie 109e is not entertaining” and λ₂=“NO” for “no movie 109e is not educational” are omitted for reasons of clarity. Also note that in the case of the mixture discussed above, subject Sₖ is only expected to have its state |Sₖ [symbol] be one of eigenvectors [symbol] ₁ and [symbol] ₁. Differently put, subject Sₖ is expected to be in one of the “YES”-eigenstates, but we do not know (based on a classical probability for relative probabilities in the mixture) which one. In other words, we have 90/10 chances for subject Sₖ adopting the “entertainment value” or “educational value” contextualization modulo preparatory proposition 107′ about movie 109e. In either case, subject Sₖ is expected to yield the measurable indication “YES”.

Since we can already tell in our own capacity as curators of human experience that it is hard to judge the same movie 109e in contextualizations based on “entertainment value” and based on “educational value” simultaneously, we expect that matrices PR_{V} and PR_{AV} will not commute. As a result, the fact that eigenvectors [symbol] ₁ and [symbol] ₁ are not aligned is not surprising. In practice, the relative orientation of these eigenvectors should be confirmed not just by the human curator but also by reviewing large numbers of measurements and deploying the rules of commutator algebra well known to those skilled in the art.

The expectation value of subject's Sₖ judgment of movie 109e in the “entertainment value” basis (measured by applying subject value matrix PR_{V}) is obtained by taking the regular prescription (see Eq. 10a). That prescription involves ket subject state |S [symbol] , its complex conjugated dual bra [symbol] S| and subject value matrix PR_{V}. Similarly, we can also obtain the expectation value of subject's Sₖ judgment of movie 109e in the “educational value” basis (measured by applying alternative subject value matrix PR_{AV}). The same prescription holds and calls for subject states |Sₖ [symbol] , its bra [symbol] Sₖ| and now alternative subject value matrix PR_{AV} instead of subject value matrix PR_{V}.

Just from a cautious geometrical intuition built from examining FIG. 4, we see that these expectation values will be very different. We state this fact more formally by using the expectation value formula explicitly as follows:

[symbol]

S|PR_{V}|S)≠ [symbol] S|PR_{AV}|S [symbol] , or

[symbol]

PR_{V} [symbol] _{|S} [symbol] ≠ [symbol] PR_{AV} [symbol] _{|S} [symbol] . Eq. 22

In practice, the range of expectation value (given our +1 and −1 eigenvalues) will be between +1 and −1. From a simple visual inspection of the geometry (the reader is yet again cautioned that FIG. 4 is a Bloch-related representation) we see the projection for [symbol] PR_{V} [symbol] _{|S} [symbol] to be close to about 0.75, while [symbol] PR_{AV} [symbol] _{|S} [symbol] appears to be close to 0.

In FIG. 4 subject Sₖ is indicated with internal state 110k and their internal complex-conjugated state 110k*. Both the state and its complex-conjugate are about movie 109e at center of preparatory proposition 107′. As we have previously seen in U.S. application Ser. No. 14/324,127, the evolution along some orbit can always take internal state 110k to internal complex-conjugated state 110k*. In a sense, these two states are “reflections” of each other. We thus posit subject Sₖ and a “mirror image” subject Sₖ namely subject S_{k*}. Subject Sₖ* can be thought of as the same subject Sₖ after some amount of evolution. Subject Sₖ* can also be thought of as a completely different subject that currently contextualizes movie 109e but whose ket state (the non complex-conjugated state) is represented by internal state 110k*. In other words, the |notional [symbol] state or ket state of subject Sₖ* is in fact the bra state or the [symbol] counter-notional| state of subject Sₖ.

This “flipping” between bras and kets can be understood as a change in mind about movie 109e from the point of view of a “party” represented by subject Sₖ to the point of view of a “counter-party” represented by subject Sₖ*. In the vernacular, such opposite thinking about the same underlying proposition may express itself as: 1) “yes the movie is entertaining to me” and 2) “yes the movie is entertaining to others”. Differently put, this pair of complex-conjugate internal states can be associated with a “party” and a “counter-party” mentality. They both certainly “see eye to eye”. They also agree on judging movie 109e in the same contextualization of “entertainment value” but still are distinct in the sense that one would act like a “viewer” or “consumer” of movie 109e and the other like a “promoter” or “producer” of movie 109e.

We are presently interested in situations that start out with two subjects that individually and independently of each other perceive a given proposition. Separately and individually they each adopt their own contextualization of that proposition. Their contextualizations are known. Further, the subject states of the two separate subjects in their known contextualizations can be well estimated because their initial measurable indications are also known. Preferably, these known measurable indications modulo the proposition were recently collected from each subject independently. Note that although the measurable indications are known, they are not necessarily the same. Being fresh, however, they allow one to set the estimates of the subject states to be the eigenvectors of the corresponding subject value matrix that is the quantum mechanical representation of the correspondent contextualization of the proposition. The known measurable indications, of course, belong to the set of all possible measurable indications that are the eigenvalues of the subject value matrix. In addition, the F-D anti-consensus and B-E consensus statistics of the subjects modulo the proposition are also known.

Given these preconditions, we are interested in taking another step with the two individual subjects. We wish to examine a mutual interdependence that may be established between them upon their joint confrontation with the proposition. In other words, we wish to consider them together to determine a state of entanglement that forms after they jointly, rather than independently, contextualize the proposition. Within the computer system of the invention, this occurs when the two subjects in the pair are brought together and are jointly confronted with or exposed to the proposition. The step of joint exposure is performed in a manner that makes both subjects aware that they are facing the proposition together. Differently put, they are aware that the consequences of contextualiztions they decide to adopt with respect to the proposition will affect them both.

In some embodiments the formation of the entangled or mutually interdependent state between the subjects can be further promoted by the choice of item that the proposition is about. As noted above, the item at the core of the proposition is usually selected from among subjects, objects and experiences, as well as any combination of one or more of these. A range of exemplary items 109 about which propositions can be formed are contained in inventory store 130 of FIG. 3A. To promote the formation of the joint state that is entangled we are interested in using items 109 that may be scarce, limited, unique, constrained, desirable or that have features and/or attributes or qualities that make them appear as being in short supply or otherwise limited to the subjects.

The following teachings build on some basic concepts behind joint states as already introduced in U.S. patent application Ser. No. 14/224,041 and the more detailed follow-up discussion in U.S. patent application Ser. No. 14/324,127. The concepts behind spin statistics leading to B-E consensus and F-D anti-consensus type behaviors of subjects when forced into joint states were originally presented in those incorporated references. Follow-up exploration of the consequences of F-D anti-consensus statistics in the context of joint states is found in Ser. No. 14/601,227. The diligent reader should refer to these for background information.

In the following drawing figures we will illustrate a specific case of entanglement modulo a specific proposition about a specific item. The example builds on the previous embodiments and hence uses the same reference numerals for analogous parts whenever practicable. The computer system that implements the invention is analogous to computer system 100 (see FIG. 2). The additional important aspect that ensure system 100 properly implements aspects related to entangled states are called out expressly in the drawing figures that follow. The example application used to explain the invention is concrete in order to provide a more thorough and clear teaching of the invention. It is not to be construed as a limitation on the myriads of situations where entanglement comes into play.

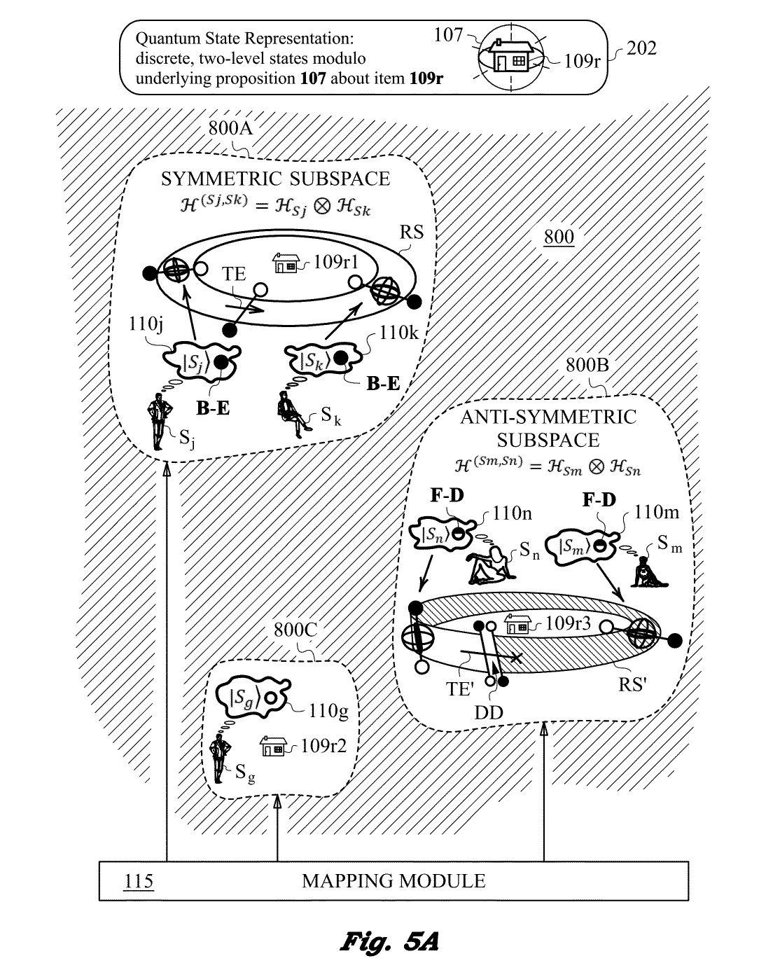

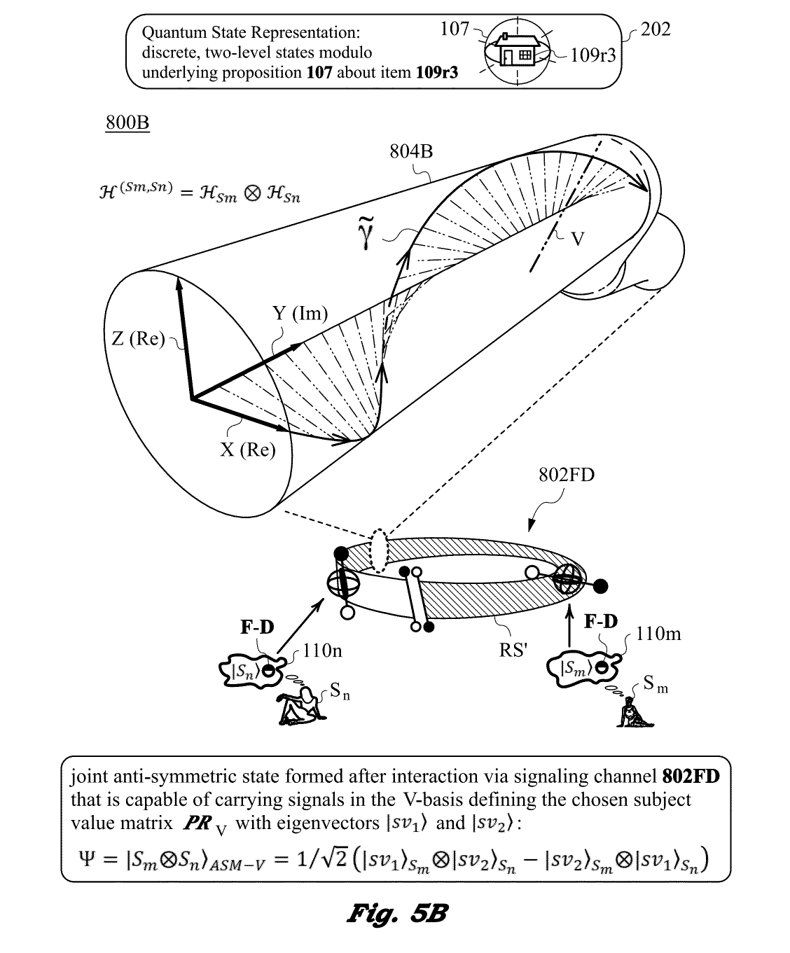

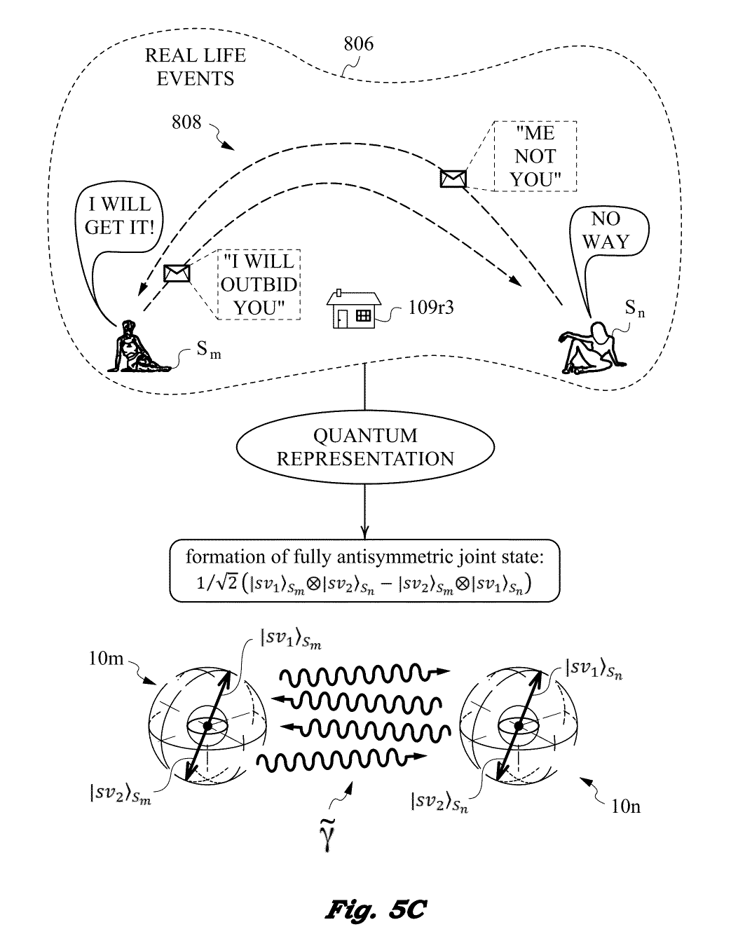

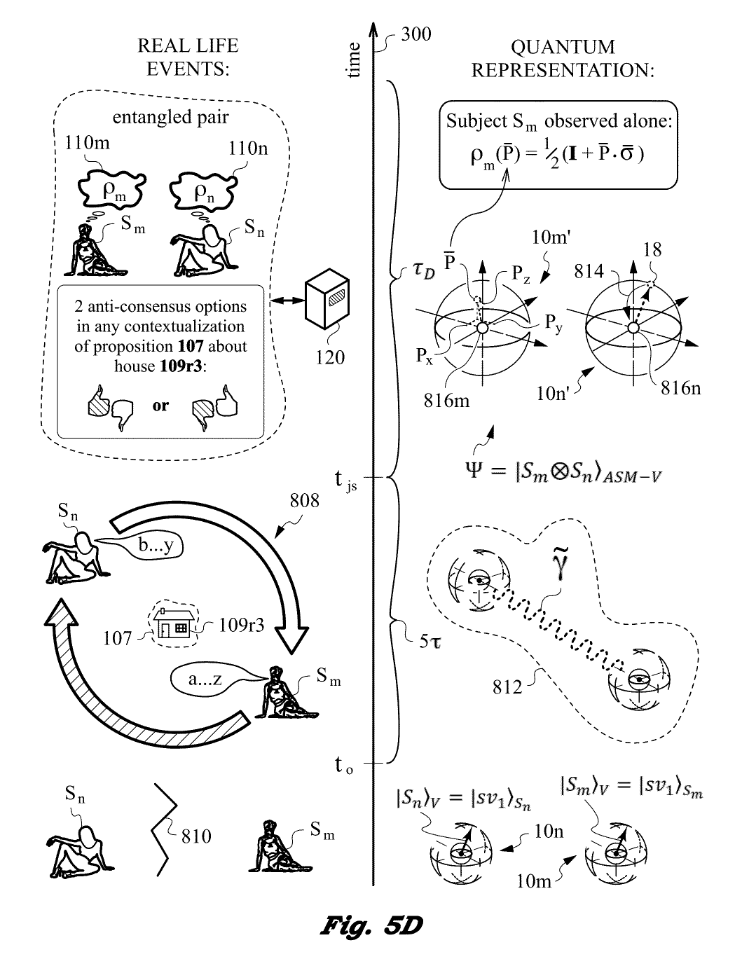

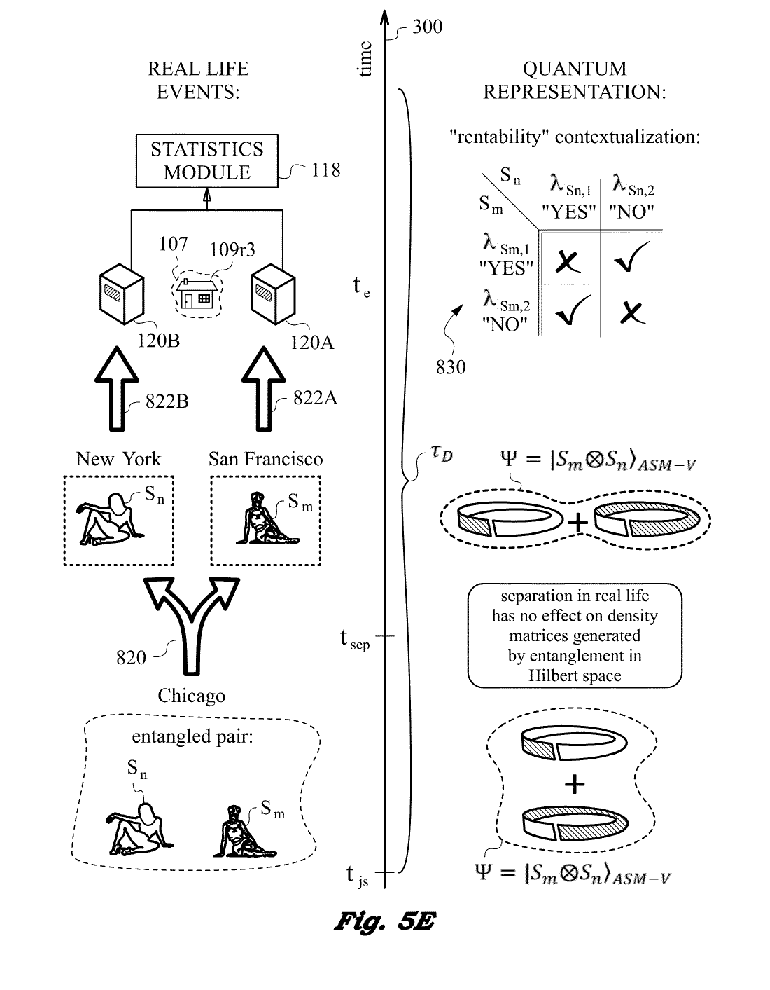

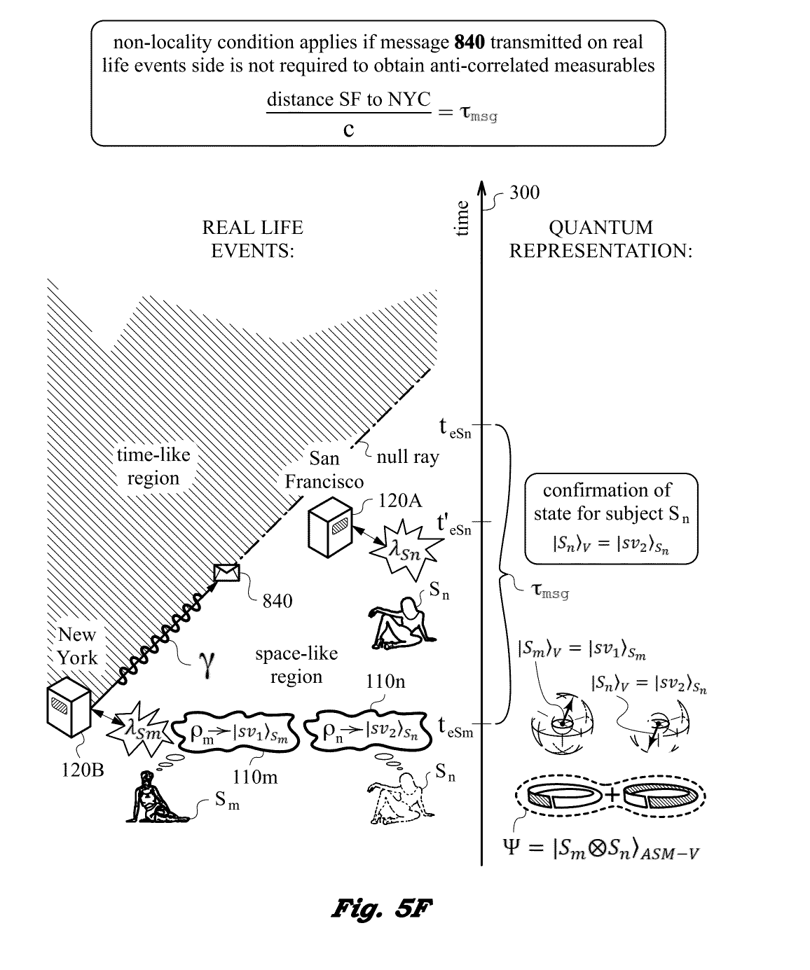

FIG. 5A shows three different and separate situations. The first involves a first pair of subjects Sⱼ, Sₖ. The second a second pair of subjects Sₘ, Sₙ, and the third situation is about a single subject S_{g}. All subjects under consideration are selected by mapping module 115 from among all available subjects Sᵢ in computer system 100 (see FIG. 2). Further, context 202 over subjects Sⱼ, Sₖ, Sₘ, Sₙ and S_{g} is generated by presentation of proposition 107 about item 109r that is an object (rather than a subject or experience) embodied by a house (see also FIG. 3A). Information about individual contextualizations, measurable indications and consensus types of subjects Sⱼ, Sₖ, Sₘ, Sₙ and S_{g} are known to system 100. This information is discovered in accordance with the above teachings.

Subjects Sⱼ, Sₖ, Sₘ, Sₙ and S_{g} are shown embedded in a context space 800. Context space 800 is a higher-dimensional space in which internal states 110j, 110k, 110n, 110m and 110g of corresponding subjects Sⱼ, Sₖ, Sₘ, Sₙ and S_{g} are embedded. Context space 800 may be considered a values space or even a community values space (see U.S. patent application Ser. No. 14/324,127) for certain sub-groups of subjects Sᵢ including subjects Sⱼ, Sₖ, Sₘ, Sₙ and S_{g} selected by mapping module 115. Context space 800 may simply be Hilbert space. However, no such restriction need ultimately apply to the embedding. Instead, what is important in the present embodiment is that context space 800 support certain inner states to be joined in the form of joint subject states, while allowing other states to be separate. Differently put, context space 800 has the ability to act as a type of “insulator” between inner states 110 that do not enter into joint subject states while maintaining others as joint subject states.

In this example the first pair of subjects, namely subjects Sⱼ, Sₖ are identified as B-E consensus type. Their internal states 110j, 110k are assigned to individual subject states |Sₖ [symbol] , |Sₖ [symbol] prior to the formation of their joint subject state. The second pair of subjects Sₘ, Sₙ have subject states |Sⱼ [symbol] , |Sₖ [symbol] that are contained in subspace 800A of context space 800. This second pair of subjects Sₘ, Sₙ are both F-D anti-consensus type and their internal states 110m, 110n are assigned to subject states |Sₘ [symbol] , |Sₙ [symbol] prior to the formation of the joint subject state. Subject states |Sₘ [symbol] , |Sₙ [symbol] inhabit subspace 800B that is insulated from subspace 800A of context space 800.

Subject S_{g} does not interact with any other subjects (not with subjects Sⱼ, Sₖ, Sₘ, Sₙ nor with any other subject(s) found among available subjects Sᵢ). Hence, subject state |S_{g} [symbol] is shown fully insulated from the others within his or her own subspace 800C of context space 800. Since subject state |S_{g} [symbol] remains insulated in its subspace 800C it can be treated individually or separately. More strictly speaking, subject states |S_{g} [symbol] is separable from others. Such state does not require us to account for its consensus statistic and may be described in simple terms as previously discussed in U.S. patent application Ser. No. 14/182,281.

The present invention is not concerned with single and insulated subject states that can be considered independent of each other. Such states, also commonly referred to as separable states, do not enter into any joint subject states and hence do not entangle. Of course, it is crucial to remember that in the case of subject S_{g} this applies in contextualization of proposition 107 about house 109r. Subject S_{g} may easily entangle with other subjects modulo other propositions about certain items.

We turn our attention to pairs of subjects Sⱼ, Sₖ and Sₘ, Sₙ. Although they exhibit different consensus statistics, they certainly can entangle. In other words, they can form joint quantum states that are not separable. We have previously discussed the anti-symmetric and symmetric joint states that can be formed by such pairs in U.S. patent application Ser. No. 14/601,227. Here, we will extend our discussion and deepen our understanding of such joint states. The quantum representation is kept simple because both pairs of subjects Sⱼ, Sₖ and Sₘ, Sₙ selected by mapping module 115 when under measurement precipitate as discrete, two-level states modulo proposition 107 about house 109r. The consensus is preferably tracked by creation module 117 (see FIG. 2) that is charged of formally producing the quantum representation and applying the corresponding creation (and annihilation) operators that posit the states.

We first turn to the B-E consensus type pair of subjects Sⱼ, Sₖ. As before, Riemann surface RS serves as a visualization aid to illustrate the importance of the B-E consensus statistic on the example of subject pair Sⱼ, Sₖ. Specifically, the way in which subjects Sⱼ, Sₖ apprehend proposition 107 in their internal spaces 110j, 110k is encoded per our quantum representation in subject states |Sⱼ [symbol] , |Sₖ [symbol] as assigned in assignment module 116 along with their consensus types used during formal state creation by creation module 117 (see FIG. 2). In contrast to a number of previously considered cases, subjects Sⱼ, Sₖ are aware of each other confronting the same proposition 107 and thus their consensus type becomes crucial. Because of their B-E consensus statistics their joint state will be symmetric.

The interdependency modulo proposition 107 about specific house 109r1 is ensured by the very nature of proposition 107. Namely, we choose here specific house 109r1 at the core of proposition 107 that is for rent. This is a situation where the resource constraint of proposition 107 imposed by the availability to subjects Sⱼ, Sₖ of just a single house 109r1 enforces interdependency. Preferably, the human curator is involved in ascertaining that subjects of pair Sⱼ, Sₖ are truly interested in proposition 107 to rent house 109r1. In other words, house 109r1 registers as a limited resource in internal spaces 110j, 110k of subjects Sⱼ, Sₖ and both are seriously interested in renting it.

Evidence for B-E consensus statistic modulo proposition 107 exists for any two subjects if, for example, according to data files 112-Sj, 112-Sk, communications in network 104, social network 106 and corroboration from human curator, subjects Sⱼ, Sₖ exhibit conscious agreement or consensus when considering specific house 109r1 in the same contextualization. For example, they both judge specific house 109r1 in the known contextualization of “rentability”. Moreover, each one of them is fine with the other one judging house 109r1 to be a “YES” or a “NO” in that known contextualization (the a being the “YES” indication and the b being the “NO” indication). Such lack of strife with respect to each other over house 109r1 is characteristic of B-E consensus type subjects.

In practice, it may be difficult to discern that subjects Sⱼ, Sₖ are inclined to produce such cooperative or symmetric state modulo proposition 107 about the exact same house 109r1 from data files 112 and communications found in traffic in network 104 and within social network 106. This is why creation module 117 has to review data files 112 as well as communications of subjects Sⱼ, Sₖ containing indications exhibited in situations where both were present and modulo propositions as close as possible to proposition 107 about specific house 109r1. The prevalence of “big data” as well as “thick data” that subjects produce in self-reports is very useful in this task. Furthermore, the human curator that understands the lives of both subjects Sⱼ, Sₖ should review and approve the proposed B-E consensus statistic for each subject modulo rental proposition 107 about specific house 109r1. The involvement of the curator is especially important when dealing with general “big data” (i.e., typical associative data put together by crawlers operating without any general instructions). Repositories of such “big data” have become a virtual garbage dump. The relationships between such data and subjects are either tenuous or even non-existent. For example, the reader is reminded here of a typical set of images for a person found on a large search engine. The hundreds of images displayed in association with that person frequently do not even include the image of the person in question but do include images that likely have little or nothing to do with that person and their common contextualizations of propositions either alone or jointly with others. Swaths of such low-quality “big data” are potentially meaningless, useless or worse without the oversight of the human curator.

A person skilled in the art will note that any proposition 107 that generates constraints such as limited availability, perceived status, perceived desirability, exclusivity, necessity for survival, necessity for fulfillment and/or any other mechanisms is likely to require joint subject states. More specifically, when limited resource or other limiting constraints generate conditions under which bidding, competition, strife and/or other similar group dynamics among subjects can manifest they produce a situation in which the quantum representation of subjects is likely to require a joint state. The joint state of B-E consensus type subjects will reflect their ability to share the limited resource here being the item embodied by specific house 109r1 at the core of proposition 107. In other words, joint states among B-E consensus subject admit of joint state solutions in which the pair of subjects Sⱼ, Sₖ finds a way to share the scarce resource at the center of proposition 107.

In our exemplary case subjects Sⱼ, Sₖ are genuinely interested in proposition 107 to rent specific house 109r1. Moreover, they are confirmed to exhibit the B-E consensus dynamic modulo proposition 107 about renting specific house 109r1. The B-E consensus statistic is explicitly indicated for selected subjects Sⱼ, Sₖ along with their states |Sⱼ [symbol] , |Sₖ [symbol] .

To consider subject states |Sⱼ [symbol] , |Sₖ [symbol] jointly we need to introduce a tensor space [symbol] ^{(Sj,Sk)}= [symbol] _{Sj} [symbol] [symbol] _{Sk} that can hold any joint state that this pair of consensus type subjects Sⱼ, Sₖ may yield. In other words, any tensor state |Sⱼ [symbol] [symbol] |Sₖ [symbol] that is among subjects Sⱼ, Sₖ modulo proposition 107 has to be in tensor space [symbol] ^{(Sj,Sk)}.

Knowledge of consensus statistics B-E among pair of subjects Sⱼ, Sₖ modulo proposition 107 tells us something upfront. Namely, whatever joint state obtains it must be symmetric according to the physical principles behind the quantum representation adopted herein. Thus, components of any legitimate joint state Φ=|Sⱼ [symbol] [symbol] |Sₖ [symbol] for B-E consensus subject pair Sⱼ, Sₖ will interchange with a “+” sign. Differently put, the symmetric joint state we are looking for has to be in the symmetric subspace of [symbol] ^{(Sj,Sk)}. That is because permissible joint states given B-E consensus statistics can also be thought of as confined to unitary evolution on Riemann surface RS. Surface RS is “flat” meaning that it has no twists or obstructions that would produce a flip or sign change in a state confined to unitary evolution along surface RS. All quantum states evolving along RS will do so without flipping. For better visualization, the lack of impediment in evolution along this orbit due to the absence of flipping is indicated by arrow TE in FIG. 5A.

For still better visualization, the lack of any flip is indicated by the black and white dots that “travel” with the quantum mechanical state representations visualized by “balls” as they evolve in a unitary manner along Riemann surface RS. There is clearly no impediment to the co-existence of subject states |Sⱼ [symbol] , |Sₖ [symbol] in the symmetric subspace [symbol] ^{(Sj,Sk)} of Hilbert space if they were to “roll over each other” and occupy the same quantum state somewhere along surface RS vis-à-vis proposition 107 about specific house 109r1. Notably, in such symmetric joint state two subjects Sⱼ, Sₖ in the pair could even attempt to rent same house 109r1 together.

The general expression for a symmetric joint state contains the “+” sign between tensor products of component states for subjects Sⱼ, Sₖ. The states or vector components associating to these individual subjects Sⱼ, Sₖ are tracked by corresponding subscripts. As already hinted at above, person skilled in the art will be aware that we are treating subjects as “indistinguishable” particles at this point in our quantum representation. The tensor space is based on the V-basis decomposition for each subject per “rentability” contextualization. Just to repeat, this is because of the known use of subject value matrix PR_{V} by both subjects Sⱼ, Sₖ in contextualizing proposition 107 about specific house 109r1 in terms of “rentability”. The known contextualization in the case of each one of subjects Sⱼ, Sₖ has two eigenvalues corresponding to measurable indications “YES” and “NO”.

The joint state inhabits tensor space [symbol] ^{(Sj,Sk)} or rather its symmetric subspace, as indicated in FIG. 5A. We use subscript SYM-V to remind ourselves of the fact that the space is a symmetric tensor space. In other words, the symmetric joint state between subjects Sⱼ, Sₖ takes on the general form expressed by Φ=|Sⱼ [symbol] |Sₖ=|Sⱼ [symbol] Sₖ [symbol] _{SYM-V}. The SYM-V subscript can also be used on the complex coefficients alpha and beta to remind us that they are used in this decomposition of a symmetric joint quantum state.

The measurable indications collected in collapsing or measuring the symmetric joint state will come in pairs. All possibilities will be covered with measurable indication pairs including: “YES”, “YES”; “YES”, “NO”; “NO”, “YES” and “NO”, “NO” for subjects Sⱼ, Sₖ, respectively. Recall, however, that due to the indistinguishable nature of subject states in the quantum representation adopted herein, it is not possible to label which state corresponds to which subject prior to measurement. Also, prior to entering the joint state the individual measurable indications for each subject are known. In other words, we know or can at the very least estimate from history and/or any other available data as discussed above, the measurable indications of subjects Sⱼ, Sₖ while still individuated. Since data modulo specific house 109r1 is likely unavailable (unless both subjects Sⱼ, Sₖ, while not yet knowing that they are both potential bidders for renting specific house 109r expressed their measurable indications online or in real life and system 100 managed to collect these indications). In most cases data including opinions and even, if available, measured indications generated by subjects Sⱼ, Sₖ about comparable houses and propositions can be used.

We now review the quantum representation of the symmetric joint state |Sⱼ [symbol] Sₖ [symbol] _{SYM-V} that pair of subjects Sⱼ, Sₖ contextualizing in terms of “rentability” can assume. This symmetric joint state is spectrally decomposed in eigenvectors |sv₁ [symbol] and |sv₂ [symbol] of subject value matrix PR_{V} for each subject. The superposition is expressed as:

Φ=|Sⱼ [symbol] Sₖ [symbol] _{SYM-V}=1/\sqrt{2}(|sv₁ [symbol] _{S}_{ⱼ} [symbol] |sv₂ [symbol] _{S}_{ₖ}+|sv₂ [symbol] _{S}_{ⱼ} [symbol] |sv₁ [symbol] _{S}_{ₖ}). Eq. 23

For reasons of simplicity and clarity of explanation this expression presumes that subjects Sⱼ, Sₖ are confronted jointly by proposition 107 about renting specific house 109r1. It further presumes that subjects Sⱼ, Sₖ are not affected in their joint state by anything other than each other and proposition 107. In practical situations such entanglement may not be complete and other environmental effects may need to be taken into account. However, in the present example it is presumed that pair of subjects Sⱼ, Sₖ are well-confined within subspace 800A and thus are not subject to interactions with any other subjects regarding proposition 107 about specific house 109r1.

Although we could now proceed to the next step on our journey to understanding entanglement with B-E consensus subjects Sⱼ, Sₖ, in subspace 800A, we will instead focus our attention on the case of F-D anti-consensus subject Sₘ, Sₙ in subspace 800B. These subjects are also jointly exposed to proposition 107 but the proposition is about a different specific house 109r3. This condition ensures that the subject pairs are in fact insulated from each other. The reason for continuing the explanation based on F-D anti-consensus subjects Sₘ, Sₙ is due to the more complicated nature of their joint subject state. Specifically, the joint subject state of F-D anti-consensus subjects Sₘ, Sₙ will exhibit the Pauli Exclusion Principle. This principle does not apply to B-E consensus subjects Sⱼ, S_{k.}

Second pair of subjects Sₘ, Sₙ in subspace 800B are covered by context 202 generated by proposition 107 about house 109r3. Their quantum representation is discrete and two-level modulo proposition 107 about house 109r3. In deploying Riemann surface RS′ as a visualization aid we see the importance of the F-D anti-consensus statistic on the example of subjects Sₘ, Sₙ making up the second pair. Specifically, the way in which subjects Sₘ, Sₙ apprehend proposition 107 in their internal spaces 110m, 110n is encoded per our quantum representation in subject states |Sₘ [symbol] , |Sₙ [symbol] as assigned in assignment module 116 along with their consensus types used during formal state creation by creation module 117 (see FIG. 2).

In terms of the quantum representation subject states |Sₘ [symbol] , |Sₙ [symbol] inhabit tensor space [symbol] ^{(Sm,Sn)}= [symbol] _{Sm} [symbol] [symbol] _{Sn} that cannot support a joint state in which both are evolving without impediment on the same Riemann surface RS′. That is because a quantum state cannot exhibit unitary evolution on Riemann surface RS′ that evolves without producing a disruption due to the flip or sign change necessitated by the half-integral twist. This impediment is indicated by arrow TE′. The fact that there is an obstacle is also visually indicated by discontinuity DD in Riemann surface RS′ for states |Sₘ [symbol] , |Sₙ [symbol] .

The strictly pedagogical visualization is reinforced by the black and white dots that “travel” with the quantum mechanical state representations visualized by the “balls”. The dots indicate that the half-integral twist in Riemann surface RS′ prevents the two states from being identical after completing one cycle or loop in travelling along RS′. States |Sₘ [symbol] , |Sₙ [symbol] cannot “roll over each other” when confined to travel along surface RS′ after just a single cycle. They thus cannot occupy the same quantum state somewhere along surface RS′ vis-à-vis proposition 107 about house 109r3 without impediment. In fact, they turn into their opposites after one cycle! This is a fundamental structural impediment to the co-existence of subject states |Sₘ [symbol] , |Sₙ [symbol] in Hilbert space [symbol] ^{(Sm,Sn)} while occupying the same quantum state vis-à-vis proposition 107 about house 109r3. Their joint state cannot be symmetric under this condition. The consequence, also called the Pauli Exclusion Principle, is that subjects Sₘ, Sₙ exhibiting F-D anti-consensus statistic must occupy different states. A joint state composed of such F-D anti-consensus subjects has to be anti-symmetric. This is in analogy to fermions whose joint states are anti-symmetric.

We return to our exemplary case where subjects Sₘ, Sₙ are genuinely interested in proposition 107 about house 109r3. Their known contextualization of proposition 107 about house 109r3 concerns “rentability”. Moreover, they are confirmed to exhibit the F-D anti-consensus dynamic modulo proposition 107 about renting house 109r3. The F-D anti-consensus statistic is explicitly indicated for these subjects along with their states |Sₘ [symbol] , |Sₙ [symbol] . To consider subject states |Sₘ [symbol] , |Sₙ [symbol] jointly we introduced tensor space [symbol] ^{(Sm,Sn)}= [symbol] _{Sm} [symbol] [symbol] _{Sn}. This space can hold any joint state that these two exemplary subject states may yield. In other words, any tensor state |Sₘ [symbol] [symbol] |Sₙ [symbol] that is among subjects Sₘ, Sₙ modulo proposition 107 has to be in tensor space [symbol] ^{(Sm,Sn)}.

Knowledge of anti-consensus statistics F-D among subjects Sₘ, Sₙ modulo proposition 107 tells us that whatever joint state obtains it must be anti-symmetric. Components of any legitimate joint state Ψ=|Sₘ [symbol] [symbol] |Sₙ [symbol] for F-D anti-consensus subjects Sₘ, Sₙ will interchange with a “−” sign. An anti-symmetric joint state resides in the anti-symmetric subspace of [symbol] ^{(Sm,Sn)}.

Again, it may be difficult to discern such competitive dynamic among subjects Sₘ, Sₙ modulo underlying proposition 107 about house 109r3 or the need for an anti-symmetric joint state from data files 112 and communications found in traffic propagating via network 104 and within social network 106. Therefore creation module 117 has to review data files 112 as well as any communications originated by and/or passed between subjects Sₘ, Sₙ and containing indications exhibited in situations where both were present and were confronted by propositions as close as possible to proposition 107 about house 109r3. The prevalence of “big data” as well as “thick data” that subjects produce in self-reports is again very helpful. Still, the human curator who understands the lives of both subjects Sₘ, Sₙ should preferably exercise their intuition in reviewing and approving the proposed F-D anti-consensus statistic for each subject modulo proposition 107 about house 109r3 in view of some limitations developing in “big data”, as mentioned above.

The joint state available to F-D anti-consensus subjects Sₘ, Sₙ inhabits anti-symmetric subspace of tensor space [symbol] ^{(Sm,Sn)} and we will use subscript ASM-V to remind ourselves of this fact. In other words, the anti-symmetric joint state between subjects Sₘ, Sₙ takes on the general form expressed by Ψ=|Sⱼ [symbol] [symbol] |Sⱼ [symbol] =|Sⱼ [symbol] Sₖ [symbol] _{ASM-V}. The ASM-V subscript is also used on the complex coefficients alpha and beta to remind us that they are used in this decomposition of the anti-symmetric joint quantum state. The tensor space is based on the V-basis decomposition for each subject per “rentability” contextualization. This is because of the known use of subject value matrix PR_{V} by both subjects Sₘ, Sₙ in contextualizing proposition 107 about house 109r3 in terms of “rentability”. The known contextualization in the case of each one of subjects Sₘ, Sₙ has two possible eigenvalues λ₁, λ₂ corresponding to measurable indications “YES” and “NO”.

Given this, the full anti-symmetric joint state |Sⱼ [symbol] Sₖ [symbol] _{ASM-V} that subjects Sₘ, Sₙ in contextualizing proposition 107 about “rentability” of house 109r3 can be decomposed in eigenvectors |sv₁ [symbol] and |sv₂ [symbol] . These are the eigenvectors of subject value matrix PR_{V} for each subject. The superposition is expressed as:

Ψ=|Sₘ [symbol] Sₙ [symbol] _{ASM-V}=1/\sqrt{2}(|sv₁ [symbol] _{S}_{ₘ} [symbol] |svₙ−|sv₂ [symbol] _{S}_{ₘ} [symbol] |sv₁ [symbol] _{S}_{ₙ}). Eq. 24

Of course, this expression presumes that subjects Sₘ, Sₙ are the only two that are confronted jointly by proposition 107 about renting house 109r3. Subjects Sₘ, Sₙ are not affected in their joint state by anything other than each other and proposition 107. As in the case of B-E consensus subjects discussed previously, such entanglement may not be complete and other environmental effects may need to be taken into account. In the present example subjects Sₘ, Sₙ entangle with negligible environmental influences.

We now turn to FIG. 5B to examine the process of entanglement that leads to the anti-symmetric joint state expressed in Eq. 24. This drawing figure illustrates the inside of subspace 800B only. We again remind ourselves of context 202 covering subjects Sₘ, Sₙ in subspace 800B being due to proposition 107 about house 109r3 in particular.

FIG. 5B introduces a signaling channel 802FD whose aspect admitting of illustration corresponds to Riemann surface RS′. Signaling channel 802FD spans subspace 800B that is more rigorously defined by the anti-symmetric portion of tensor space [symbol] ^{(Sm,Sn)}. A small portion 804B of channel 802FD is shown in an exploded form to afford a closer examination. Channel 802FD may be considered as the communication link. In embodiments where subjects are placed on vertices of a graph, channel 802FD stands for the link or edge that connects the vertices or nodes to which subjects Sₘ, Sₙ are assigned. The reader is referred to U.S. patent application Ser. No. 14/324,127 for embodiments where subjects are mapped onto graphs including the social graph.

For purposes of present explanation, channel portion 804B is expanded into three dimensions (3-dimensional space or [symbol] ³). These stand for those previously introduced for Bloch Sphere 10 in FIG. 1A. We thus have the X, Y, Z axes. Of these the X and Z axes correspond to real axes and are thus additionally labeled Re. Meanwhile, the Y axis corresponds to the imaginary axis and is additionally labeled by Im. The reader is cautioned that the standard SU(2) representation of spinors on which our explanation is based double-covers the Bloch Sphere shown in [symbol] ³. Thus, the illustration should be considered for visualization purposes. Those skilled in the art will recall that the imaginary axis, here the Y axis extending along channel portion 804B, may be thought of as the time axis (see also Wick rotation where time is allowed to extend along the imaginary axis).

Signaling channel 802FD defines a space traversed by signals or messages that allow subjects Sₘ, Sₙ to interact. It is important to realize that any medium that carries information between subjects Sₘ, Sₙ can support signaling channel 802FD. In preferred embodiments of the present invention signaling channel 802FD is the corresponding portion of network 104 of computer system 100 that supports signaling between subjects Sₘ, Sₙ (see FIG. 2). Still differently put, channel 802FD is traversed by messages that are passed between subjects Sₘ, S_{n.}

There is an analogy between messages or signals exchanged by subjects Sₘ, Sₙ and the gauge boson that mediates the field between field quanta. In the cases discussed so far the QFT of choice for explanatory purposes has been QED. In this field theory the gauge is mediated by the photon γ. The photon γ in its role as gauge boson is described by the Abelian U(1) symmetry at every point along its space-time trajectory (see also null ray). U(1) symmetry permits the photon γ to assume standard observed polarizations. The two basis states of the photon γ are conveniently set to right-handed and left-handed polarizations. Other observed polarizations, such as the often-discussed linear polarization, are built up of combinations of these two basis states. The diligent reader is referred to standard texts on Quantum Field Theory mentioned in the Background Section for a more thorough treatment of the photon including its deeper significance as mediator of the gauge field under the QED Lagrangian as well as the non-physical states assumed by virtual photons.

From the physics inspiration to our quantum representation we draw an analogy between the photon γ as mediator between field quanta, to the signal in signaling channel 802FD as mediator between subjects Sₘ, Sₙ. In particular, we see in the exploded portion 804B of channel 802FD a message or signal designated by the reference \tilde{γ}. This choice of reference is clearly inspired by the analogy to the photon γ. Message or signal \tilde{γ}, which in accordance to the gauge freedom can mediate any allowable state is shown to propagate along imaginary axis Y of FIG. 5B. In fact, in this figure signal \tilde{γ} is reminiscent of a right-handed photon.

Of course, as remarked, this analogy to the physics model is used to interpret signaling, rather than to set forth a formal characterization thereof (e.g., formal determination of the permissible gauge freedom and dimensionality associated with mediation between subjects Sₘ, Sₙ). What is important, however, is that signal \tilde{γ} traces components corresponding to the V-basis laid down by subject value matrix PR_{V} expressing the “rentability” contextualization. In other words, signal \tilde{γ} can mediate between subjects Sₘ, Sₙ whose internal states 110m, 110n are assigned states |Sₘ [symbol] , |Sₙ [symbol] that are eigenvectors |sv₁ [symbol] , |sv₂ [symbol] of subject value matrix PR_{V.}

In FIG. 5B the capacity of mediation between subjects Sₘ, Sₙ that contextualize in the V-basis via signal \tilde{γ} is indicated by its “alignment” with ray V. The reader is reminded here that the eigenvectors in the Bloch representation extend along ray V in opposite directions. Ray V is found embedded in signal \tilde{γ} in the exploded portion of signaling channel 802FD. In accordance with the physics inspired quantum representation adopted herein, signal \tilde{γ} can mediate between subjects choosing any value basis that is within subspace 800B. This last statement is tantamount to saying that the gauge boson that is embodied by signal \tilde{γ} can mediate all states that are permissible. A person skilled in the art will realize that this is a re-statement of the fact that the gauge freedom of a QFT is properly mediated by its gauge boson.

We now turn to FIG. 5C to review the formation of entanglement between subjects Sₘ, Sₙ that leads to the fully anti-symmetric joint state expressed with Eq. 24. Bloch spheres 10m, 10n are used here in the quantum representation to stand for subject states. However, they do not indicate states |Sₘ [symbol] , |Sₙ [symbol] of subjects Sₘ, Sₙ as in previous teachings. Using pure states is no longer appropriate when describing entangled states (density matrix representation is required). Thus, Bloch spheres 10m, 10n just show eigenvectors |sv₁ [symbol] _{S}_{ₘ}, |sv₂ [symbol] _{S}_{ₘ} for subject Sₘ and eigenvectors |sv₁ [symbol] _{S}_{ₙ}, |sv₂ [symbol] _{S}_{ₙ} for subject Sₙ. These, of course, are the eigenvectors of the V-basis set forth by subject value matrix PR_{V} that stands for contextualization according to “rentability”.

Note that these same four eigenvectors |sv₁ [symbol] _{S}_{ₘ}, |sv₂ [symbol] _{S}_{ₘ}, |sv₁ [symbol] _{S}_{ₙ}, |sv₂ [symbol] _{S}_{ₙ} are an appropriate basis for the anti-symmetric portion of tensor space [symbol] ^{(Sm,Sn)} that contains any admissible joint subject state involving subjects Sₘ, Sₙ. Therefore, the density matrix representation of the entangled state can be expressed using these eigenvectors.

The top portion of FIG. 5C illustrates a representative sample of possible real life interactions and more generally signals between subjects Sₘ, Sₙ over proposition 107 about house 109r3. These messages or signals are contained in the real life events portion of FIG. 5C within the dashed outline 806. The messages, signals and interactions may include in person as well as online events. In general, they can include exchanges of signals or messages in spoken, written and/or any other communicable form(s) (e.g., by proxies of understanding and/or signs) between subjects Sₘ, Sₙ. Overall, the exchange may include conversation(s), monologue(s), unidirectional and/or bidirectional signaling that is direct and indirect in nature. For example, a threat issued or relayed via a third subject is considered communication that is indirect in nature. The reference 808 generally indicates any permissible collection of messages or signals up to and including conversation(s) and richer exchanges between subjects Sₘ, S_{n.}

The quantum representation of real life events within outline 806 are indicated in the lower portion of FIG. 5C. Here we see interaction 808 being translated into an exchange of messages or signals \tilde{γ} already introduced above. In physics proper, photon exchange corresponds to the interaction mechanism between the field quanta in QED, e.g., electrons. This exchange can lead to the formation of a joint state. Interaction via the gauge field also requires a certain fundamentally indeterminate amount of time to occur with some given probability. This indeterminate time, just as many other quantities in quantum mechanics, is not a classically computable quantity.

An effective way to treat time is as a parameter that relates to a transition probability. The transition we are interested in is from separable subject states |Sₘ [symbol] , |Sₙ [symbol] expressing known contextualizations and measurable indications when subjects Sₘ, Sₙ are on their own, to the joint subject state Ψ=|Sₘ [symbol] Sₙ [symbol] _{ASM-V} as fully expressed by Eq. 24. The concept we will use herein is that of a half-life τ. With the transpiration of each half-life τ that subjects are jointly exposed to proposition 107 about house 109r3 the probability of formation of the joint subject state we are interested in increases. Equivalently, the likelihood of no exchange of message or signal \tilde{γ} decreases by 1/e (where e is Euler's number that is irrational and approximately equal to 2.71828) after each half-life τ. Although no time is indicated in the quantum representation of FIG. 5C, the practitioner is advised to ensure that at least a few half-lives τ be allowed to transpire in order to form the desired joint subject state between subjects Sₘ, S_{n.}

We now consult the diagram of FIG. 5D to track the formation of an entangled state between subjects Sₘ, Sₙ in more detail. In the present example the entangled state is embodied by joint subject state Ψ of Eq. 24. This figure illustrates real life events involving subjects Sₘ, Sₙ and salient aspects of their quantum representation. The quantum representation is shown on the right of a time line 300. Real life events involving subjects Sₘ, Sₙ are shown on the left of time line 300. By laying out the diagram in this manner, real life events and the quantum representation are thus temporally synced. Time increases in the up direction.

Recall that prior to entering or forming the joint subject state Ψ the contextualization and the individual measurable indications for each subject Sₘ, Sₙ are known. More precisely, we know or can at the very least estimate from history and/or any other available data as discussed above, the measurable indications of subjects Sₘ, Sₙ while still individuated. The time when subjects Sₘ, Sₙ are individuated and not yet jointly confronted by proposition 107 is prior to an initial time tₒ as shown at the bottom of time line 300. A separator 810 is used on the real life side of time line 300 to visually remind us of the independent nature of subjects Sₘ, Sₙ at this stage. Meanwhile, on the quantum representation side right of time line 300 known and separable subject states |Sₙ [symbol] are designated with the aid of corresponding Bloch spheres 10n, 10m.

We note that before initial time tₒ both separable subject states |Sₘ [symbol] , |Sₙ [symbol] are reasonably pure and correspond to eigenvector |sv₁ [symbol] of the V-basis laid down by subject value matrix PR_{V} denoting contextualization by “rentability”. In other words, both subjects Sₘ, Sₙ are in an inner state that can be represented by eigenvector |sv₁ [symbol] according to which the subject considers house 109r3 to be desirable or rentable (a measurement would yield the corresponding eigenvalue “YES” for “rentability”). We use subscripts to remind ourselves of the basis and to designate the corresponding subject. Subscript V stands for the basis of the spectral decomposition and subscripts Sₘ, Sₙ indicate which subject. In other words, we have |Sₘ [symbol] _{V}=|sv₁ [symbol] _{S}_{ₘ} and |Sₙ [symbol] _{V}=|sv₁ [symbol] _{S}_{_{n.}}

Joint exposure to proposition 107 commences at initial time tₒ. At this initial time tₒ subjects Sₘ, Sₙ are placed by system 100 (see FIG. 2) under conditions in which they realize that they are both confronting underlying proposition 107 about house 109r3. At this point in time, both subjects Sₘ, Sₙ are still most likely using their known contextualization of “rentability”.

Their discovery of the fact that they are jointly confronting proposition 107 may take place in real life or, preferably, online within system 100, e.g., within network 104 or even within social network 106. The fact that both subjects Sₘ, Sₙ are F-D anti-consensus type modulo proposition 107 about renting house 109r3 is indicated in FIG. 5D by a specific visual designation of interaction 808. Namely, the arrows indicating interaction 808 are blank and shaded, respectively. This represents a type of exchange or conversation that cannot lead to consensus or agreement on the same state for both subjects Sₘ, Sₙ even in principle. Instead, subjects Sₘ, Sₙ are locked in a win/lose or competitive mentality. They will not be able to devise a way to share house 109r3 by moving in together or by any other strategy. One can consider subjects Sₘ, Sₙ to be in some sense “repulsive” with respect to each other modulo proposition 107. The physical outcome of such situations ends in one subject outbidding the other.

Joint exposure commencing at initial time tₒ finds its quantum representation on the right side of time line 300. Starting at time tₒ the two previously known states of subjects Sₘ, Sₙ can no longer be labeled. In fact, they cannot be presumed to be separable. Now they are engaged in the possible formation of joint subject state Ψ. This process is indicated by the corresponding dashed outline 812.

Time line 300 indicates that a time equal to five half-lives (5τ) is allowed to elapse during which subjects Sₘ, Sₙ are jointly exposed to proposition 107 about renting house 109r3. Because of indistinguishability dictated by our quantum representation we can't at this stage say who is who. Thus, the Bloch spheres are not expressly labeled. However, at some time a message or signal \tilde{γ} is exchanged and leads to the formation of joint subject state Ψ that is entangled. More than one signal \tilde{γ} can be exchanged up to an inclusive an entire conversation. Furthermore, since the quantum representation cannot yield but statistical information about when the exchange happens, we have indicated in a dashed line in FIG. 5D. For the purposes of the present example it is presumed that joint subject state Ψ is achieved by time tⱼₛ, or after five half-lives. This is a fairly safe assumption, as the careful reader will note that the probability of not having formed joint subject state Ψ after that much time is less than 1%.

The joint confrontation or exposure of subjects Sₘ, Sₙ to house 109r3 where underlying proposition 107 concerns rent to thus induce the formation of joint subject state Ψ is not open-ended. Generation of joint subject state Ψ and its persistence is bounded in time. Once achieved with more than 99% likelihood by time tⱼₛ joint subject state Ψ will have a tendency to decohere or dissociate with the passage of time. Based on physical rules on which the present quantum representation is based, the persistence of the joint state is associated with a decoherence time τ_{D} for subjects Sₘ, Sₙ. Preferably, this time is estimated by system 100 and further corroborated by the human curator.

In vernacular terms, decoherence time τ_{D} is directly related to how long, once in joint subject state Ψ, subjects Sₘ, Sₙ can remain in it. In the quantum representation adopted herein, we specify that ideally much less time than one decoherence time τ_{D} should elapse between obtaining the joint state at time tⱼₛ and measuring it (by measuring either or both of subjects Sₘ, Sₙ) to obtain any eigenvalue(s) or subsequent measurable indication(s). As more and more decoherence times τ_{D} expire, the probability of subjects Sₘ, Sₙ persisting in joint subject state Ψ will typically be found to decay exponentially. We can thus only speak of entanglement with a high expectation that it is still there prior to the expiration of one decoherence time τ_{D} and preferably just a fraction thereof. In the following discussion it will be assumed that our chosen pair of subjects Sₘ, Sₙ are being considered within a time period much shorter than one decoherence time τ_{D} after time t_{js.}

It is important to realize that entanglement itself produces a correlation between subjects Sₘ, Sₙ that transcends their individuality. This is fully captured by joint subject state Ψ of Eq. 24. Even more, this correlation transcends any particular choice of contextualization by either subject in the pair. In other words, as long as entanglement in the pair of subjects Sₘ, Sₙ persists, it will manifest modulo proposition 107 about house 109r3 even when house 109r3 is not considered in the “rentability” contextualization. This rather surprising type of correlation existing prior to the choice of basis (or, equivalently, prior to the choice of contextualization) is not found in classical representations. It is a unique feature of the quantum representation adopted herein and it does warrant further explanation.

Correlation due to entanglement produces a kind of bond or anti-bond, depending on type of joint subject state (which is partly dictated by the consensus or anti-consensus statistics). F-D anti-consensus subjects Sₘ, Sₙ establishing entanglement under joint subject state Ψ of Eq. 24 generate an anti-bond. This anti-bond transcends physicality. In some embodiments of the invention it can be assigned its own proxy that has explanatory power among subjects Sₘ, Sₙ and for any user of computer system 100, e.g., an analyst.

Convenient proxies include feelings such as trust, distrust, amity, enmity, belonging, loneliness (apartness) and/or other feelings that subjects Sₘ, Sₙ recognize. Of course, these proxies may only be posited in internal spaces 110m, 110n (see FIG. 5B) of subjects Sₘ, Sₙ. Their use for explanatory purposes should not be unduly extended.

In the present case, subjects Sₘ, Sₙ established an anti-bond in their strife over rental of house 109r3 while jointly exposed to proposition 107. Given that both subjects Sₘ, Sₙ are F-D anti-consensus, a likely feeling that may encapsulate their anti-correlation formed through entanglement is enmity. Had subjects Sₘ, Sₙ been B-E consensus type and established correlation in a different entangled state, then even if one had “won” and the other “lost” the bidding over house 109r3 a likely feeling representing the bond (rather than anti-bond found among F-D anti-consensus types) would be mutual respect.

The key feature of correlations (i.e., correlations and anti-correlations) that can thus be captured by the proxy of a feeling is that it forms and persists in Hilbert space. In other words in the case of subjects Sₘ, Sₙ their anti-correlation captured by joint subject state Ψ does not have any objective existence in real life. No equivalent of this anti-correlation, just as in the case of feelings, can be represented in precipitated reality conditions illustrated on the left side of time line 300. The only way to find evidence of the existence of the entangled state when operating within the domain of real life events is through measurement. Of course, measurement necessitates a basis choice, or equivalently a choice of contextualization. Thus, only a “projection” of the entanglement created between subjects Sₘ, Sₙ can ever be observed.

FIG. 5D illustrates the anti-bond established in the entangled pair of subjects Sₘ, Sₙ by showing that they will anti-correlate under any given proposition 107 involving house 109r3. In other words, irrespective of choice of basis (contextualization) modulo proposition 107, when measured in that basis their measurable indications will anti-correlate. The drawing figure uses the rather universal thumbs-up and thumbs-down signs to illustrate the anti-correlation of subsequent measurable indications that entangled subjects Sₘ, Sₙ are expected to manifest in real life. In preferred embodiments of the invention network monitoring unit 120 is in charge of collecting subsequent measurable indications from subjects Sₘ, S_{n.}

On the quantum representation side of time line 300 we show the entangled state Ψ with the aid of new Bloch spheres 10n′ and 10m′. Explanation of entangled state Ψ requires the density matrix formalism. For reasons of simplicity and clarity, the present example presumes that subjects Sₘ, Sₙ entangled with negligible environmental influences and are thus truly represented by joint state Ψ as expressed in Eq. 24. A person skilled in the art will recognize that effects beyond entanglement can be included in the density matrix expression of subject's internal state in accordance with the quantum representation taught herein.

Bloch spheres 10n′, 10m′ no longer illustrate individual states with eigenvectors. Rather, as shown on the example of subject Sₙ assigned to Bloch sphere 10n′, entanglement caused its reasonably pure eigenstate |sv₁ [symbol] _{S}_{ₙ} of value matrix PR_{V} to “jump” to a point 816n at the center of Bloch sphere 10n′ as indicated by arrow 814. In other words, the quantum representation of internal state 110n of subject Sₙ modulo proposition 107 about house 109r3 has ceased to be a reasonably pure state associated to single state vector |sv₁ [symbol] _{S}_{ₙ} or, equivalently its point 18 on the surface of Bloch sphere 10n′. Internal state 110n of subject Sₙ modulo proposition 107 is now expressed by density matrix ρ_{n.}

The same is true for subject Sₘ whose experience of entanglement with subject Sₘ modulo proposition 107 sends his quantum representation to a point 816m at the center of Bloch sphere 10m′. Internal state 110m of subject Sₘ modulo proposition 107 is now expressed by density matrix ρₘ. The reader is reminded here that once the quantum description of the subject's state ceases to be confined to the surface of the Bloch sphere (i.e., it ceases to be a pure state and becomes mixed) it also stops being unique. In other words, there are many ways to describe the same point within the Bloch sphere. Still differently put, many types of entanglement can lead to the subject's state to be expressed by the same point within the Bloch sphere.

FIG. 5D also provides an idea of environmental effects that may interfere with the achievement of perfect entanglement between subjects Sₘ, Sₙ. To keep matters simple, environmental influences are shown on the example of subject Sₙ only. As already noted previously, these could be due to additional entangling effects under coupling with aspects of the environment that may include other subjects, objects and/or experiences including the subject's own internal experiences. Because of such additional entanglement the quantum representation of inner state 110m of subject Sₘ changes. This is depicted in Bloch sphere 10m′ where point 816m at center is dislodged to point P̅ as shown in the dashed lines.

The amount by which point P̅ moves away from center point 816m is conveniently described by projections Pₓ, P_{y}, P_{z}. Put together, these parameterize point P̅ in vector form that can be used to describe the deviation of subject Sₘ from perfect entanglement under Eq. 24 with subject Sₙ. The perturbed density matrix ρₘ that describes internal state 110m of subject Sₘ is explicitly written out in terms of point P̅, the identity matrix I and the “vector” of Pauli matrices σ̅ (see also Eq. 13 in Background section).

In the following we presume perfect entanglement in accordance with Eq. 24. In view of the previous example of perturbation, we immediately see that for states corresponding to points 816m, 816n at the centers of their Bloch spheres 10m′, 10n′ (or alternatively where point P̅={0, 0, 0}) density matrices ρₘ, ρₙ become just one half the identity matrix I. This is the simple case we have been introduced to in the Background section (refer to Eqs. 15 & 16 and corresponding discussion).

A crucial realization is that entanglement between subjects Sₘ, Sₙ leading to density matrices ρₘ, ρₙ could have been achieved in any other basis or contextualization of proposition 107! Say subjects Sₘ, Sₙ had been jointly exposed to proposition 107 while previously espousing a known alternative contextualization expressed by an alternative subject value matrix PR_{AV}. For example, alternative value matrix PR_{AV} sets forth the alternative contextualization by “architectural beauty”. Its eigenbasis contains two orthogonal eigenvectors. This first eigenvector |sav₁ [symbol] stands for finding house 109r3 architecturally beautiful. The second eigenvector |sav₂ [symbol] stands for not finding house 109r3 architecturally beautiful. The eigenvalues that go with these eigenvectors are mutually exclusive measurable indications of “YES” and “NO”.

Clearly, entanglement between subjects Sₘ, Sₙ could now lead to Eq. 24 but using the basis vectors |sav₁ [symbol] , |sav₂ [symbol] of alternative subject value matrix PR_{AV}. In other words, we now obtain the same expression with the new basis vectors:

Ψ=1/\sqrt{2}(|sav₁ [symbol] _{S}_{ₘ} [symbol] |sav₂ [symbol] _{S}_{ₙ}−|sav₂ [symbol] _{S}_{ₘ} [symbol] |sav₁ [symbol] _{S}_{ₙ}).

But this will again lead to the same density matrices ρₘ, ρₙ! Therefore, irrespective of how entanglement was achieved, density matrices ρₘ, ρₙ continue to describe the individual states of subjects Sₘ, Sₙ modulo proposition 107. This holds for purposes of collection of subsequent measurements from each one of subjects Sₘ, Sₙ on its own. Of course, we again presumed no environmental effects in this case.

The gist of entanglement is thus seen to transcend correlations and anti-correlations modulo propositions about items manifesting in physical reality or in the realm or real life events shown on the left side of time line 300. Entanglement is an expression of an overall approach to proposition 107 in any basis when subjects Sₘ, Sₙ are cognizant of each other. Indeed, in some instances even the exchange of the item about which proposition 107 is formed may not affect the entangled state (see also U.S. patent application Ser. No. 14/583,712).

Entanglement between subjects may sustain or persist over different propositions altogether. In the vernacular, it is as if subjects Sₘ, Sₙ developed an anti-correlation in measurable indications irrespective of what proposition it is they are confronting. Of course, for subjects that exhibit the B-E consensus statistic entangled states that point to the development of a liking of each other irrespective of the proposition and/or the item it is about is possible too.

In the quantum representation entanglement is taken to persists even when subjects Sₘ, Sₙ are no longer together. The inspiration for this aspect of the representation is once again derived from physics proper, where entanglement has been confirmed to sustain for non-local states. Experiments that empirically corroborate this are commonly done with Bell states separated by large distances (see also EPR states). Eigenvalues obtained in measuring one of the pair of particles or photons in some basis are seen to obey the correlation established in Hilbert space when the other particle or photon of the pair is measured in the same basis. The reader is encouraged to explore the many experimental verifications of Bell's inequality. For other types of tests of entanglement and “no-go” theorems for classical explanations of entanglement (typically using hidden variables) the reader is referred to the Kochen-Specker (KS) theorem along with its early version presented by von Neumann and also to Gleason's theorem in quantum logic.

The establishment of entanglement in physics is due to an underlying symmetry or conservation law that governs the interaction (for a more extensive review see Noether's theorem and the Ward-Takahashi identity). Underlying symmetries transcend specific instances. In the case of the two spinors we have been using in our example, it is typically the conservation of angular momentum that is used to illustrate this point. We start with an entangled state in which the pair of spins add to yield a net angular momentum of zero. The careful reader will recognize that this is the state encapsulated by Eq. 24. When the two spins separate and the joint state has not yet decohered, conservation of angular momentum dictates that the spins anti-correlate when measured in the same basis. It is irrelevant how far apart the spins are in emerged or precipitated reality from the point of view of conservation of angular momentum that is imposed on the state in Hilbert space. No communication between the spins in emerged or precipitated reality is required to communicate this underlying symmetry (conservation of angular momentum).

By extending entanglement to pairs of subjects we are importing these foundational insights about physical nature to inform our quantum representation. We thus posit that once formed, entanglement continues to affect subjects Sₘ, Sₙ even when they are no longer together. Thus, their entanglement continues until it is destroyed by decoherence.

FIG. 5E first shows subjects Sₘ, Sₙ together after being entangled at time tⱼₛ when their joint subject state Ψ is created (with 99% probability, as noted above). On the quantum representation side of time line 300 we show their joint subject state Ψ pictorially for reasons of simplicity. Note that the plus sign in this picture merely indicates that the state is joint (the formal joint subject state has a minus sign and is described by Eq. 24). The fact that subjects Sₘ, Sₙ are entangled to anti-correlate on subsequent measurable indications when collected in the same basis (or, equivalently, in the same contextualization) is indicated by opposite shadings of the Riemann surfaces.

Before the passage of one decoherence time τ_{D} after entanglement time tⱼₛ subjects Sₘ, Sₙ are physically separated. The separation occurs in real life at a separation time tₛₑₚ. It is designated by arrow 820 shown on the left side of time line 300. Subjects Sₘ, Sₙ are no longer together after time tₛₑₚ and thus cannot be jointly exposed to proposition 107 any more.

Nevertheless, according to our quantum representation subjects Sₘ, Sₙ are still entangled after separation time tₛₑₚ with a very high probability (until they decohere). As a reminder of this important aspect, we note on the quantum representation side of time line 300 that physical separation 820 has no effect on entangled state as described by joint subject state Ψ. The reader should note that once some sufficient physical separation between subjects is achieved in real life, complete online separation, i.e., in network 104 can be used to achieve and keep the final physical separation.

In the present example a large physical separation 820 is used for pedagogical reasons. In particular, subject Sₘ moves to San Francisco while subject Sₙ moves to New York city. This is visually indicated on the real life events side of time line 300. At the same time, nothing changes in the description of joint subject state Ψ on the quantum representation side. Just to indicate that subjects are physically separated their Riemann surfaces are rearranged but they stay within the same Hilbert space.

At a measurement time tₑ subjects Sₘ, Sₙ are re-confronted by proposition 107 about renting house 109r3 again. The re-confrontation or exposure is not joint, since subjects Sₘ, Sₙ are evidently separated and not in communication with each other. Moreover, the re-confrontation may not occur at exactly the same time for each of subjects Sₘ, Sₙ. In some cases, only one subject may be measured and the other not. For reasons of explanation of the effects of entanglement, however, we will continue with a case in which both subjects Sₘ, Sₙ are measured and yield subsequent measurable indications.

In a preferred embodiment re-confrontation with proposition 107 is orchestrated by using any of the affordances of network 104 and/or social network 106 within computer system 100. Alternatively, re-confrontation may happen in real life. It may even occur spontaneously when, for example, both subjects Sₘ, Sₙ read their respective newspapers with advertisements for rental of house 109r3 at their original location prior to separation. Just for the purpose of the present example, we will take this place to be Chicago, as also indicated in FIG. 5E.

For the purposes of the present example neither subject in the entangled pair had ultimately won the bidding over house 109r3. Some unknown third subject had rented house 109r3. This unknown subject is vacating house 109r3 shortly after moving in, so it is available for rent once more. Subjects Sₘ, Sₙ living their now separate lives, as indicated by arrows 822A and 822B, learn about this fact separately. Again, by separate lives 822A, 822B we mean that subjects Sₘ, Sₙ are no longer in any communications with each other and are thus not exchanging any signals or messages about any propositions and especially not about proposition 107 about renewed rental opportunity of house 109r3. This lack of contact is true in real life and online.

Local network monitoring units 120A, 120B are provided in San Francisco and New York city for collecting subsequent measurable indications from subjects Sₘ, Sₙ modulo proposition 107. Preferably, units 120A, 120B belong to overall network monitoring unit 120 (see FIG. 2) or are otherwise integrated and/or interfaced therewith in any permissible manner. Units 120A, 120B have access to information generated by the subjects. For example, units 120A, 120B belong to a system that monitors transactions such as rentals and sales of real estate evidently including house 109r3. Examples of such systems are well known in the art of real estate brokerage and include services built around the likes of Multiple Listing Services (MLS) and other closed and open transaction recordation services.

At event time tₑ, which is slightly different for each subject (e.g., from a few hours to a few day apart), units 120A, 120B collect subsequent measurable indications from subjects Sₘ, Sₙ. Of course, both are collected within a single decoherence time τ_{D} after entanglement time tⱼₛ. In accordance with the quantum representation, it is therefore very likely that both subjects Sₘ, Sₙ still deploy the contextualization of proposition 107 in terms of “rentability” of house 109r3 when re-confronting proposition 107.

On the other hand, if joint state Ψ between subjects Sₘ, Sₙ has already decohered by event time tₑ then no entanglement effects will be observed. At this point subjects Sⱼ, Sₖ can be treated separately as previously taught for individual or independent states (separable states). Preferably, the new and independent states should be estimated first before attempting any tracking, simulation or prediction.

For the present purposes, we will proceed under the assumption that the measurement or “collapse” of the wave function does indeed happen from joint state Ψ. The joint state manifests the anti-correlated measurable indications. This is shown on the quantum representation side of time line 300 by table 830 of possible subsequent measurable indications when both subjects Sₘ, Sₙ again choose the “rentability” contextualization of proposition 107. Specifically, the measureable indications are here properly associated to their correspondent eigenvalues.

It is duly noted, that although both subjects Sₘ, Sₙ can still be contextualizing proposition 107 about renting house 109r3 the same way at event time tₑ, namely “rentability”, their context choice at that time can also be different. This different context choice does not negate or undo the effects of entanglement, as we will see further below.

Table 830 shows the measurable indications that can be collected from collapsing anti-symmetric joint state Ψ in the same contextualization. As noted above, both subjects use the same subject value matrix PR_{V}, which corresponds to contextualization by “rentability”. They eigenvalues come in pairs since we measure both subjects. They go with the eigenvectors in the tensor space [symbol] ^{(Sm,Sn)}. To keep better track, we take eigenvalues λ_{Sm,1}, λ_{Sm,2} as those for subject Sₘ (“YES”, “NO” from subject Sₘ) and λ_{Sn,1}, λ_{Sn,2} as those for subject Sₙ (“YES”, “NO” from subject Sₙ). In the same contextualization of “rentability” the pairs will include: “YES”, “NO” and “NO”, “YES” for subjects Sₘ, Sₙ, respectively. In table 830 the entries corresponding to these indications are shown with a check sign. The “YES”, “YES” and “NO”, “NO” options available when the entangled subjects are B-E consensus type are not available to the F-D anti-consensus type subjects Sₘ, Sₙ. The corresponding entries in table 830 are therefore crossed out. Also recall that the indistinguishable nature of subject states in this quantum representation precludes labeling of subjects prior to measurement. Only after the measurement is performed at a later time will we know how subjects Sₘ, Sₙ chose their “YES” and “NO” eigenvalues.

Entanglement ensures that subjects Sₘ, Sₙ will yet again exhibit strife typical of two competing F-D anti-consensus subjects. In the vernacular, the two subjects Sₘ, Sₙ will effectively replay their original competitive dynamic. In the chosen contextualization of “rentability”, the strife can manifest in a “bidding war” or similar situation. We recall that the eigenvalues λ_{Sm,1}, λ_{Sm,2} and λ_{Sn,1}, λ_{Sn,2} can manifest not only in terms of the mutually exclusive responses of “YES” and “NO”. They may take on the form of a real-valued parameter W that denominates a socially accepted quantity. For example, in real life the renewed competition between subjects Sₘ, Sₙ over house 109r3 can find expression in measurable indications being differing amounts of money offered to rent house 109r3. In this case, money would be the embodiment of the real-valued parameter W. U.S. patent application Ser. No. 14/504,435 discusses measurable indications in the quantum representation of the invention and suitable real-valued parameter W or quantity. Indeed, the presentation of more money W by one subject over the other is a legitimate step in a competitive bidding for rent of house 109r3 between F-D anti-consensus subjects Sₘ, Sₙ. This process assures that only one will rent house 109r3, thus proving out the F-D anti-consensus dynamic.

Surprisingly, the competitive dynamic will play out even if subjects Sₘ, Sₙ choose a different contextualization when re-confronted by proposition 107. For example, let us consider the case where both subjects Sₘ, Sₙ decide at event time tₑ to contextualize proposition 107 they are re-confronted with in terms of “spirituality”. In this contextualization subjects do not consider house 109r3 for its suitability to be rented, but whether it is fit as a spiritual sanctuary. The purpose of house 109r3 is evidently different in contextualization by “spirituality”. Therefore, the judgment of house 109r3 in this contextualization will be different. We presume here that both subjects Sₘ, Sₙ are interested in house 109r3 in this secondary contextualization by “spirituality” for whatever reasons (e.g., for personal, religious or nostalgic reasons).

Contextualization of proposition 107 about house 109r3 by “spirituality” practiced by subjects Sₘ, Sₙ in this alternative is not compatible in the Heisenberg sense with the “rentability” contextualization expressed with subject value matrix PR_{V}. The “spirituality” contextualization is expressed with a secondary subject value matrix PR_{SV} whose eigenvectors are orthogonal to those of subject value matrix PR_{V}. Although it is clear that contextualizing by “spirituality” and by “rentability” typically cannot be applied simultaneously in agreement with the Heisenberg sense of non-commutability, the relationship should nevertheless be confirmed. In other words, commutator algebra should be used to obtain the best possible estimate of the relationship between subject value matrix PR_{V} and secondary subject value matrix PR_{SV.}

In practice, each subject is free to choose their own contextualization when re-confronted by proposition 107. To see what happens when the basis is changed it will be necessary to sway subjects Sₘ, Sₙ to adopt the “spirituality” contextualization. This is best done by using the resources of system 100 including networked devices 102, network 104 and/or social network 106 (see FIG. 2). For example, a new advertisement for house 109r3 is pushed to subjects Sₘ, Sₙ touting its spiritual attributes (e.g., as having qualities of a sanctuary or of a place for spiritual retreat). The purpose is to shift the choice of contextualization by subjects Sₘ, Sₙ (change of basis) but not to disrupt entanglement.

We proceed under the assumption that the strategy for shifting the basis was effective. In other words, subjects Sₘ, Sₙ switched from contextualizing proposition 107 by “rentability” to contextualizing it by “spirituality”. This means that the states of subjects Sₘ, Sₙ should now be spectrally decomposed in eigenvectors of secondary subject value matrix PR_{SV}. These eigenvectors are not the same as those of subject value matrix PR_{V}. In fact, they are possibly even completely orthogonal (ensure confirmation by commutator algebra) to those of subject value matrix PR_{V.}

We now expect something unusual to manifest. We have already discovered that the formation of entangled subject state Ψ modulo proposition 107 about house 109r3 originally achieved in the “rentability” contextualization expressed with subject value matrix PR_{V} led to density matrices ρₘ, ρₙ that were not unique representations of subject inner states. In other words, entanglement in any other basis or contextualization would have yielded the same density matrices ρₘ, ρₙ (consult FIG. 5D). To repeat, entanglement between subjects Sₘ, Sₙ leading to density matrices ρₘ, ρₙ could have been achieved in the contextualization of proposition 107 by “architectural beauty” expressed by alternative value matrix PR_{AV}, by “spirituality” expressed by secondary subject value matrix PR_{SV}, or indeed any other admissible contextualization under which subjects Sₘ, Sₙ can entangle!

This means that when subjects Sₘ, Sₙ remain entangled but deploy the same contextualization at event time tₑ, network monitoring units 120A, 120B will record measurable indications that anti-correlate. This is true irrespective of the commutation relation between the subject value matrices encoding the contextualizations. For example, value matrices PR_{V}, PR_{AV}, PR_{SV} could be non-commuting (yielding the largest commutator value possible) thus standing for contextualizationg that are not compatible (cannot be acted on simultaneously). Alternatively or they could commute and stand for contextualizations that can be adopted simultaneously in judging proposition 107. Most likely, they would represent contextualizations that partially commute and are somewhere in-between compatibility and incompatibility. In any event, however, as long as subjects Sₘ, Sₙ are still entangled and adopt the exact same contextualization, their measurable indications will anti-correlate.

Of course, in most common situations it will not be possible to sway both subjects Sₘ, Sₙ to choose the same contextualization. Attempting to do so may even break the joint subject state Ψ and consequently destroy entanglement. The human curator should be consulted when attempting to sway subject Sₘ, Sₙ to estimate the likelihood of loss of entanglement when forcing a contextualization upon one or both of them.

In the general case, subjects Sₘ, Sₙ will be allowed or even expected to freely choose different contextualizations upon being re-confronted by proposition 107. Despite this freedom, the effects of entanglement will become apparent in subsequent measurements. Specifically, the statistics of subsequent measurable indications collected by 120A, 120B from subjects Sₘ, Sₙ will violate Bell's inequality. In the vernacular, entanglement will cause the internal states of subjects Sₘ, Sₙ to “feel” each other's choices irrespective of contextualization. It is this absolutely astounding correlation between the inner states experienced by subjects Sₘ, Sₙ despite being separated that leads to statistics that violate Bell's inequality.

Of course, it is possible that only one of subjects Sₘ, Sₙ will manifest their measurable indication. The other subject may drop out of the competition without yielding their measurable indication. Nonetheless, as long as entanglement is still present there will be an effect. Specifically, at the time that the measurable indication of the first subject is collected the second subject concurrently assumes a certain internal state. This internal state will be the one that the quantum representation assigns based on the symmetry under which entanglement was formed. For our F-D anti-consensus type subjects Sₘ, Sₙ the second subject, if forced to yield their measurable indication would exhibit anti-correlation in the same contextualization. For B-E consensus type subjects, of course, measurable indications can correlate rather than anti-correlate under entanglement (depending on the joint subject state under which entanglement occurs).

FIG. 5F is a diagram that takes a closer look at a situation in which subject Sₘ yields their measurable indication λ_{Sm} at their event time t_{eSm}. The actual value of measurable indication λ_{Sm} is either λ_{Sm,1} or λ_{Sm,2}. It corresponds in our example to one of the two mutually exclusive responses “YES” or “NO”. In reliance on the fact that entanglement transcends contextualizations the contextualization in which subject Sₘ yields their measurable indication λ_{Sm} is not imposed. In other words, subject Sₘ is not swayed in their choice of contextualization. Instead, the contextualization unit 120B collects measurable indication λ_{Sm} (i.e., λ_{Sm,1} or λ_{Sm,2}) at event time t_{eSm} and simply notes the freely chosen contextualization exhibited by subject Sₘ when yielding their measurable indication A_{Sm.}

Subject Sₙ does not yield their measurable indication λ_{Sn} until their event time t_{eSn}. Again, the actual measurable indication λ_{Sn} is either λ_{Sn,1} or λ_{Sn,2} and stands for one of the two mutually exclusive responses “YES” or “NO”. Subject Sₙ is likewise allowed to freely choose their contextualization. Unit 102B collects measurable indication λ_{Sn} (i.e., λ_{Sn,1} or λ_{Sn,2}) at event time t_{eSn} and also notes the freely chosen contextualization exhibited by subject Sₙ when providing their measurable indication λ_{Sn.}

Now the reason for letting mapping module 115 choose subjects Sₘ, Sₙ that entangle in the same contextualization and are likely to continue to exhibit that contextualization in the future will pay its dividends. Specifically, since subjects Sₘ, Sₙ were chosen for exhibiting the known contextualization of “rentability”, it is likely that they will freely adopt this same contextualization after they have been entangled and are being re-confronted by proposition 107. Of course, this is just a probable situation and we do not presume that it will happen always or even most of the time. However, in the cases where both subjects Sₘ, Sₙ revert to contextualization by “rentability” the quantum representation tells us that their measurable indications λ_{Sm}, λ_{Sn}, if both collected at event times t_{eSm}, t_{eSn} that are very close (so as to prevent any appreciable state evolution in the interim between them) will anti-correlate.

It is crucial to note that the quantum representation does not dictate that the anti-correlation should be the same as before. The two subjects Sₘ, Sₙ can switch their “YES” and “NO” responses. Such a swap will still satisfy the entanglement condition. In addition, entanglement that assigns their inner states 110m, 110n to joint subject state Ψ will cause anti-correlated measurable indications λ_{Sm}, λ_{Sn} irrespective of the separation of subjects Sₘ, Sₙ in space-time. No transmission of physical information between subjects Sₘ, Sₙ is required for this to take place. In other words, the correlation does not exist on the real life events side of time line 300. Instead, it is confined to the Hilbert space on the quantum representation side of time line 300.

Einstein had a fundamental objection to this “spooky action at a distance” under which “collapse” or measurement of the state of one subject influenced the state of the other. To better understand the objection we examine our case of subject pair Sₘ, Sₙ in still more detail.

As shown in FIG. 5F, subject Sₘ is measured at time t_{eSm} by unit 120B in New York and exhibits eigenvalue λ_{Sm}=λ_{Sm,1}. Therefore, at measurement or event time t_{eSm} internal space 100m of subject Sₘ must be assigned to quantum state |sv₁ [symbol] _{S}_{ₘ}. This means that the density matrix ρₘ representation of their inner state 100m modulo proposition 107 is reduced to just state |sv₁ [symbol] _{S}_{ₘ}. Were it not so, then subject Sₘ would not have generated measurable indication λ_{Sm,1}, which is after all the physical manifestation of state |sv₁ [symbol] _{S}_{ₘ} per our quantum representation.

At this juncture Einstein would maintain that nothing has yet happened to subject Sₙ, who is far away in San Francisco. However, inner state 100m of subject Sₘ is entangled with inner state 100n of subject Sₙ. Thus, as subject Sₘ is measured and collapses to state |sv₁ [symbol] _{S}_{ₘ} it is inextricably entangled with inner state of 100n of subject Sₙ and thus has to “collapse” it too. That is the quantum meaning of the joint subject state. It is impossible to interact with one of the entangled entities in the pair without affecting the other irrespective of physical separation.

The measurement of subject Sₘ must therefore reduce the density matrix ρₙ representing inner state 100n of subject Sₙ modulo proposition 107 to pure state |sv₂ [symbol] _{S}_{ₙ}! The symmetry (anti-symmetric joint subject state) under which entanglement occurred in our quantum representation requires anti-correlation of inner states 100m, 100n. Notice that we did not need to measure the correspondent eigenvalue λ_{Sn}=λ_{Sn,2} from subject Sₙ at time t_{eSm} to establish the existence of state |sv₂ [symbol] _{S}_{ₙ}. Were it to be measured, it would have yielded eigenvalue λ_{Sn,2} given subject Sₙ is in state |sv₂ [symbol] _{S}_{ₙ}.

In labeling the states in the drawing figure we have added back the subscript V to indicate the V-basis decomposition in the “rentability” contextualization per subject value matrix PR_{V} for pedagogical reasons. The fact that measurement of subject Sₘ under re-confrontation of proposition 107 has thus collapsed the full joint wave function Ψ described by Eq. 24 is indicated on the quantum representation side in FIG. 5F.

Einstein's objection is that internal state of subject Sₙ, who is all the way in San Francisco cannot be changed by measurement of subject Sₘ in New York without some interaction mechanism in real life. This objection indicates a skepticism that symmetry laws that hold in Hilbert space and do not require mediation through the fully emerged context or via the space-time fabric on the left side of time line 300 are sufficient for mediating the quantum correlations established in entanglement. In order to overcome the objection from the point of view of our present quantum representation, it would have to be shown subject Sₙ “feels” a change in their inner state 110n at measurement time t_{eSm} of entangled partner Sₘ. Note that this change is initially confined to inner spaces and does not need to produce any measurable indication.

For the purposes of the present invention and the quantum representation adopted herein, we assume that subject Sₙ “feels” the change in their inner state 110n as captured by the change in their quantum representation when their partner Sₘ is measured. Further, for the purposes of the invention, it is assumed that any pair of subjects can represent such “feelings” by a proxy that has explanatory power for them. Even further, tokenization of proxies in physical entities, which may include items is also permissible.

For example, a “feeling of rivalry” may be a proxy that entangled subjects experiencing this proxy wish to capture or embody in the physical realm. The token may be an item that relates to the proposition the “feelings of rivalry” were about. In the event of house 109r3, the token may simply be a picture of the house 109r3. Tokens that embody proxies such as friendship, trust, amity etc. can also be instantiated. In most cases, proxies can be represented by items that include subjects, objects and experiences. In the case of proxies for the feeling of “trust” very specific items can be designated. Indeed, these items may even represent the real-valued parameter W we have previously discussed. A very convenient social choice for tokenization of parameter W standing for social trust is money.

In general, tokenization of proxies in accordance with the invention allows us to measure entanglement (or at least the level of entanglement experienced by the subject pairs). We can, of course, deploy for this purpose the many tools we have previously discussed for studying the level of entanglement in physics proper. Advantageously, however, unfettered deployment of tokens by subjects that are entangled to capture their specific type of joint subject states should be encouraged. These tokens can be used as a validation of entanglement measures obtained using the tools from physics proper. Tokens can also be used to discover hidden entanglements between subjects. For example, the discovery of a token embodied by an item such as a friendship bracelet between apparent strangers indicates that these subjects are likely entangled in accordance to one of the four possible joint subject states for pairs. These also correspond to the four canonical entangled states for two qubits, when the invention is practiced using qubits.

We now consider the conclusion to the situation shown in FIG. 5F as if it were necessary to communicate in the emerged realm on the left side of time line 300 to sync up subjects Sₘ, Sₙ in their measurable indications to reflect the anti-correlation captured by their anti-symmetric joint subject state Ψ. It so happens that subject Sₙ is measured within a very short time after subject Sₘ at time t′r_{eSn} by unit 120A in San Francisco. The period between times t_{eSm} and t′_{eSn} is extremely short. It is shorter than a signaling or messaging time τ_{msg} during with a message 840 communicating the choice of eigenvalue λ_{Sm,1} in contextualization of “rentability” made by subject Sₘ to subject Sₙ can be physically sent between New York and San Francisco. Message 840 could, at the very earliest, arrive at a time t_{eSm} after subject Sₙ has already exhibited their measurable indication λ_{Sn}. In other words, subject Sₙ would have already had to have exhibited their measurable indication correctly, i.e., exhibited the proper anti-correlation on measurable indications forcing λ_{Sn}=λ_{Sn,2} by time t_{eSm.}

Message 840 communicating the choice of eigenvalue λ_{Sm,1} by subject Sₘ to subject Sₙ cannot travel any faster. That is because message 840 uses the fastest possible message transfer channel available in fully emerged reality, namely the electro-magnetic field or photons y. Photons γ cannot travel faster than the speed of light c and thus are confined to propagate on the null ray. As indicated in the diagram, this makes it impossible to transmit message 840 in fully emerged reality or on the real life events side of time line 300 it a time less than τ_{msg}. The separation between subjects Sₘ, Sₙ is space-like. Therefore, there is no mechanism permitted within our current understanding of relativity that can be responsible for alerting subject Sₙ to the choice of contextualization and measurable indication already made by subject Sₘ if the time between t_{eSm} and t′_{eSn} is less than τ_{msg}. The earliest time by which message 840 can arrive in principle is t_{eSn.}

Barring any evolution of the state of subject Sₙ between its collapse at time t_{eSm} and time t′_{eSn} we see from the perspective of quantum representation that measurement of subject Sₙ is merely confirmatory of what we already know. Namely, subject Sₙ will be found in state |sv₂ [symbol] _{S}_{ₙ} and will yield as subsequent measurable indication λ_{Sn}=λ_{Sn,2}. It has to do that in order to preserve the anti-correlation between the measurable indications. In physics proper, this type of situation has been studied in Bell-type experiments. The non-local anti-correlation is a fact. In our representation, we take this to mean that message 840 is not required to sync up subjects Sₘ, Sₙ to obtain the anti-correlation.

Returning to FIG. 5E, we see that in the preferred embodiment statistics module 118 is connected to unit 120 broken down in this case into units 120A, 120B. Module 118 reviews known and subsequent measurable indications from subjects Sₘ, Sₙ to estimate a measure of entanglement such as, for example, entanglement entropy. At this point it should be remembered that there are four possible pairwise entangled states. The first two express entanglement between F-D anti-consensus subject pairs like subjects Sₘ, Sₙ (notice that Eq. 24 is just Eq. 25 with the minus sign choice):

Ψ=1/\sqrt{2}(|sv₁ [symbol] _{S}_{ₘ} [symbol] |sv₂ [symbol] _{S}_{ₙ}±|sv₂ [symbol] _{S}_{ₘ} [symbol] |sv₁ [symbol] _{S}_{ₙ}) Eqs. 25

The other two are for B-E consensus subject pairs like subjects Sⱼ, Sₖ experiencing entanglement:

Φ=1/\sqrt{2}(|sv₁ [symbol] _{S}_{ⱼ} [symbol] |sv₁ [symbol] _{S}_{ₖ}±|sv₂ [symbol] _{S}_{ⱼ} [symbol] |sv₂ [symbol] _{S}_{ₖ}) Eqs. 26

Clearly, for the perfectly anti-correlated joint subject state Ψ expressed by Eq. 24 the entanglement measure will indicate complete entanglement. The same will be true for the remaining three joint subject states of Eqs. 25 & 26.

As will be appreciated by those skilled in the art, tests of entangled states can be performed in many ways. These may even include situations in which the original measurable indications are unknown, but entanglement is nonetheless established. Therefore, statistics module 118 can be used for estimating the measure of entanglement by comparing just the subsequent measurable indications without having at its disposal any known measurable indications. In cases where the original measurable indications are known, of course, comparison of known measurable indications with subsequent measurable indications will permit module 118 to obtain better estimates. In cases where a sufficiently reliable measure of entanglement can be obtained, the statistics module may proceed to further estimate a change in the quantum representation of the pair of subjects due to entanglement. In other words, when confronted with imperfect entanglement (see FIG. 5D and corresponding description of density matrix ρ), module 118 can estimate point P̅.

In estimating the entanglement it is particularly advantageous to select an additional proposition that is incompatible with underlying proposition 107 in the quantum sense. Preferably, however, both propositions are about the same item. Subjects in the pair should then be confronted with the additional proposition to obtain subsequent measurable indications. Most effective is an additional proposition that induces secondary subject value matrix PR_{SV} that is incompatible with subject value matrix PR_{V}. This is true, of course, if secondary subject value matrix PR_{SV} was indeed confirmed by commutator algebra to be incompatible with subject value matrix PR_{V}. Otherwise, secondary subject value matrix should be appropriately selected with the aid of commutator algebra. In the above example secondary subject value matrix PR_{SV} stands for contextualization by “spirituality”.

Clearly, the manner in which additional proposition is presented should induce the incompatible contextualization. It should induce subjects to yield their subsequent measurable indications as eigenvalues of secondary subject value matrix PR_{SV}. To ensure that this is true, the eigenvalues should preferably be collected in conjunction with questions asking the subjects to articulate their contextualization.

The present invention relates to computer implemented methods and computer systems that are designed to determine a mutual interdependence or entanglement in pairs of subjects that jointly contextualize a proposition. As seen above, the subjects can be F-D anti-consensus type of B-E consensus type. Of course, the methods and systems extend to tracking or detecting the effects of entanglement that each subject in the entangled pair experiences. They also extend to simulating the effects of entanglement exhibited or experienced by pairs of subjects. In particular, Bell type experiments can be performed on subject states in the process of tracking, detecting or simulating the effects of entanglement.

Referring back to FIG. 2, we note that in most embodiments it is advantageous to mediate interactions between selected subjects within network 104 and/or social network 106 for reasons of convenience and control over the process. For example, the step of jointly exposing the subjects to the proposition to generate the joint subject state can be performed entirely within computer system 100 by using the resources of network 104 using available screens or other communication affordances. Of course, as remarked above, when not possible to confine subjects within network 104 joint exposure can be achieved by presenting them with the proposition in real life. Since the rules under which the joint subject state forms include a sufficient amount of joint exposure time and clarity on behalf of both subjects that they are interdependent in their choice of contextualization the affordances used should be correspondingly configured. Specifically, the confrontation of exposure of subjects to propositions jointly should be unmistakable to both subjects. The use of online communications tools even including simple messages of the type: “your friend is also looking at this proposition about the item” is permissible.

It will be evident to a person skilled in the art that the present invention admits of various other embodiments. Therefore, its scope should be judged by the claims and their legal equivalents.

1. A computer implemented method for detecting entanglement in a joint subject state modulo a proposition, said method comprising:
a) selecting by a mapping module a pair of subjects individually exhibiting a known contextualization of said proposition and known measurable indications;
b) assigning by an assignment module a subject value matrix PR_{V} for said known contextualization, where eigenvalues of said subject value matrix PR_{V} correspond to possible measurable indications;
c) jointly exposing said pair of subjects to said proposition to form said joint subject state;
d) collecting by a network monitoring unit subsequent measurable indications from said pair of subject after formation of said joint subject state.

2. The computer implemented method of claim 1, further comprising the step of separating said pair of subjects prior to said step of collecting of said subsequent measurable indications.

3. The computer implemented method of claim 2, wherein said step of separating is performed in a network environment.

4. The computer implemented method of claim 1, wherein said new measurable indications are collected for an additional proposition that is incompatible with said proposition.

5. The computer implemented method of claim 4, wherein said proposition and said additional proposition are about an item selected from the group consisting of a subject, an object and an experience.

6. The computer implemented method of claim 5, wherein said proposition and said additional proposition are about the same item.

7. The computer implemented method of claim 2, wherein said additional proposition is incompatible with said proposition such that it induces in said pair of subject a secondary subject value matrix PR_{SV} that does not commute with said subject value matrix PR_{V}.

8. The computer implemented method of claim 2, further comprising the step of estimating by a statistics module a measure of said entanglement by comparing said known measurable indications with said subsequent measurable indications.

9. The computer implemented method of claim 8, further comprising estimating by said statistics module a change in a quantum representation of said pair of subjects due to said entanglement.

10. The computer implemented method of claim 1, wherein said step of jointly exposing comprises presenting both of said pair of subjects with said proposition within a network.

11. The computer implemented method of claim 1, wherein said step of jointly exposing comprises presenting both of said pair of subject with said proposition in real life.

12. A computer system for detecting entanglement in a joint subject state modulo a proposition, said computer system comprising:
a) a mapping module for selecting a pair of subjects individually exhibiting a known contextualization of said proposition and known measurable indications;
b) an assignment module for assigning a subject value matrix PR_{V} to said known contextualization, where eigenvalues of said subject value matrix PR_{V} correspond to possible measurable indications;
c) a means for jointly exposing said pair of subjects to said proposition to form said joint subject state;
d) a network monitoring unit for collecting subsequent measurable indications from said pair of subject after formation of said joint subject state.

13. The computer system of claim 12, further comprising a statistics module for estimating a measure of said entanglement by comparing said known measurable indications with said subsequent measurable indications.

14. The computer system of claim 12, wherein said means for jointly exposing comprises an apparatus with a visualization component for presenting said proposition to said pair of subject.

15. The computer system of claim 14, further comprising a network and wherein said means for jointly exposing is an element of said network.

16. The computer system of claim 15, wherein said network is selected from the group consisting of the Internet, the World Wide Web, a Wide Area Network (WAN) and a Local Area Network (LAN).

17. The computer system of claim 15, wherein said at least one of said pair of subject is a member of a social group.

18. The computer system of claim 17, wherein said social group is selected from any one or more of the group of social networks consisting of Facebook, LinkedIn, Google+, MySpace, Instagram, Tumblr, YouTube.

19. The computer system of claim 17, wherein said social group manifests an affiliation with one or more product sites selected from the group consisting of Amazon.com, Walmart.com, bestbuy.com, Groupon.com, Netflix.com, iTunes, Pandora and Spotify.

20. The computer system of claim 11, wherein said proposition is associated with at least one item from the group consisting of a subject, an object and an experience.
